(19) United States
(12) Patent Application Publication
(10) Pub. No.: US 2010/0049538 A1
(43) Pub. Date: Feb. 25, 2010

(54) METHOD AND APPARATUS FOR SELECTING NEXT ACTION

(76) Inventors: Durban Frazer, Kentfield, CA (US); Helen Geraldine E. Rosario, Chapel Hill, NC (US); Marc-David Cohen, Ross, CA (US); Gerald Fahner, Austin, TX (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/197,134

(22) Filed: Aug. 22, 2008

(51) Int. Cl. G06Q 99/00

(52) U.S. Cl. 705/1

(57) ABSTRACT

A method for selecting a next action includes reading transaction data, determining insights and relationships between a first entity and a second entity from the collected transaction data. Once these relationships and insights have been determined, the possibility of a future event occurring in one of a number of selected time periods can be determined using a predictive time-to-event component. A system for selecting a next action includes a memory for storing transaction data, an insight/relationship determination module, and a predictive time-to-event module. The memory, the insight/relationship determination module and the predictive time-to-event module carry out the above method. A programmable media having an instruction set can also cause a machine to carry out the above method.

### TECHNICAL FIELD

Various embodiments described herein relate to apparatus, systems, and methods for selecting next actions given data relating individuals to various events.

### BACKGROUND

Retailers, advertisers, and many other institutions are keenly interested in understanding consumer spending habits. These companies invest tremendous resources to identify and categorize consumer interests, in order to learn how consumers spend money. If the interests of an individual consumer can be determined, then it is believed that advertising and promotions related to these interests will be more successful in obtaining a positive consumer response, such as purchases of the advertised products or services.

Conventional means of determining consumer interests have generally relied on collecting demographic information about consumers, such as income, age, place of residence, occupation, and so forth, and associating various demographic categories with various categories of interests and merchants. Interest information may be collected from surveys, publication subscription lists, product warranty cards, and myriad other sources. The data collected is processed resulting in some demographic and interest description of each of a number of consumers.

This approach to understanding consumer behavior often misses the mark. The assumption is that consumers will spend money on their interests, as expressed by things like their subscription lists and their demographics. Yet, the data on which the determination of interests is made is typically only indirectly related to the actual spending patterns of the consumer. For example, most publications have developed demographic models of their readership, and offer their subscription lists for sale to others interested in the particular demographics of the publication's readers. But subscription to a particular publication is a relatively poor indicator of what the consumer's spending patterns will be in the future.

Even taking into account multiple different sources of data, such as combining subscription lists, warranty registration cards, and so forth still only yields an incomplete collection of unrelated data about a consumer.

One of the problem associated with these conventional approaches is the failure to recognize that spending patterns are time based. That is, many times consumers spend money in a time related manner. For example, a consumer who is a business traveler spends money on plane tickets, car rentals, hotel accommodations, restaurants, and entertainment in preparation for and during a single business trip. These purchases together more strongly describe the consumer's true interests and preferences than any single one of the purchases alone.

Yet another problem with conventional approaches is that categorization of purchases is often based on standardized industry classifications of merchants and business, such as the SIC codes. This set of classification is entirely arbitrary, and has little to do with actual consumer behavior. Consumer do not decide which merchants to purchase from based on their SIC code. Thus, the use of arbitrary classifications to predict financial behavior is doomed to failure, since the classifications have little meaning in the actual data of consumer spending.

Still another problem is that different groups of consumers spend money in different ways. For example, consumers who frequent high-end retailers have entirely different spending habits than consumers who are bargain shoppers. To deal with this problem, most systems focus exclusively on very specific, predefined types of consumers, in effect, assuming that the interests or types of consumers are known, and targeting these consumers with what are believed to be advertisements or promotions of interest to them. However, this approach essentially puts the cart before the horse: it assumes the interests and spending patterns of a particular group of consumers, it does not discover them from actual spending data. It thus begs the questions as to whether the assumed group of consumers in fact even exists, or has the interest that are assumed for it.

Accordingly, what is needed is the ability to model consumer financial behavior based on actual historical spending patterns that reflect the time-related nature of each consumer's purchase. Further, it is desirable to extract meaningful classifications of merchants based on the actual spending patterns, and from the combination of these, predict future spending of an individual consumer in specific, meaningful merchant groupings.

One source of data now available to retailers is transaction data. Retailers typically sell and provide a wide variety of products to a large number of customers. Each of the transactions is recorded at a point of sale device and is used for accounting and other purposes. Many retailers retain data related to these transactions, which is sometimes referred to as transaction data. Transaction data includes all data related to a transaction including, for example, promotions, price changes, product features, store features, seasonal factors and customer loyalty data that may affect the transaction. The transaction data can also include demographics and firmographics. The transaction data includes data detailing an actual purchase, which is referred to as purchase data. Purchase data or transaction data can be used for a variety of purposes. Typically, purchase data is used to encourage repeat purchase behavior and to identify customers with high value growth potential. One challenge associated with transaction data or purchase data is associated with the sheer volume of the data. While the purchase data or transaction data offers a huge opportunity for vital marketing information, the sheer volume of the data challenges the traditional statistical and mathematical techniques at the retailers disposal. Retail data analysts use only limited online analytical processing (OLAP) capabilities to “slice and dice” the purchase data to extract basic statistical reports and use them and other domain language to make marketing decisions.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a flow chart of a method for selecting a next best action, according to an example embodiment described herein.

FIG. 2 is a flow chart of a method for selecting a next best action in a consumer setting, according to an example embodiment described herein.

FIG. 3 shows an embodiment of a system for selecting a next best action, according to an example embodiment.

FIG. 4 shows a more detailed embodiment of a system for selecting a next best action, according to an example embodiment.

FIG. 5 shows retail transaction data as a time stamped sequence of market baskets, according to an example embodiment.

FIG. 6 shows an example of the insight/relationship determination module 320 consistency graph for a grocery retailer, in which nodes represent products and edges represent consistency relationships between pairs of nodes, according to an example embodiment.

FIG. 7 shows a product neighborhood, in which a set of products is shown with non-zero consistency with the target product, where the left FIG. is shown without cross edges and the right FIG. is shown with a cross edge, according to an example embodiment.

FIG. 8 shows a bridge structure in which two or more product groups are connected by a bridge product, according to an example embodiment.

FIG. 9 shows a logical bundle of seven products, according to an example embodiment.

FIG. 10 shows data pre-processing, which involves both data filtering (at customer, transaction, line item, and product levels) and customization (at customer and transaction levels), according to an example embodiment.

FIG. 11 shows that the insight/relationship determination module 320 is context rich, where there are two types of contexts in the insight/relationship determination module 320: market basket context and purchase sequence context; where each type of context allows a number of parameters to define contexts as necessary and appropriate for different applications for different retailer types, according to an example embodiment.

FIG. 12 is a description of Technique 1, according to an example embodiment.

FIG. 13 is a description of Technique 2, according to an example embodiment.

FIG. 14 shows a definition of consistency, according to an example embodiment.

FIG. 15 shows four counts and their Venn diagram interpretation, according to an example embodiment.

FIG. 16 shows the wide variety of the insight/relationship determination module 320 applications divided into three types: Product affinity applications, Customer affinity applications, and Purchase behavior applications, according to an example embodiment.

FIG. 17 shows a discrete bundle lattice space used to define a locally optimal product bundle for Techniques 4 and 5, according to an example embodiment.

FIG. 18 shows an example of polyseme where a word can have multiple meanings. This is the motivation for bridge structures, according to an example embodiment.

FIG. 19 shows an example of a product bundle with six products and time-lags between all pairs of products in the bundle, according to an example embodiment.

FIG. 20 shows the Recommendation Engine process, according to an example embodiment.

FIG. 21 shows two types of recommendation engine modes depending on how customer history is interpreted: The Market Basket Recommendation Engine (top) and the Purchase Sequence Recommendation Engine (bottom), according to an example embodiment.

FIG. 22 shows the motivation for using density score for post-processing the recommendation score if the business goal is to increase the market basket size, according to an example embodiment.

FIG. 23 shows a representation of a three dimensional propensity matrix, according to an example embodiment.

FIG. 24 shows a propensity matrix for one of the selected times from the three dimensional propensity matrix, according to an example embodiment.

FIG. 25 shows a flow diagram of an optimization of a recommendation engine, according to an example embodiment.

FIG. 26 is a block diagram of a computer system that executes programming for performing the methods discussed in more detail below, according to an example embodiment.

FIG. 27 is an overview of one embodiment of the predictive time-to event (TTE) component, according to an example embodiment.

FIG. 28 is a schematic diagram of the analytic process performed by the predictive time-to-event component, according to an example embodiment.

FIG. 29 depicts a process for compiling information from several propensity matrices into an optimized offer schedule, according to an example embodiment.

The description set out herein illustrates the various embodiments of the invention and such description is not intended to be construed as limiting in any manner.

### DETAILED DESCRIPTION

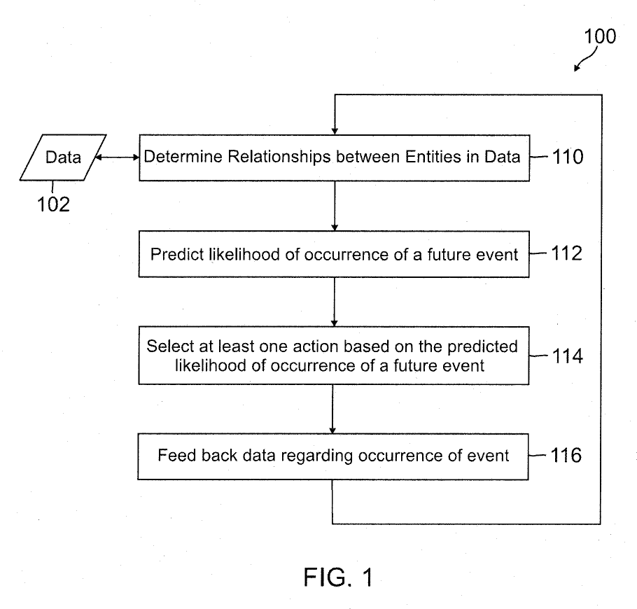

FIG. 1 is a flow chart of a method 100 for selecting a next best action, according to an example embodiment described herein. At least part of the method 100 acts on a set of data 102. The method 100 includes determining relationships between entities 110 within the data. In the embodiments described herein the data is transaction data about purchases made by various customers at one or more retailers. In some instances, there may be terabytes of transaction data related to transactions between customers and one or more retailers.

Entities can be any number of items associated with the data. In the instances where the data relates to transactions between customers and a retailer or retailers, entities include products, and product groups. Entities are also not limited to products and product groups, and can also represent a promotion, a change in price, or potions of information about consumers, or other data. Entities can also be promotion histories, or purchase histories of a customer or group of customers. Determining insights between entities 110 includes finding products that are coherent or bridge to other products. Insights include all types of relationships, including relationships that may have previously been unknown to the retailer or group of retailers. Determining insights 110 includes determining relationships between products and consumers. In short, determining relationships between entities 110 allows marketers to gain insight into relationships between the various entities.

The method 100 also includes predicting the likelihood of the occurrence of a future event 112. In retail situations, the future event many times is the purchase of another product. For example, when a consumer buys a personal computer many times the consumer will follow with purchases of other hardware or software. The consumer may buy a printer or may buy a word processing program shortly after making a computer purchase. The future event can actually include other items, such as an in-store visit or the like.

In addition to predicting that an event will occur, in some embodiments of the invention, a time frame in which the event will occur is also predicted. In one embodiment, predicting the likelihood of the occurrence of a future event 112 is generally done as a risk factor over a number of selected times. This is referred to as predicting the time to the event. The risk factor is set for the various time frames. The time frames can be as short or as long as desired. For example, the time frame may be a second, or it may be several days. The risk factor is based on the risk that the action takes place over the time frame. The subsequent time frame presents yet another risk factor. The time frames can be equal or can be unequal. The method 100 also includes selecting at least one action based on the predicted likelihood of the occurrence of a future event 114. In marketing, most of the time the at least one action will have a monetary component. In other words, the actions will cost money to perform. In business, it is desirable to get the most effect for the dollar spent. Therefore, selecting the action 114 may also include optimization so that the predictions made can be leveraged across customers and products to meet business goals and objectives within the bounds of resource constraints placed by the business.

In one particular embodiment of the method 100, the marketing action will be a recommendation for an action to be taken. The owner of the product, in this one embodiment, will pay a fee for a recommendation to be made. A retailer can make the recommendation to a particular customer. The source of the recommendation can also be other than the retailer. The method 100 also includes feeding back information regarding the occurrence of the event 116. This information is useful in determining or tweaking the relationships or insights between the entities associated with the data as well as predicting the likelihood of occurrence of a future event. Statistics can be kept as to the effectiveness of the predictions for the purpose of pricing the services. The statistics can also be used to determine the timing for retraining models for the predictive component or if some relationships found are no longer significant of it new ones have emerged. It should be noted that the discussion of business and marketing is one application or example application of the method for finding insights or relationships between events in a set of data and then predicting when this method 100 is extendable to other situations.

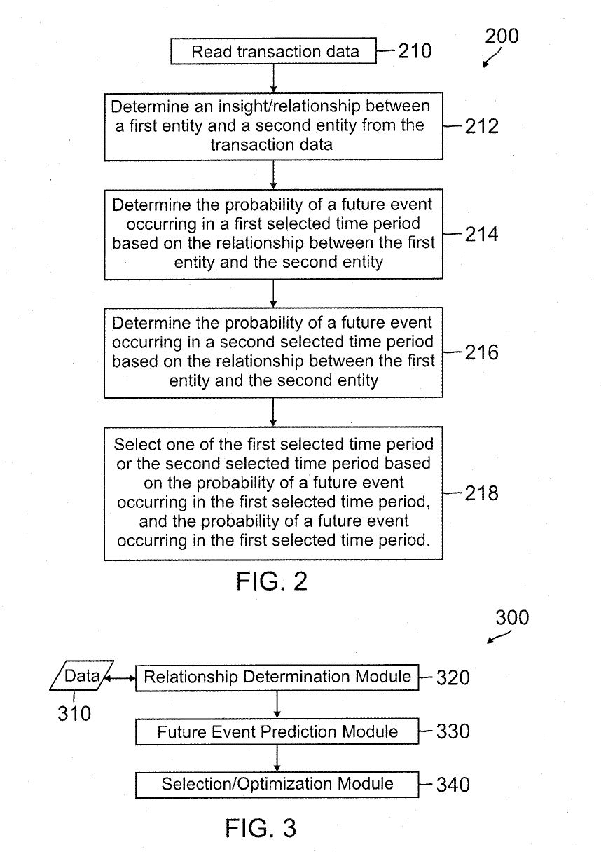

FIG. 2 is a flow chart of a method 200 for selecting a next best action in a consumer setting, according to an example embodiment described herein. The method for selecting a next action 200 includes reading transaction data 210, and determining a relationship between a first entity and a second entity from the transaction data 212. In some instances, the relationship may not be known and the relationship found may be some new insight. The method 200 also includes determining the probability of a future event occurring in a first selected time period based on the relationship between the first entity and the second entity 214, and determining the probability of a future action occurring in a second selected time period based on the relationship between the first entity and the second entity 216. In some embodiments, the method 200 also includes selecting one of the first selected time period or the second selected time period based on the ranking of the possibility of a future event occurring in the first selected time period 218. The first entity can be a first product and the second entity can be a second product. In other embodiments of the method 200, the first entity can be a product and the second entity can be a customer or consumer. In still another embodiment, the first entity is a product and the second entity is a set of customers. In yet another embodiment, the method 200 can be extended to further include determining a relationship between the first entity and the second entity and the third entity. The third entity is a marketing action, or demographic information, or historical information, or the like. In this way, the action selected can be in response to a marketing action, for example. Many times there are several possible actions that can be taken at several possible times. The action or actions are optimized, in some embodiments of the method 200 so as to provide leverage for the resources expended to do the actions.

FIG. 3 shows a system 300 for selecting a next best action, according to an example embodiment. The system 300 includes a memory 310 for storage of data, an insight determination module 320, a predictive time to event module 330 and a selection optimization module 340. These modules can be hardware or software or a combination of both hardware and software. Software will include a set of instructions for causing a machine to perform the set of instructions.

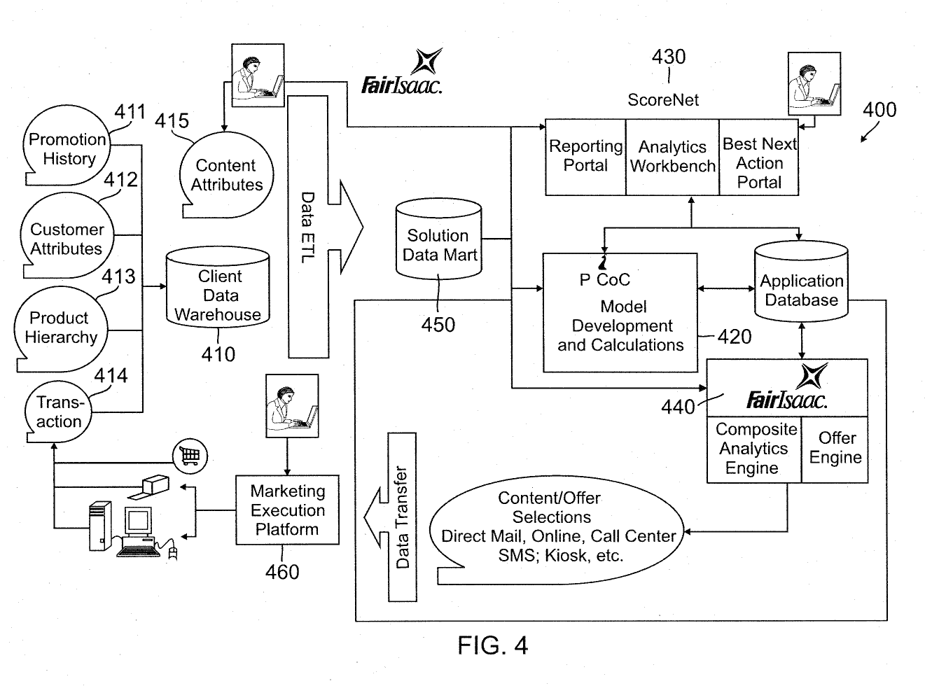

FIG. 4 shows a more detailed embodiment of a system 400 for selecting a next best action, according to an example embodiment. The system 400 shows a hardware portion of the system 300. It should be understood that various portions of hardware will execute software or firmware. The system 400 will initially be described briefly and the process used in the various modules will be set forth in further detail. The system 400 includes a data warehouse 410 that includes data and information promotion history 411, customer attributes 412, product hierarchy 413, and purchase data 414. The purchase data includes data related to the actual purchase of goods, whether over the internet or at a point of sale device within a retail store. The client warehouse data 410 also include content attributes 415.

The client warehouse data 410, mentioned above, represents terabytes of transaction and other data related to a sales entity. The client warehouse data 410 includes extra information that does not need to be used to perform the method for selecting the next best action, such as method 100 or method 200. As a result, the needed data is extracted, transformed and loaded into a more useable subset of the warehouse data base called a solution data mart 450. The solution data mart 450 can be stored with the data client warehouse 410 or can be stored on a separate data server or other separate data location. The data associated with the solution data mart 450 is used or acted on to determine various relationships between entities.

The system 400 also includes a insight/relationship determination module 420, and a future event prediction module 430, and a selection and optimization module 440. The relationships are determined after reviewing historical transaction data and producing a model based on the historical data for a number of entities. The model can then be used to project future actions of a person or consumer based on other entities, such as promotions or the product. The future event prediction module 430 is used to determine the possibility of a future event occurring within a number of time frames. The future event prediction module 430 determines the possibility of a future event over at least two selected time frames. The future event prediction module 430 uses a proportional hazard type model. The possibility that an event will occur within a time frame is set forth as a number. The number represents the possibility that the event will occur in the particular time frame. The number is between zero (where it absolutely sill not occur) and one (where the event will occur during that particular time frame). The number assigned is actually a probability of the event occurring. Assigning the probability for the various time frames may also be referred to as scoring the possibility or propensity of the future event happening during the time frame. The future event prediction module shifts the emphasis to when an event, such as a purchase, will occur. In other words, the emphasis is not merely a prediction that the event will occur but the prediction is made with finer granularity with respect to the timing of the future event.

For each time frame, a propensity matrix including one or more customers and at least one product is formed. Several propensity matrices will be produced for each of the future time slots. This data is input to the selection module 440. The selection module 440 selects from among the best times to make a recommendation to the consumer. The selection module 440 can also be thought of as an optimization module for timing recommendations that will be the most effective in causing the future event. The recommendation or other marketing action is then output from the selection module 440 as a content offer. In some embodiments, a marketing channel is also recommended. For example, an offer may be made to a consumer by direct mail, or from a call center, or through a kiosk or over the internet. The recommendation or other marketing action data is transferred to a marketing execution platform 460 where the recommendation is fulfilled or made to the consumer. Of course the purchase transactions can then be monitored to see if the consumer acts or buys the product. In other words, the process has a feed back loop which can be monitored for success of the recommendations or other marketing action. The new purchases, the marketing action, the product and the timing of these actions then become part of the historical data of client data warehouse 410 that will be extracted, transformed, and loaded for use in the next iteration of the method.

Thus, the system 400 is a closed-loop process incorporating data acquisition and management, measurement and reporting, analytics, and complex decisioning to serve the highest performing interaction to customers at the right time and through the right channel. The system 400 is scalable to meet both current and future client marketing objectives.

The insight/relationship determination module 420 includes a scalable, highly automated parallel computing data mining application. It takes a large amount of customer transaction data and produces individual (disaggregated) likelihoods for a specified set of events that customers may experience in the near future (week, month, next mouseclick, etc.). The future event predictor module 320, in one embodiment uses a form of scorecards (one scorecard per predicted event) which tend to be interpretable.

The notion of events is very general. A user can specify which events to predict, after giving careful consideration to the business objectives and what's actionable. Predicting store visits, purchases in various departments, or of various products, can be exploited by sending brochures, discount coupons, or by means of a product recommendation engine. While purchase events are directly available from the data, it is also possible to define technical events as prediction targets.

The scorecards take into account previous transaction information (in the form of recency and frequency attributes), as well as seasonal information. This information is often very rich and predictive of future behavior. Other potential inputs are customer demographics, behavior summary features, marketing variables, pricing information, economic and competitor data, etc.)

In the operation, new transactions continuously stream into the data warehouse 410. The future events prediction module 430 regularly recomputed scores based on the latest information. The scores/event likelihoods may change over time, reflecting the changing needs and attitudes of the customers. The scores will input into the selection optimization module 440 and marketing execution platform 460 which use rules to turn scores into marketing or other decisions.

Due to expected changes in the environment (economy, competitors), changes in customer behavior (fashions), and the increasing information collected over time, it is important to occasionally update (some of) the underlying predictive models, both in terms of their structure and their parameters.

The output of the future event prediction module (330, 430) is a set of predictions, not decisions. To orchestrate smart decisions, (constrained) optimization techniques are used. The “propensity matrix” of purchase likelihoods of all customers for all products provides precise (accurate and timely) information for marketing optimization.
One example of the selection optimization module (340, 440) would be to optimize targeting of product offers (recommendations, coupons, etc.) to those customers who have not bought certain products before, and who have a high propensity/purchase likelihood for these products. This is quite natural in the case of seldom purchased products, such as TV's or appliances. It could also be interesting when attempting to “switch” customers to start purchasing repeatedly purchased products, such as a brand of a toothpaste, if they haven't bought this brand yet.
Often, these offers are subjected to several constraints, like in the following example:
   Number of offers/recommendations made per customer <=3 (for the benefit not to confuse the customer with too many offers)
   Number of offers for 40″ LCD TV's <=10,000 (for the benefit of not creating too much demand that the retailer may not be able to accommodate)
   Number of mailings=1 million pieces (for the benefit of using up the marketing budget set aside for envelopes and stamps)
If the promotion involves multiple channels and costs are known, the optimization may also incorporate more complex constraints such as:
   Total cost of phone calls and mailings for TV and CD promotions combined <=$25,000.
If product margin information is available, this could be brought into the formulation to optimize expected profit subject to constraints such as:
   Total profit of promotion for 40 LCD TV by phone >=5 percent of its total cost.

The system 400 and methods 100, 200 provide for highly personalized marketing campaigns by marketing the right products to the right customers at the right time and through the right channel.

Solutions should be designed to work on a large scale with many millions of customers and hundreds or thousands of products.

The discussion of FIG. 4 is a general overview of various portions of one embodiment of the system 400 as well as how the various components function and interact to perform the method of predicting future actions, such as shown and described in FIGS. 1-3. Now, the various modules and how they work will be described in further detail.

Insight/Insight/Relationship Determination Module

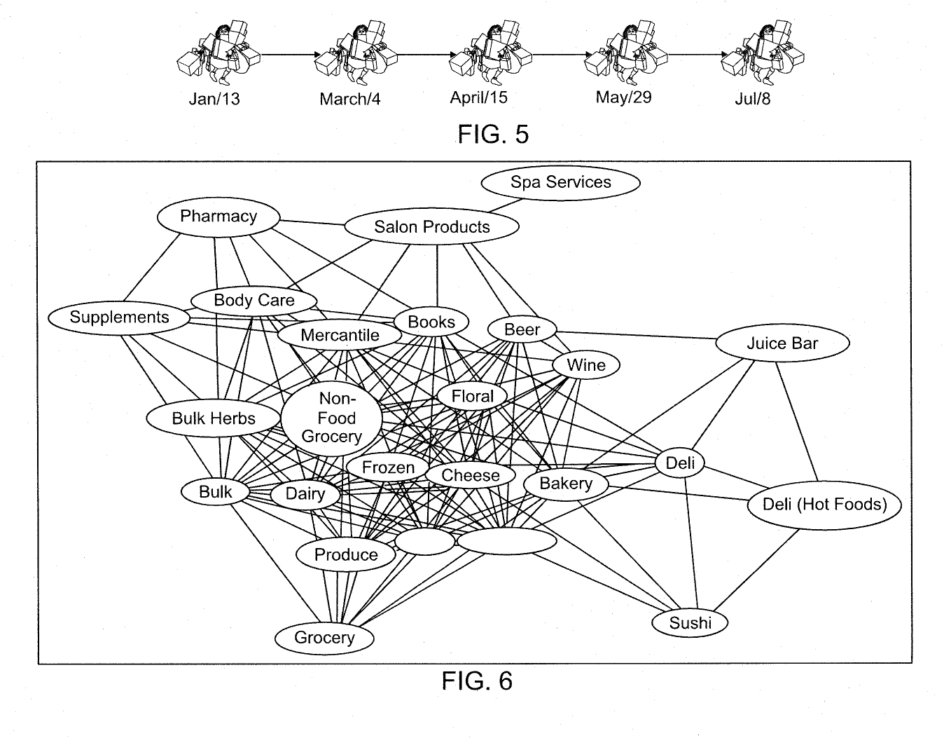

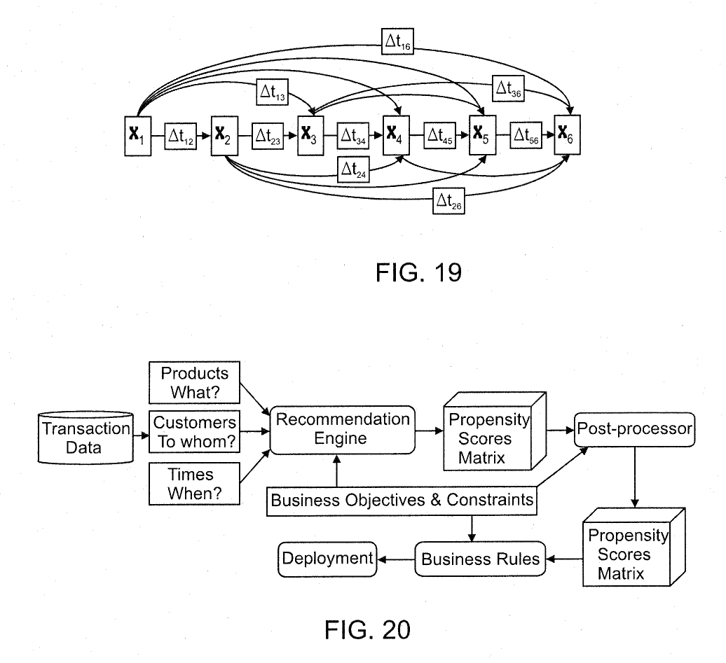

Referring now to FIGS. 5-22, the insight/relationship module 320 will be further detailed. The insight/relationship module 320 in a retail environment, is designed to act on historical transaction data and search for and find relationships between various events associated with the transactional data. The insight/relationship module 320, therefore, provides insights in that it searches and finds relationships that might not have previously been evident. The events in transactional data more than likely relate to a follow up purchase a product or products based on a previous purchase of a product by a customer or group of customers. The insight/relationship determination module 320, uses a blend of technologies from statistics, information theory, and graph theory to quantify and discover patterns in relationships between entities, such as products and customers, as evidenced by purchase behavior. The insight/relationship determination module 320 employs information-theoretic notions of consistency and similarity, which allows robust statistical analysis of the true, statistically significant, and logical associations between products and the entities. As a result, the insight/relationship determination module 320 lends itself to reliable, robust predictive analytics based on purchase-behavior.

The insight/relationship determination module allows product associations to be analyzed in various contexts, e.g. within individual market baskets, or in the context of a next visit market basket, or across all purchases in an interval of time, so that different kinds of purchase behavior can be associated with different types of products and different types of customer segments can be revealed. Therefore, accurate customer-centric and product-centric decisions can be made. The insight/relationship determination module 320 can be scaled to very large volumes of data, and is capable of analyzing large numbers of products and even more transactions. The insight/relationship determination module 320 is interpretable and develops a graphical network structure that reveals the product associations and provides insight into the decisions generated by the analysis. It also enables a real-time customer-specific recommendation engine that can use a customer's past purchase behavior and current market basket to develop accurate, timely, and very effective cross-sell and up-sell offers.

The Insight/Relationship Determination Module 320 Framework

Traditional modeling frameworks in statistical pattern recognition and machine learning, such as classification and regression, seek optimal causal or correlation based mapping from a set of input features to one or more target values. The systems (input-output) approach suits a large number of decision analytics problems, such as fraud prediction and credit scoring. The transactional data in these domains is typically collected in, or converted to, a structured format with fixed number of observed and/or derived input features from which to choose. There are a number of data and modeling domains, such as language understanding, image understanding, bioinformatics, web cow-path analysis etc., in which either (a) the data are not available in such a structured format or (b) we do not seek input-output mappings, where a new computational framework might be more appropriate. To handle the data and modeling complexity in such domains, the insight/relationship determination module 320, a semi-supervised insight discovery and data-driven decision analytics framework, known as Pair-wise Co-occurrence Consistency that:
Seeks Pair-wise relationships between large numbers of entities,
In a variety of domain specific contexts,
From appropriately filtered and customized transaction data,
To discover insights in the form of relationship patterns of interest,
That may be projected (or scored) on individual or groups of transactions or customers,
And to make data-driven-decisions for a variety of business goals.

Each of the highlighted terms has a very specific meaning as it applies to different domains. Before describing these concepts as they apply to the retail domain, consider the details of the retail process and the retail data abstraction based on customer purchases.

Retail Transaction Data

At a high level, the retail process may be summarized as Customers buying products at retailers in successive visits, each visit resulting in the transaction of a set of one or more products (market basket). In its fundamental abstraction, as used in the insight/relationship determination module 320 framework, the retail transaction data is treated as a time stamped sequence of market baskets, as shown in FIG. 5.

Transaction data are a mixture of two types of interspersed customer purchases:

1. Logical/Intentional Purchases (Signal)—Largely, customers tend to buy what they need/want and when they need/want them. These may be called intentional purchases, and may be considered the logical or signal part of the transaction data as there is a predictable pattern in the intentional purchases of a customer.

2. Emotional/Impulsive Purchases (Desirable Noise)—In case of most customers, the logical intentional purchase may be interspersed with emotion driven impulsive purchases. These appear to be unplanned and illogical compared to the intentional purchases. Retailers deliberately encourage such impulsive purchases through promotions, product placements, and other incentives because it increases their sales. But from an analytical and data perspective, impulsive purchases add noise to the intentional purchase patterns of customers. This makes the problem of finding logical patterns associated with intentional purchases more challenging.

Key Challenges in Retail Data Analysis

Based on this abstraction of the transaction data that they are a mixture of both intentional and impulsive purchases, there are three key data mining challenges:

1. Separating Intentional (Signal) from Impulsive (Noise) Purchases—As in any other data mining problem, it is important to first separate the wheat from the chaff or signal from the noise. Therefore, the first challenge is to identify the purchase patterns embedded in the transaction data that are associated with intentional behaviors.

2. Complexity of Intentional Behavior—The intentional purchase part of the transaction data is not trivial. It is essentially a mixture of projections of (potentially time-elapsed) latent purchase intentions. In other words:
(i) a customer purchases a particular product at a certain time in a certain store with a certain intention, e.g. weekly grocery, back-to-school, etc.
(ii) Each visit by a customer to the store may reflect one or more mixtures of intentions.
(iii) Each intention is latent, i.e. they are not obvious or announced although they may be deduced from the context of the products purchased.
(iv) Each intention may involve purchase of one or more products. For a multi-product intention, it is possible that the customer may not purchase all the products associated with that intention either at the same store or in the same visit. Hence, the transaction data only reflects a subset or a projection of a latent intention for several reasons: The customer may already have some products associated with the intention, or the customers may have them as a gift, or purchased them at a different store, etc.
(v) Finally, an intention may be spread across time. For example, an intention such as garage re-modeling or setting up a home office may take several weeks and multiple visits to different stores.
Finding patterns in transaction data with noisy (due to impulsive), incomplete (projections of intentions), overlapping (mixture of intentions), and indirect (latent intentions) underlying drivers presents a unique set of challenges.

3. Matching the Right Impulses to the Right Intentions—As mentioned above, the customer's impulsive behavior is desirable for the retailer. Therefore instead of ignoring the noise associated with it, the retailers might be interested in finding patterns associating the right kind of impulsive buying purchases with specific intentional purchases.

### Overview

In the following discussion, a high level overview of the insight determination module 320 framework is given. The insight determination module combs transaction data to find various relationships between entities associated with the data.

The terminology used to define the insight/relationship determination module 320 framework is described. The insight/relationship determination module 320 process and benefits of the insight/relationship determination module 320 framework are also provided.

Entities in Retail Domain

In the retail domain, there are a number of entity-types: Products, Customers, Customer segments, Stores, Regions Channels, Web pages, Offers, etc. The insight/relationship determination module 320 primarily focuses on two main entity types: Products and Customers.

Products are goods and services sold by a retailer. We refer to the set of all products and their associated attributes including hierarchies, descriptions, properties, etc. by an abstraction called the product space. A typical product space exhibits the following four characteristics:
Large—A typical retailer has thousands to hundreds of thousands of products for sale.
Heterogeneous—Products in a number of different areas might be sold by the retailer.
Dynamic—New products are added and old products removed frequently.
Multi-Resolution—Products are organized in a product hierarchy for tractability.

The set of all customers that have shopped in the past forms the retailer's customer base. Some retailers can identify their customers either through their credit cards or retailer membership card. However, most retailers lack this ability because customers are using either cash or they do not want to participate in a formal membership program. Apart from their transaction history, the retailer might also have additional information on customers, such as their demographics, survey responses, market segments, life stage, etc. The set of all customers, their possible organization in various segments, and all additional information known about the customers comprise the customer space. Similar to a product space, a typical customer space exhibits the following four characteristics:
Large—A customer base might have hundreds of thousands to millions of customers.
Heterogeneous—Customers are from various demographics, regions, life styles/stages.
Dynamic—Customers are changing over time as they go through different life stages.
Multi-Resolution—Customers may be organized by household, various segmentations.

Relationships in Retail Domain

There are different types of relationships in the retail domain. The three main types of relationships considered by the insight/relationship determination module 320 are:

1. First order, explicit purchase-relationships between customers and products, i.e. who purchased what, when, for how much, and how (channel, payment type, etc.)?

2. Second order, implicit consistency-relationships between two products, i.e. how consistently are two products co-purchased in a given context?

3. Second order, implicit similarity-relationships between two customers, i.e. how similar are the purchase behaviors exhibited by two customers?

While the purchase relationships are explicit in the transaction data, the insight/relationship determination module 320 framework is used primarily to infer the implicit product-product consistency relationships and customer-customer similarity relationships. To do this, the insight/relationship determination module 320 views products in terms of customers and views customers in terms of products.

The Insight/Relationship Determination Module 320 Graphs

The most natural representation of pair-wise relationships between entities abstraction is a structure called Graph. Formally, a graph contains:
a set of Nodes representing entities (products or customers); and
a set of Edges representing strength of relationships between pairs of nodes (entities).

FIG. 6 shows an example of a insight/relationship determination module Consistency Graph created using the transaction data from a Grocery retailer. In FIG. 6, nodes represent products and edges represent consistency relationships between pairs of nodes. This graph has one node for each product at a category level of the product hierarchy. These nodes are further annotated or colored by department level. In general, these nodes could be annotated by a number of product properties, such as total revenue, margin per customers, and the like. There is a weighted edge between each pair of nodes. The weight represents the consistency with which the products in those categories are purchased together. Edges with weights below a certain threshold are ignored. For visualization purposes, the graph is projected on a two-dimensional plane, such that edges with high weights are shorter or, in other words, two nodes that have higher consistency strength between them are closer to each other than two nodes that have lower consistency strength between them.

The insight/relationship determination module 320 graphs are the internal representation of the pair-wise relationships between entities abstraction. There are three parameters that define an insight/relationship determination module graph.

1. Customization defines the scope of the insight/relationship determination module graph by identifying the transaction data slice (customers and transactions) used to build the graph. For example, one might be interested in analyzing a particular customer segment or a particular region or a particular season or any combination of the three. Various types of customizations that are supported in the insight/relationship determination module are described below.

2. Context defines the nature of the relationships between products (and customers) in the insight/relationship determination module graphs. For example, one might be interested in analyzing relationships between two products that are purchased together or within two weeks of each other, or where one product is purchased three months after the other, and so on. As described below, the insight/relationship determination module 320 supports both market basket contexts and purchase sequence contexts.

3. Consistency defines the strength of the relationships between products in the product graphs. There are a number of consistency measures based on information theory and statistics that are supported in the insight/relationship determination module 320 analysis. Different measures have different biases. These are discussed further below.

Insight-Structures in the Insight/Relationship Determination Module Graphs

As mentioned above, the insight/relationship determination module graphs may be mined to find insights or actionable patterns in the graph structure that may be used to create marketing decisions. These insights are typically derived from various structures embedded in the insight/relationship determination module graphs. The five main types of structures in the insight/relationship determination module graph that are explored are:

1. Sub-graphs—A sub-graph is a subset of the graph created by picking a subset of the nodes and edges from the original graph. There are a number of ways of creating a sub-graph from a insight/relationship determination module graph. These may be grouped into two types:
Node based Sub-graphs are created by selecting a subset of the nodes and therefore, by definition, keeping only the edges between selected nodes. For example, in a product graph, one might be interested in analyzing sub-graph of all products within the electronics department or clothing merchandise, or only the top 10% high value products, or products from a particular manufacturer, etc. Similarly, in a customer graph, one might be interested in analyzing customers in a certain segment, or high value customers, or most recent customers, etc.
Edge based Sub-graphs are created by pruning a set of edges from the graph and therefore, by definition, removing all nodes that are rendered disconnected from the graph. For example, one might be interested in removing low consistency strength edges (to remove noise), and/or high consistency strength edges (to remove obvious connections), or edges with a support less than a threshold, etc.

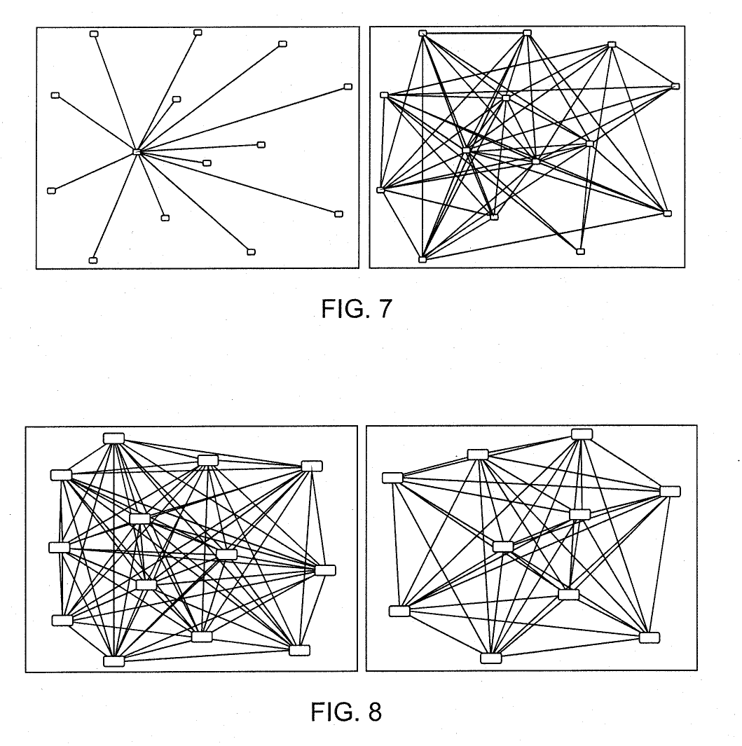

2. Neighborhoods—A neighborhood of a target product in an insight/relationship determination module graph is a special sub-graph that contains the target product and all the products that are connected to the target product with consistency strength above a threshold. This insight structure shows the top most affiliated products for a given target product. Decisions about product placement, store signage, and the like, can be made from such structures. A neighborhood structure may be seen with or without cross edges as shown in FIG. 7, which shows a Product Neighborhood having a set of products with non-zero consistency with the target product. In FIG. 7, the left figure is without cross edges and the right figure is with cross edges. A cross-edge in a neighborhood structure is defined as an edge between any pair of neighbors of the target product. More details on product neighborhoods are given below.

3. Product Bundles—A bundle structure in the insight/relationship determination module graph is defined as a sub-set of products such that each product in the bundle has a high consistency connection with all the other products in the bundle. In other words, a bundle is a highly cohesive soft clique in a insight/relationship determination module graph. The standard market basket analysis tools seek to find Item-Sets with high support (frequency of occurrence). The insight/relationship determination module 320 product bundles are analogous to these item-sets, but they are created using a very different process and are based on a very different criterion known as bundleness that quantifies the cohesiveness of the bundle. The characterization of a bundle and the process involved in creating a product bundle exemplify the pair-wise relationships and is part of a suite of propriety techniques that seek to discover higher order structures from pair-wise relationships.

FIG. 8 shows two examples of product bundles. Each product in a bundle is assigned a product density with respect to the bundle. FIG. 8 shows a cohesive soft clique where each product is connected to all others in the bundle. Each product is assigned a density measure which is high if the product has high consistency connection with others in the bundle and low otherwise. Bundle structures may be used to create co-promotion campaigns, catalog and web design, cross-sell decisions, and analyze different customer behaviors across different contexts. More details on product bundles are given below.

4. Bridge Structures—The notion of a bridge structure is inspired from that of polyseme in language where a word might have more than one meaning (or belongs to more than one semantic family). For example, the word ‘can’ may belong to the semantic family {‘can’, ‘could’, ‘would’ . . . } or {‘can’, ‘bottle’, ‘canister’ . . . }. In retail, a bridge structure embedded in the insight/relationship determination module graph is a collection of two or more, otherwise disconnected, product groups (product bundle or an individual product) that are bridged by one or more bridge product(s). For example, a wrist-watch may be a bridge product between electronics and jewelry groups of products. A bridge pattern may be used to drive cross department traffic and diversify a customer's market basket through strategic promotion and placement of products. More details on bridge structures are given below.

5. Product Phrases—A product phrase is a product bundle across time, i.e. it is a sequence of products purchased consistently across time. For example, a PC purchase followed by a printer purchase in a month, followed by a cartridge purchase in three months is a product phrase. A product bundle is a special type of product phrase where the time-lag between successive products is zero. Consistent product phrases can be used to forecast customer purchases based on their past purchases to recommend the right product at the right time. More details about product phrases is given below.

Logical vs. Actual Structures

All the structures discussed above are created by (1) defining a template-pattern for the structure and (2) efficiently searching for those patterns in the graphs of the insight/relationship determination module. One of the fundamental differences between the insight/relationship determination module 320 and conventional approaches is that the insight/relationship determination module 320 seeks logical structures in the graphs while conventional approaches, such as frequent item-set mining, seek actual structures directly in transaction data.

Consider, for example, a product bundle or an item-set shown in FIG. 10 with seven products. For a conventional approach discover it, a large number of customers must have bought the entire item-set or, in other words, the support for the entire item-set should be sufficiently high. The reality of transaction data, however, is that customers buy projections or subsets of such logical bundles/item-sets. In the example of FIG. 6, it is possible that not a single customer bought all these products in a single market basket and, hence, the entire logical bundle never exists in the transaction data (has a support of zero) and is therefore not discovered by standard item-set mining techniques. In reality, customers only buy projections of the logical bundles. For example, some customers might buy a subset of three out of seven products, another set of customers might buy some other subset of five out of seven products, and it is possible that there is not even a single customer who bought all the seven products. There could be several reasons for this: May be they already have the other products, or they bought the remaining products in a different store or at a different time, or they got the other products as gifts, and so on.

The limitation of the transaction data that they do not contain an entire logical bundle throws a set of unique challenges for retail data mining in general, and item-set mining in particular. The insight/relationship determination module 320 addresses this problem. First, it uses these projections of the logical bundles by projecting them further down to their atomic pair-wise levels and strengthens only these relationships between all pairs within the actual market basket. Secondly, when the insight/relationship determination module graphs are ready, the insight/relationship determination module 320 discards the transaction data and tries to find these structures in these graphs directly. So even if edges between products A and B are strengthened because of a different set of customers, between A and C by another set of customers and between B and C by a third set of customers (because they all bought different projections of the logical bundle {A, B, C}), still the high connection strengths between A-B, B-C, and A-C result in the emergence of the logical bundle {A, B, C} in the insight/relationship determination module 320 and it's graph. Thus, the two stage process of first creating the atomic pair-wise relationships between products and then creating higher order structures from them gives insight/relationship determination module 320 a tremendous generalization capability that is not present in any retail mining framework. The same argument applies to other higher order structures such as bridges and phrases as well. This provides the insight/relationship determination module 320 a unique ability to find very interesting, novel, and actionable logical structures (bundles, phrases, bridges, etc.) that cannot be found otherwise.

The Insight/Relationship Determination Module Retail Mining Process

There are three stages in the insight/relationship determination module 320 retail mining process for extracting actionable insights and data-driven decisions from this transaction data:

1. Data Pre-processing—In this stage, the raw transaction data are (a) filtered and (b) customized for the next stage. Filtering cleans the data by removing the data elements (customers, transactions, line-items, and products) that are to be excluded from the analysis. Customization creates different slices of the filtered transaction data that may be analyzed separately and whose results may be compared for further insight generation, e.g. differences between two customer segments. This stage results in one or more clean, customized data slices on which further analyses may be done. Details of the Data Pre-processing stage are provided below.

2. The Insight/relationship determination module 320 Graph Generation—In this stage, The insight/relationship determination module 320 uses information theory and statistics to create The insight/relationship determination module 320 Graphs that exhaustively capture all pair-wise relationships between entities in a variety of contexts. There are several steps in this stage:
Context-Instance Creation—depending on the definition of the context, a number of context instances are created from the transaction data slice.
Co-occurrence Counting—For each pair of products, a co-occurrence count is computed as the number of context instances in which the two products co-occurred.
Co-occurrence Consistency—Once all the co-occurrence counting is done, information theoretic consistency measures are computed for each pair of products resulting in a The insight/relationship determination module 320 graph.

3. Insight Discovery and Decisioning from the Insight/relationship determination module Graphs—The insight/relationship determination module 320 graphs serve as the model or internal representation of the knowledge extracted from transaction data. They are used in two ways:
Product Related Insight Discovery—Here, graph theory and machine learning techniques are applied to the insight/relationship determination module 320 graphs to discover patterns of interest such as product bundles, bridge products, product phrases, and product neighborhoods. These patterns may be used to make decisions, such as store layout, strategic co-promotion for increased cross department traffic, web-site layout and customization for identified customer, and the like. Visualization tools such as a Product Space Browser have been developed to explore these insights.
Customer Related Decisioning—Here, the insight/relationship determination module graph is used as a model for decisions, such as a recommendation engine that predicts the most likely products a customer may buy given his past purchases. The recommendation engine may be used to predict not only what products the customer will buy, but also the most likely time when the customer will buy it, resulting in insight/relationship determination module 320's ability to make precise and timely recommendations. The recommendation engine can be part of the selection optimization module 340. Details of the recommendation engine are provided below.

The Insight/Relationship Determination Module 320 Benefits

The insight/relationship determination module 320 framework integrates a number of desirable features in it that makes it a very compelling and powerful retail analytic approach. The insight/relationship determination module 320 framework is:
Generalizable: In association rules for a product bundle (or itemset) to be selected as a potential candidate, it must occur sufficient number of times among all the market baskets, i.e. it should have a high enough support. This criterion limits the number and kind of product bundles that can be discovered especially, for large product bundles. The insight/relationship determination module 320 uses only pair-wise consistency relationships and uses the resulting graph to expand the size of the candidate item-sets systematically. This approach makes the insight/relationship determination module 320 far more accurate and actionable compared to association rules and similar frequency based approaches.
Scalable: Again, because of pair-wise relationships among the product and customers, the insight/relationship determination module 320 framework can represent a large number of sparse graphs. A typical implementation of the insight/relationship determination module 320 implementation on a single processor can easily handle hundreds of thousands of products, millions of customers, and billions of transactions within reasonable disk space and time complexities. Moreover, the insight/relationship determination module 320 framework is highly parallelizable and, therefore, can scale well with the number of products, number of customers, and number of transactions.
Flexible: The insight/relationship determination module 320 is flexible in several ways: First it supports multiple contexts simultaneously and facilitates the search for the right context(s) for a given application. Secondly, it represents and analyzes graphs at possibly multiple levels of entity hierarchies. Thirdly, it represents entity spaces as graphs and therefore draws upon the large body of graph theoretic techniques to address complex retail analytics problems. Most other frameworks have no notion of context; they can work well only at certain resolutions, and are very specific in their applications.
Adaptive: As noted before, both the product space and the customer space is very dynamic. New products are added, customers change over time, new customers get added to the market place and purchase trends change over time. To cope up with these dynamics of the modern day retail market, one needs a system that can quickly assimilate the newly generated transaction data and adapt its models accordingly. The insight/relationship determination module 320 is very adaptive as it can update its graph structures quickly to reflect any changes in the transaction data.
Customizable: The insight/relationship determination module 320 can be easily customized at various levels of operations: store level, sub-region level, region level, national level, international level. It can also be customized to different population segments. This feature allows store managers to quickly configure the various insight/relationship determination module applications to their stores or channels of interest in their local regions.
Interpretable: The insight/relationship determination module 320 results can be interpreted in terms of the sub-graphs that they depend upon. For example, bridge products, seed products, purchase career paths, product influences, similarity and consistency graphs, everything can be shown as two dimensional graph projections using the visualization tool of the insight/relationship determination module 320. These graphs are intuitive and easy to interpret by store managers and corporate executives both to explain results and make decisions.

### Retail Data

In the following discussion, a formal description of the retail data is presented. Mathematical notations are introduced to define products in the product space, customers in the customer space, and their properties. Additionally, the data pre-processing step involving filtering and customization are also described in this discussion.

Product Space

A retailer's product space is comprised of all the products sold by the retailer. A typical large retailer may sell anywhere from tens of thousands to hundreds of thousands of products. These products are organized by the retailer in a product hierarchy in which the finest level products (SKU or UPC level) are grouped into higher product groups. The total numbers of products at the finest level change over time as new products are introduced and old products are removed. However, typically, the numbers of products at coarser levels are more or less stable. The number of hierarchy levels and the number of products at each level may vary from one retailer to another. The following notation is used to represent products in the product space:
Total number of product hierarchy levels is L (indexed 0 . . . L−1), 0 being the finest level
Product Universe at level l is the set: Uₗ={u₁^{(l)}, . . . , uₘ^{(l)}, . . . , u_{M}_{ₗ}^{(l)}} with Mₗ products
Every product at the finest resolution is mapped to a coarser resolution product using many-to-one Product Maps that define the product hierarchy:

Mₗ:U₀→Uₗ

In addition to these product sets and mappings, each product has a number of properties as described below.

Customer Space

The set of all customers who have shopped at a retailer in the recent past form the customer base of the retailer. A large retailer may have anywhere from hundreds of thousands to tens of millions of customers. These customers may be geographically distributed for large retail chains with stores across the nation or internationally. The customer base might be demographically, financially, and behaviorally heterogeneous. Finally, the customer base might be very dynamic in three ways:

1. new customers add over time to the customer base,

2. old customers churn or move out of the customer base, and

3. existing customers change in their life stage and life style.

Due to the changing nature of the customer base, most retail analysis including customer segmentation must be repeated every so of ten to reflect the current status of the customer base. We use the following formal notation to represent customers in the customer space:
Total number of customers in the customer space at any snapshot: N
Customers will be indexed by n ∈ {1 . . . N}

As described below, each customer is associated with additional customer properties that may be used their retail analysis.

Retail Transaction Data

As described earlier, transaction data are essentially a time-stamped sequence of market baskets and reflect a mixture of both intentional and impulsive customer behavior. A typical transaction data record is known as a line-item, one for each product purchased by each customer in each visit. Each line-item contains fields such as customer id, transaction date, SKU level product id, and associated values, such as revenue, margin, quantity, discount information, and the like. Depending on the retailer, on an average, a customer may make anywhere from two, e.g. electronic and sports retailers, to 50, e.g. grocery and home improvement retailers, visits to the store per year. Each transaction may result in the regular purchase, promotional purchase, return, or replacement of one or more products. A line-item associated with a return transaction of a product is generally identified by the negative revenue. Herein, we are concerned only with product purchases. We use the following formal notation to represent transactions:
The entire transaction data is represented by: X={x⁽ⁿ⁾}_{n-1′}^{N}, where
Transactions of customer n are represented by the time-stamped sequence of market baskets:

x⁽ⁿ⁾=( [symbol] t₁⁽ⁿ⁾, x₁⁽ⁿ⁾ [symbol] , . . . , [symbol] t_{q}⁽ⁿ⁾, x_{q}⁽ⁿ⁾ [symbol] , . . . , [symbol] t_{Qn}ⁿ, x_{Qn}⁽ⁿ⁾ [symbol] ),

### Where:

t_{q}⁽ⁿ⁾ is the date of the q^{th} transaction by the n^{th} customer, and

$${x}_{q}^{( n )} = {y}_{0. q}^{( n )} = {\{ {x}_{q . s}^{( n )} \}}_{s = 1}^{{S}_{0. q}^{( n )}} ⊆ {U}_{0}$$

is the q^{th} market basket of n^{th} customer at level 0
Size of market basket at level 0 is S_{0,q}⁽ⁿ⁾
Market basket at resolution l is defined as:

$${y}_{l , q}^{( n )} = {⋃}_{X ∈ {X}_{q}^{( n )}} {M}_{l} ( x )$$

Properties in Retail Data

There are four types of objects in the retail data:

1. Product—atomic level object in the product space

2. Line Item—each line (atomic level object) in transaction data

3. Transaction—collection of all line items associated with a single visit by a customer

4. Customer—collection of all transactions associated with a customer

Typically, each of these objects is further associated with one or more properties that may be used to (i) filter, (ii) customize, or (iii) analyze the results of various retail applications. Notation and examples of properties of these four types of objects are as follows:

Product Properties

The insight/relationship determination module 320 recognizes two types of product properties:

1. Given or Direct product properties that are provided in the product dictionary, e.g. manufacturer, brand name, product type (consumable, general merchandise, service, warranty, etc.), current inventory level in a store, product start date, product end date (if any), etc. These properties may also be level dependent, for example, manufacture code may be available only for the finest level.

2. Computed or Indirect product properties are summary properties that can be computed from the transaction data using standard OLAP summarizations, e.g. average product revenue per transaction, total margin in the last one year, average margin percent, etc. Indirect properties of a coarser level product may be computed by aggregating the corresponding properties of its finer level products.

Line Item Properties

Each line item is typically associated with a number of properties such as quantity, cost, revenue, margin, line item level promotion code, return flag, etc.

Transaction Properties

The insight/relationship determination module 320 recognizes two types of transaction properties:

1. Direct or Observed properties such as transaction channel, e.g. web, phone, mail, store id, etc., transaction level promotion code, transaction date, payment type used, etc. These properties are typically part of the transaction data itself.

2. Indirect or Derived properties such as aggregates of the line item properties, e.g. total margin of the transaction, total number of products purchased, and market basket diversity across higher level product categories, etc.

Customer Properties

The insight/relationship determination module 320 recognizes three types of customer properties:

1. Demographic Properties about each customer, e.g. age, income, zip code, occupation, household size, married/unmarried, number of children, owns/rent flag, etc., that may be collected by the retailer during an application process or a survey or from an external marketing database.

2. Segmentation Properties are essentially segment assignments of each customer (and may be associated assignment weights) using various segmentation schemes, e.g. demographic segments, value based segments (RFMV), or purchase behavior based segment.

3. Computed Properties are customer properties computed from customer transaction history, e.g. low vs. high value tier, new vs. old customer, angle vs. demon customer, early/late adopter and the like.

Data Pre-Processing

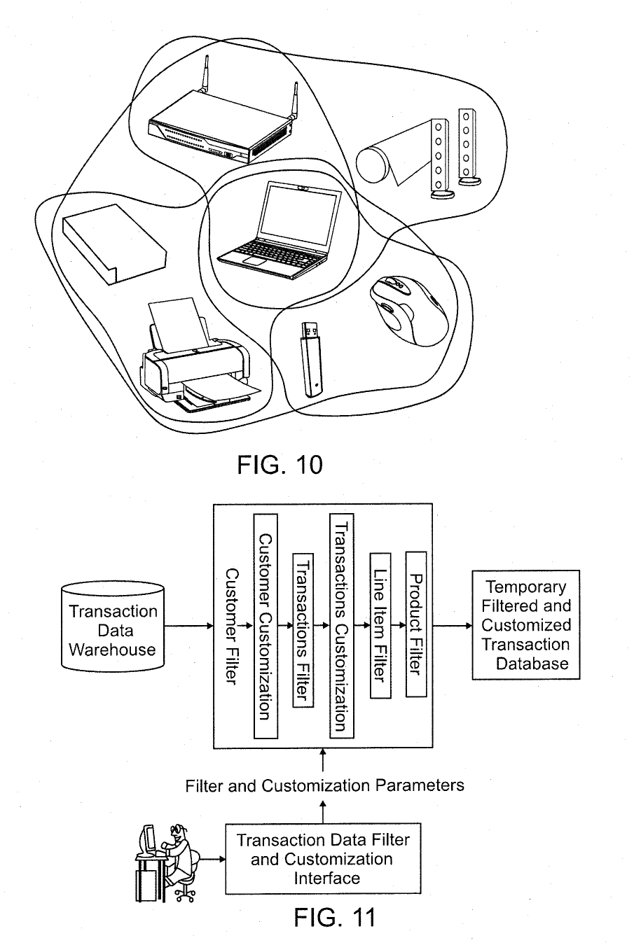

As described herein, the first step in the insight/relationship determination module 320 process is data pre-processing. It involves two types of interspersed operations. As shown in FIG. 11, data pre-processing involves both data filtering (at customer, transaction, line item, and product levels) and customization (at customer and transaction levels).

Filtering

Not everything in the transaction data may be useful in a particular analysis. The insight/relationship determination module 320 manages this through a series of four filters based on the four object types in the transaction data: products, line items, transactions, customers.

1. Product Filter—For some analyses, the retailer may not be interested in using all the products in the product space. A product filter allows the retailer to limit the products for an analysis in two ways:
(a) Product Scope List allows the retailer to create a list of in-scope products. Only products that are in this list are used in the analyses. For example, a manufacturer might be interested in analyzing relationships between his own products in a retailer's data;
(b) Product Stop List allows the retailer to create a list of out-of-scope products that must not be used in the analyses. For example, a retailer might want to exclude any discontinued products. These product lists may be created from direct and product properties.

2. Line Item Filter—For some analyses, the retailer may not be interested in using all the line items in a customer's transaction data. For example, he may not want to include products purchased due to a promotion, or products that are returned, etc. Rules based on line item properties may be defined to include or exclude certain line items in the analyses.

3. Transaction Filter—Entire transactions may be filtered out of the analyses based on transaction level properties. For example, one may be interested only in analyzing data from last three years or transactions containing at least three or more products, or the like. Rules based on transaction properties may be used to include or exclude certain transactions from the analysis.

4. Customer Filter—Finally, transaction data from a particular customer may be included or excluded from the analysis. For example, the retailer may want to exclude customers who did not buy anything in the last six months or who are in the bottom 30% by value. Rules based on customer properties may be defined to include or exclude certain customers from the analysis.

Customization

To create specific insights and/or tailored decisions, the insight/relationship determination module 320 allows customization of the analyses either by customer, e.g. for specific customer segments, or by transactions, e.g. for specific seasons or any combination of the two. This is achieved by applying the analyses on a customization specific sample of the transaction data, instead of the entire data.

1. Customer Customization—Retailers might be interested in customizing the analyses by different customer properties. One of the most common customer properties is the customer segment which may be created from a combination of demographic, relationship (i.e. how the customer buys at the retailer: recency, frequency, monetary value, (RFMV)), and behavior (i.e. what the customer buys at the retailer) properties associated with the customer. Apart from customer segments, customizations may also be done, for example, based on: customer value (high, medium, low value), customer age (old, new customers), customer membership (whether or not they are members of the retailer's program), customer survey responses, and demographic fields, e.g. region, income level, etc. Comparing The insight/relationship determination module 320 analyses results across different customer customizations and across all customers generally leads to valuable insight discovery.

2. Transaction Customization—Retailers might be interested in customization of the analyses by different transaction properties. The two most common transaction customizations are: (a) Seasonal customization and (b) Channel customization. In seasonal customization the retailer might want to analyze customer behavior in different seasons and compare that to the overall behavior across all seasons. This might be useful for seasonal products, such as Christmas gifts or school supplies, etc. Channel customization might reveal different customer behaviors across different channels, such as store, web site, phone, etc.

Together all these customizations may result in specific insights and accurate decisions regarding offers of the right products to the right customers at the right time through the right channel. At the end of the data-preprocessing stage the raw transaction data is cleaned and sliced into a number of processed transaction data sets each associated with a different customization. Each of these now serve as possible inputs to the next stages in the insight/relationship determination module 320 process.

Pair-Wise Contextual Co-Occurrences

According to the definition of The insight/relationship determination module 320 herein, it seeks pair-wise relationships between entities in specific contexts. In the following discussion, the notion of context is described in detail, especially as it applies to the retail domain. For each type of context the notion of a context instance, a basic data structure extracted from the transaction data, is described. These context instances are used to count how many times a product pair co-occurred in a context instance. These co-occurrence counts are then used in creating pair-wise relationships between products.

Definition of a Context

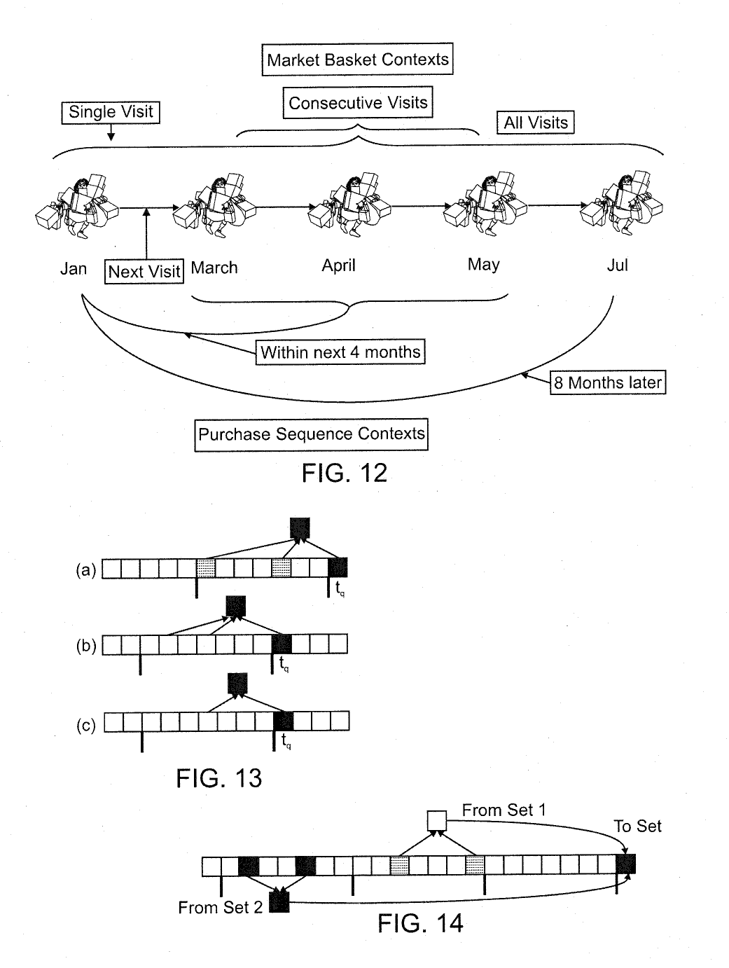

The concept of Context is fundamental to the framework of insight/relationship determination module 320. A context is nothing but a way of defining the nature of relationship between two entities by way of their juxtaposition in the transaction data. The types of available contexts depend on the domain and the nature of the transaction data. In the retail domain, where the transaction data are a time-stamped sequence of market baskets, there are a number of ways in which two products may be juxtaposed in the transaction data. For example, two products may be purchased in the same visit, e.g. milk and bread, or one product may be purchased three months after another, e.g. a printer purchased three months after a PC, or a product might be purchased within six months of another product, e.g. a surround sound system may be purchased within six months of a plasma TV, or a product may be purchased between two to four months of another, e.g. a cartridge is purchased between two to four months of a printer or previous cartridge. The insight/relationship determination module 320 retail mining framework is context rich, i.e. it supports a wide variety of contexts that may be grouped into two types as shown in FIG. 12: market basket context and purchase sequence context. Each type of context allows is further parameterized to define contexts as necessary and appropriate for different applications and for different retailer types.

For every context, the insight/relationship determination module 320 uses a three step process to quantify pair-wise co-occurrence consistencies for all product pairs: (α,β)∈ Uₗ×Uₗ for each level l at which the analysis is to be done in the insight/relationship determination module 320.

1. Create context instances from filtered and customized, transaction data slice,

2. Count the number of times the two products co-occurred in those context instances, and

3. Compute information theoretic measures to quantify consistency between them.

These three steps are described for both the market basket and purchase sequence contexts next.

Market Basket Context

Almost a decade of research in retail data mining has focused on market basket analysis. Traditionally, a market basket is defined as the set of products purchased by a customer in a single visit. In the insight/relationship determination module 320, however, a market basket context instance is defined as a SET of products purchased on one or more consecutive visits. This definition generalizes the notion of a market basket context in a systematic, parametric way. The set of all products purchased by a customer (i) in a single visit, or (ii) in consecutive visits within a time window of (say) two weeks, or (iii) all visits of a customer are all valid parameterized instantiations of different market basket contexts. A versatile retail mining framework should allow such a wide variety of choices for a context for several reasons:
Retailer specific market basket resolution—Different market basket context resolution may be more appropriate for different types of retailers. For example, for a grocery or home improvement type retailer, where customers visit more frequently, a fine time resolution, e.g. single visit or visits within a week, market basket context might be more appropriate. While for an electronics or furniture type retailer, where customers visit less frequently, a coarse time resolution, e.g. six months or a year, market basket context might be more appropriate. Domain knowledge such as this may be used to determine the right time resolution for different retailer types.
Time elapsed intentions—As mentioned above, transaction data is a mixture of projections of possibly time-elapsed latent intentions of customers. A time elapsed intention may not cover all its products in a single visit. Sometimes the customer just forgets to buy all the products that may be needed for a particular intention, e.g. a multi-visit birthday party shopping, and may visit the store again the same day or the very next day or week. Sometimes the customer buys products as needed in a time-elapsed intention for example a garage re-modeling or home theater set up that might happen in different stages, the customer may choose to shop for each stage separately. To accommodate both these behaviors, it is useful to have a parametric way to define the appropriate time resolution for a forgot visit, e.g. a week, to a intentional subsequent visit, e.g. 15 to 60 days.

For a given market basket definition, the conventional association rules mining techniques try to find high support and high confidence item-sets. As mentioned above, these approaches fail because of two fundamental reasons: First the logical product bundles or item-sets typically do not occur as the transaction data is only a projection of logical behavior and, secondly, using frequency in a domain where different products have different frequency of purchase leads to a large number of spurious item-sets. The framework of the insight/relationship determination module 320 framework corrects these problems as described above. Consider the first two steps of creating pair-wise co-occurrence counts for the market basket context.

Creating Market Basket Context Instances

A parametric market basket context is defined by a single parameter: window width: ω. Technique 1 below describes how the insight/relationship determination module 320 creates market basket context instances, Bₙ, given:
A customer's transaction history: x⁽ⁿ⁾
The last update date (for incremental updates): tₗₐₛₜ (which is 0 for the first update)
The window width parameter ω (number of days)
The function M that maps a SKU level market basket into a desired level basket.

Technique 1: Create Market basket context instances from
a customer's transaction data.
B = CreateMarketBasketContextInstances(x⁽ⁿ⁾, tₗₐₛₜ, ω, M)

Initialize: B ← Ø; qₚᵣₑᵥ ← Qₙ + 1; q ← Qₙ
While (q ≧ 1) and (t_{q} ≧ tₗₐₛₜ)

qₗₐₛₜ ← q; b_{q} ← M (x_{q}⁽ⁿ⁾); p ← q − 1
$While ( p \geq 1 ) and ( ⌊ \frac{{t}_{q}^{( n )} - {t}_{p}^{( n )}}{ω} ⌋ = 0 )$

b_{q} ← b_{q} ∪ M (xₚ⁽ⁿ⁾);
qₗₐₛₜ ← p; p ← p − 1

If (qₗₐₛₜ < qₚᵣₑᵥ) and (|b_{q} |> 1)

B ← B ⊕ b_{q}

qₚᵣₑᵥ ← qₗₐₛₜ; q ← q−1

Return B

The technique returns a (possibly empty) set of market basket context instances or a set of market baskets, B=Bₙ(ω). The parameter tₗₐₛₜ is clarified later when we show how this function is used for the initial co-occurrence count and incremental co-occurrence updates since the last update.

The basic idea of Technique 1 is as follows: Consider a customer's transaction data shown in FIG. 13. In FIG. 13, each cell in the three time lines represents a day. A grey cell in the time line indicates that the customer made a purchase on that day. The block above the time line represents the accumulated market basket. The thick vertical lines represent the window boundary starting from any transaction day (dark grey cell) going backwards seven (window size in this example) days in the past. Starting from the -last transaction, (the darkest shade of grey) and accumulate two lighter grey market baskets in the time line, i.e. take the union of the dark grey market basket with the two lighter grey market baskets as they are purchased within a window of seven days prior to it. The union of all three results in the first market basket context instance represented by the block above the time line for this customer. In the second iteration, shown in FIG. 13(b), we move to the second last transaction and repeat the process. FIG. 13(c) highlights an important caveat in this process. If FIG. 13(c) represents the customer data instead of FIG. 13(a), i.e. the lightest grey transaction in FIG. 13(a) is missing. In the second iteration on FIG. 13(c), the resulting market basket context instance should be a union of the two (dark and lighter) grey market baskets. However, these two transactions are already part of the first market basket context instance in FIG. 13(a). Therefore, if FIG. 13(c) is the transaction history, then the market basket context instance in the second iteration is ignored because it is subsumed by the market basket context instance of the first iteration.

Creating Market Basket Co-Occurrence Counts

The insight/relationship determination module 320 maintains the following four counts for each product level l at which the market basket analysis is done.
Total number of market basket instances: η_{ω}^{mb}(,)

$${η}_{ω}^{mb} ( \cdot , \cdot ) = {\sum }_{n = 1}^{N} \vert {B}_{n} ( ω ) \vert$$

Total number of market basket instances in which a product occurred, also known as product margin: η_{ω}^{mb}(α,)=η_{ω}^{mb}(,α) for all products α ∈ Uₗ(δ(e) is 1 if the Boolean expression e is true, otherwise it is 0)

$${η}_{ω}^{mb} ( α , \cdot ) = {η}_{ω}^{mb} ( \cdot , α ) = {\sum }_{n = 1}^{N} {\sum }_{{beB}_{n} ( ω )} δ ( α ∈ b )$$

Total number of market basket instances in which the product pair (α,β):α≠β co-occurred for all product pairs:

$$( α , β ) ∈ {U}_{l} \times {U}_{l} : {η}_{ω}^{mb} ( α , β )$$

$${η}_{ω}^{mb} ( α , β ) = {η}_{ω}^{mb} ( β , α ) = {\sum }_{n = 1}^{N} {\sum }_{{beB}_{n} ( ω )} δ ( α ∈ b ) \times δ ( β ∈ b )$$

Note that the market basket context results in a symmetric co-occurrence counts matrix. Also, the diagonal elements of the matrix are zero because the product co-occurrence with itself is not a useful thing to define. A threshold is applied to each count such, that if the count is less than the threshold, it is considered zero. Also note that the single visit market basket used in traditional market basket analysis tools is a special parametric case: ω=0.

Purchase Sequence Context

While market basket context is ubiquitous in the retail mining literature, it is clear that it either ignores when it uses single visits as market baskets, or loses when it uses consecutive visits as market baskets, temporal information that establishes contexts across time. These purchase sequence contexts, as they are called in the insight/relationship determination module 320, may be very critical in making not only precise decisions about what product to offer a particular customer, but also timely decisions about when the product should be offered. For example, in grocery domain, there might be one group of customers who buy milk every week while another group who might buy milk once a month. In, for example, electronics retailers, where this is even more useful, there might be one group of customers who use cartridge more quickly than others or who change their cell phones more frequently than others, etc. Further, there might be important temporal relationships between two or more products for example between a PC purchase; followed by a new printer purchase; followed by the first cartridge purchase. There might be consistent product phrases that may be result in important insights and forecasting or prediction decisions about customers. The purchase sequence type context in The insight/relationship determination module 320 makes such analyses possible.

Creating Purchase Sequence Context Instances

Unlike a market basket context instance, which is nothing but a market basket or a single set of products, the purchase sequence context instance is a triplet: [symbol] a,b,Δt [symbol] with three elements:
The from set: a=set of products purchased at some time in the past
The to set: b=set of products purchased at some time in the future (relative to set a)
The time lag between the two: Δt

The time t in the transaction data is in days. Typically, it is not useful to create purchase sequence context at this resolution because at this resolution we may not have enough data, moreover, this may be a finer resolution than the retailer can make actionable decisions on. Therefore, to allow a different time resolution, we introduce a parameter: ρ that quantifies the number of days in each time unit (Δt). For example, if ρ=7, the purchase sequence context is computed at week resolution. Technique 2, below, describes the technique for creating a set of purchase sequence context instances, given:
A customer's transaction history: x⁽ⁿ⁾
The last update date (for incremental updates): tₗₐₛₜ (which is 0 for the first update)
The time resolution parameter ρ
The function M that maps a SKU level market basket into a desired level basket.

The time in days is converted into the time units in Technique 2 using the function:

$$γ ( {t}_{future} , {t}_{past} , ρ ) = ⌊ \frac{{t}_{future} - {t}_{past}}{ρ} ⌋$$

The technique returns a (possibly empty) set of purchase sequence context instances or a set of triplets, [symbol] a,b,Δt [symbol] , P=Pₙ(ρ). Again, the parameter tₗₐₛₜ is clarified later when we show how this function is used for the initial co-occurrence count and incremental co-occurrence updates since the last update.

Technique 2: Create Purchase Sequence context instances from
a customer's transaction data.

```
P = CreatePurchaseSequenceContextInstances(x⁽ⁿ⁾,tₗₐₛₜ,ρ,M )
Initialize: P ← Ø; q ← Qₙ
While (q ≧ 2) and (t_{q} ≧ tₗₐₛₜ)
  - b_{q} ← M (x_{q}⁽ⁿ⁾); p ← q−1;
  - While (p ≧ 1) and (γ(t_{q}⁽ⁿ⁾,tₚ⁽ⁿ⁾,ρ) = 0) [symbol]  p ← p−1;  // Skip
  all market basket contexts
  - If (p = 0) [symbol]  Break;
  - a_{q} ← M (xₚ⁽ⁿ⁾);Δtₗₐₛₜ = γ(t_{q}⁽ⁿ⁾,tₚ⁽ⁿ⁾,ρ);p ← p−1;
  - While (p ≧ 1)
    - Δt= γ(t_{q}⁽ⁿ⁾,tₚ⁽ⁿ⁾,ρ)
    - If (Δt = Δtₗₐₛₜ) [symbol]  a_{q} ← a_{q} ∪ M (xₚ⁽ⁿ⁾);
    - Else
      - If (a_{q} ≠ Ø) and (b_{q} ≠ Ø) [symbol]  P ← P ⊕ [symbol] a_{q},b_{q},Δtₗₐₛₜ [symbol]
      - a_{q} ← M (xₚ⁽ⁿ⁾);Δtₗₐₛₜ ← Δt
    - p ← p−1;
  - If (a_{q} ≠ Ø) and (b_{q} ≠ Ø) [symbol]  P ← P ⊕ [symbol]  a_{q},b_{q},Δtₗₐₛₜ [symbol]
Return P
```

FIG. 14 shows the basic idea of Technique 2. In FIG. 14, each non-empty cell represents a transaction. If the last grey square on the right is the TO transaction, then there are two FROM sets: the union of the two center grey square transactions and the union of the two left grey square transactions resulting, correspondingly, in two context instances. Essentially we start from the last transaction (far right) as in the market basket context. We ignore any transactions that might occur within the previous seven days (assuming the time resolution parameter ρ=7). Now continuing back, we find the two transactions at Δt=1 (second and third grey squares from the right). The union of the two becomes the first FROM set resulting in the purchase sequence context instance (the grey square above the time line union=FROM, last grey square on the right=TO, Δt=1). Going further back there are two transactions at Δt=2 (two left most grey squares). The union of these two becomes the second FROM set resulting in the purchase sequence context instance (grey square below the time line union=FROM, last grey square on the right=TO, Δt=1).

Creating Purchase Sequence Co-Occurrence Counts

In the market basket context, there is a symmetric 2-D matrix with zero diagonals to maintain the co-occurrence counts. In purchase sequence context, a non-symmetric, three dimensional matrix to denote the co-occurrence counts is used. The insight/relationship determination module 320 maintains the following matrices for the purchase sequence co-occurrence counts:
Total number of purchase sequence instances with each time lag

$$Δ τ \text{:} {η}_{ρ}^{p s} ( \cdot , \cdot \vert Δ τ )$$

$${η}_{ρ}^{p s} ( \cdot , \cdot \vert Δ τ ) = {\sum }_{n = 1}^{N} {\sum }_{( a , b , Δ τ ) ∈ {P}_{n} ( ρ )} δ ( Δ t = Δ τ )$$

Total number of market basket instances in which a product occurred in the FROM set a, (From Margin) for each time lag Δτ for all products

$$α ∈ {U}_{l} \text{:} {η}_{ρ}^{p s} ( α , \cdot \vert Δ τ )$$

$${η}_{ρ}^{p s} ( α , \cdot \vert Δ τ ) = {\sum }_{n = 1}^{N} {\sum }_{( a , b , Δ τ ) ∈ {P}_{n} ( ρ )} δ ( α ∈ a ) \times δ ( Δ t = Δ τ )$$

Total number of market basket instances in which a product occurred in the TO set b, (To Margin) for each time lag Δτ for all products

$$β ∈ {U}_{l} \text{:} {η}_{ρ}^{p s} ( \cdot , β \vert Δ τ )$$

$${η}_{ρ}^{p s} ( \cdot , β \vert Δ τ ) = {\sum }_{n = 1}^{N} {\sum }_{( a , b , Δ τ ) ∈ {P}_{n} ( ρ )} δ ( β ∈ b ) \times δ ( Δ t = Δ τ )$$

Total number of market basket instances in which the product pair (α,β):α≠β co-occurred where the FROM product α occurred time lag Δt before the TO product β for all product pairs:

$$( α , β ) ∈ {U}_{l} \times {U}_{l} \text{:} {η}_{ρ}^{p s} ( α , β \vert Δ τ )$$

$${η}_{ρ}^{p s} ( α , β \vert Δ τ ) = {\sum }_{n = 1}^{N} {\sum }_{( a , b , Δ τ ) ∈ {P}_{n} ( ρ )} δ ( α ∈ a ) \times δ ( β ∈ b ) \times δ ( Δ t = Δ τ )$$

$${η}_{ρ}^{p s} ( α , β \vert Δ τ ) = {η}_{ρ}^{p s} ( β , α \vert - Δ τ )$$

Note that:

Initial vs. Incremental Updates

Transaction data are collected on a daily basis as customers shop. When in operation, the insight/relationship determination module 320 co-occurrence count engine uses an initial computation of the four counts: totals, margins, and co-occurrence counts using one pass through the transaction data. After that incremental updates may be done on a daily, weekly, monthly, or quarterly basis depending on how the incremental updates are set up.
Let t₀=the earliest date such that all transactions on or after this date to be included.
Let tₗₐₛₜ=the last transaction date of last update

```
InitialUpdate(t₀,ω,M )
  - For n = 1...N
    - Bₙ(ω)=CreateMarketBasketContextInstance(x⁽ⁿ⁾,t₀,ω,M)
    - ProcessMarketBasketContext(Bₙ(ω))
    - Pₙ(ρ)=CreatePurchaseSequenceContextInstance(x⁽ⁿ⁾,t₀,ρ,M)
    - ProcessPurchaseSequenceContext(Pₙ(ρ))
IncrementalUpdate(tₗₐₛₜ,ω,M )
  - For n = 1...N
    - If (t_{Q}_{ₙ} > tₗₐₛₜ) // If the customer purchased since last update
      - Bₙ(ω)=CreateMarketBasketContextInstance(x⁽ⁿ⁾,tₗₐₛₜ,ω,M)
      - ProcessMarketBasket(Bₙ(ω))
      - Pₙ(ρ)=CreatePurchaseSequenceContextInstance(x⁽ⁿ⁾,t₀,ρ,M)
      - ProcessPurchaseSequenceContext(Pₙ(ρ))
```

The time complexity of the initial update is

$$O ( {\sum }_{n = 1}^{N} {Q}_{n}^{2} )$$

and the time complexity of the incremental update is

$$O ( {\sum }_{n = 1}^{N} {I}_{n}^{2} ) ,$$

where Iₙ is the number of new transactions since the last update.

### Consistency Measures

The insight/relationship determination module 320 framework does not use the raw co-occurrence counts (in either context) because the frequency counts do not normalize for the margins. Instead, The insight/relationship determination module 320 uses consistency measures based on information theory and statistics. A number of researchers have created a variety of pair-wise consistency measures with different biases that are available for use in the insight/relationship determination module 320. Described in the following discussion is how these consistency matrices may be computed from the sufficient statistics that have already computed in the co-occurrence counts.

Definition of Consistency

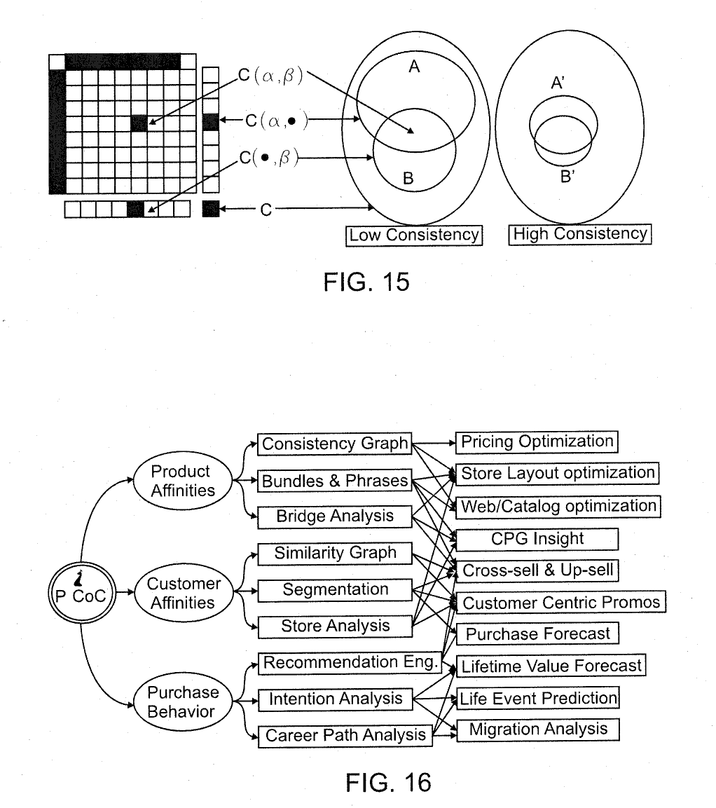

Instead of using frequency of co-occurrence, consistency is used to quantify the strength of relationships between pairs of products. Consistency is defined as the degree to which two products are more likely to be co-purchased in a context than they are likely to be purchased independently. There are a number of ways to quantify this definition. The four counts, i.e. the total, the two margins, and the co-occurrence, are sufficient statistics needed to compute pair-wise co-occurrence. FIG. 15 shows the four counts and their Venn diagram interpretation. For any product pair (α,β) let A denote the set of all the context instances in which product α occurred and let B denote the set of all context instances in which product β occurred and let T denote the set of all context instances.

In terms of these sets,

η(α,β)=|A∩B|;η(,)=|T|

η(α,)=|A|;η(,β)=|B|

In the left and the right Venn diagrams, the overlap between the two sets is the same. However, in case of sets A′ and B′, the relative size of the overlap compared to the sizes of the two sets is higher than that for the sets A and B and hence by our definition, the consistency between A′, B′ is higher than the consistency between A, B.

For the purchase sequence context, the four counts are available at each time-lag therefore all the equations above and the ones that follow can be generalized to purchase sequence as follows: η(*,*)→η(*,*|Δτ), i.e. all pair-wise counts are conditioned on the time-lag in the purchase sequence context.

Co-Occurrence Counts: Sufficient Statistics

The counts, i.e. total, the margin(s), and the co-occurrence counts, are sufficient statistics to quantify all the pair-wise co-occurrence consistency measures in insight/relationship determination module 320. From these counts, the following probabilities can be computed:

$$\begin{matrix}P ( α , \cdot ) = \frac{η ( α , \cdot )}{η ( \cdot , \cdot )} ; P ( \overline{α} , \cdot ) \\ = 1 - P ( α , \cdot ) \\ = \frac{η ( \cdot , \cdot ) - η ( α , \cdot )}{η ( \cdot , \cdot )}\end{matrix}$$

$$\begin{matrix}p ( β , \cdot ) = \frac{η ( \cdot , β )}{η ( \cdot , \cdot )} ; P ( \cdot , \overline{β} ) \\ = 1 - P ( β , \cdot ) \\ = \frac{η ( \cdot , \cdot ) - η ( \cdot , β )}{η ( \cdot , \cdot )}\end{matrix}$$

$$P ( α , β ) = \frac{η ( α , β )}{η ( \cdot , \cdot )} ;$$

$$P ( \overline{α} , \overline{β} ) = \frac{η ( \cdot , \cdot ) - [ η ( α , \cdot ) + η ( \cdot , β ) - η ( α , β ) ]}{η ( \cdot , \cdot )}$$

$$P ( α , \overline{β} ) = \frac{η ( α , \cdot ) - η ( α , β )}{η ( \cdot , \cdot )} ;$$

$$P ( \overline{α} , β ) = \frac{η ( \cdot , β ) - η ( α , β )}{η ( \cdot , \cdot )}$$

There are two caveats in these probability calculations: First if any of the co-occurrence or margin counts is less than a threshold then it is treated as zero. Second, it is possible to use smoother versions of the counts, which is not shown in these equations. Finally, if due to data sparsity, there are not enough counts, then smoothing from coarser class levels may also be applied.

Consistency Measures Library

There are a number of measures of interestingness that have been developed in statistics, machine learning, and data mining communities to quantify the strength of consistency between two variables. All these measures use the probabilities discussed above. Examples of some of the consistency measures are given below.
Context between all pairs of products at any product level is stored in a Consistency Matrix: Φ
   For Market Basket Context

Φ={φ(α,β)}:∀α,β ∈ Uₗ

φ(α,β)=ƒ(η(æ,),η(α,),η(æ,β),η(α,β))
For Purchase Sequence Context used in product phrases:

Φ={φ(α,β;Δτ)}:∀α,β ∈ Uₗ,Δτ ∈ {0 . . . ΔT}

φ(α,β;Δτ)=ƒ(η(,;Δτ),η(α,;Δτ),η(,β;Δτ),η(α,β;Δτ))

Before we go into the list of consistency measures, it is important to note some of the ways in which we can characterize a consistency measure. While all consistency measures normalize for product priors in some way, they may be:
Symmetric (non-directional) vs. Non-symmetric (directional)—There are two kinds of directionalities in the insight/relationship determination module 320. One is the temporal directionality that is an inherent part of the purchase sequence context and which is missing from the market basket context. The second kind of directionality is based on the nature of the consistency measure. By definition:

φ(α,β)=φ(β,α) [symbol] Symmetric Market Basket Consistency

φ(α|β)≠φ(β|α) [symbol] Asymmetric Market Basket Consistency

φ(α,β;Δt)=φ(β,α;−Δt) [symbol] Symmetric Purchase Sequence Consistency

φ(α|β;Δt)≠φ(β|α;−Δt) [symbol] Asymmetric Purchase Sequence Consistency
Normalized or Un-normalized—Consistency measures that take a value in a fixed range (say 0-1) are considered normalized and those that take values from negative infinity (or zero) to positive infinity are considered un-normalized.
Uses absence of products as information or not—Typically in retail, the probability of absence of a product either in the margins or in the co-occurrence, i.e. P( α̅,),P(, β̅),P( α̅,β),P(α, β̅),P( α̅, β̅) would be relatively higher than the probability of the presence of the product, i.e. P(α,), P(,β), P(α,β). Some consistency measures use absence of products also as information which may bias the consistency measures for rare or frequent products.

These properties are highlighted as appropriate for each of the consistency measures in the library. For the sake of brevity, in the rest of this discussion, we use the following shorthand notation for the marginal probabilities:

P(α,)≡P(α);P(,β)≡P(β)

Statistical Measures of Consistency

Pearson's Correlation Coefficient

Correlation coefficient quantifies the degree of linear dependence between two variables which are binary in our case indicating the presence or absence of two products. It is defined as:

$$φ ( α , β ) = \frac{Cov ( α , β )}{Std ( α ) Std ( β )} = \frac{{χ}^{2}}{η ( \cdot , \cdot )} \\ = \frac{P ( α , β ) P ( \overline{α} , \overline{β} ) - P ( α , \overline{β} ) P ( \overline{α} , β )}{\sqrt{P ( α , \cdot ) P ( \overline{α} , \cdot ) P ( \cdot , β ) P ( \cdot , \overline{β} )}} ∈ [ - 1 , + 1 ]$$

Comments:
Symmetric and Normalized, Related to χ².
Uses both presence and absence of products as information. Hard to distinguish whether the correlation is high because of co-occurrence, i.e. P(α,β) or because of co-non-occurrence, i.e. P( α̅, β̅). The latter tends to outweigh the former.

Goodman and Kruskal's λ-Coefficient

λ-coefficient minimizes the error of predicting one variable given the other. Hence, it can be used in both a symmetric and a non-symmetric version:

Asymmetric Versions:

$$φ ( α \vert β ) = \frac{P ( {ɛ}_{α} ) - P ( {ɛ}_{α} \vert β )}{P ( {ɛ}_{α} )} = \frac{M ( α \vert β ) + M ( α \vert \overline{β} ) - M ( α )}{1 - M ( α )}$$

$$φ ( β \vert α ) = \frac{P ( {ɛ}_{β} ) - P ( {ɛ}_{β} \vert α )}{P ( {ɛ}_{β} )} = \frac{M ( β \vert α ) + M ( β \vert \overline{α} ) - M ( β )}{1 - M ( β )}$$

### Where:

M(α|β)=max{P(α,β),P( α̅,β)};M(α| β̅)=max{P(α, β̅),P( α̅, β̅)}

M(β|α)=max{P(α,β),P(α, β̅)}; M(β| α̅)=max{P( α̅,β),P( α̅, β̅)}

M(α)=max{P(α),P( α̅)};M(β)=max{P(β),P( β̅)}

Symmetric Versions:

$$\begin{matrix}φ ( α , β ) = \frac{P ( {ɛ}_{α} ) + P ( {ɛ}_{β} ) - P ( {ɛ}_{α} \vert β ) - P ( {ɛ}_{β} \vert α )}{P ( {ɛ}_{α} ) + P ( {ɛ}_{β} )} \\ = \frac{M ( α \vert β ) + M ( α \vert \overline{β} ) + M ( β \vert α ) + M ( β \vert \overline{α} ) - M ( α ) - M ( β )}{2 - M ( α ) - M ( β )}\end{matrix}$$

Comments:
Both symmetric and non-symmetric versions available
Affected more by the absence of products than their presence

Odds Ratio and Yule's Coefficients

Odds Ratio measures the odds of two products occurring or not occurring compared to one occurring and another non-occurring: The odds ratio is given by:

$$φ ( α , β ) = odds ( α , β ) = \frac{P ( α , β ) P ( \overline{α} , \overline{β} )}{P ( \overline{α} , β ) P ( α , \overline{β} )}$$

Odds may be unbounded and hence two other measures based on odds ratio are also proposed:

Youle-Q:

$$\begin{matrix}φ ( α , β ) = \frac{odds ( α , β ) - 1}{odds ( α , β ) + 1} \\ = \frac{P ( α , β ) P ( \overline{α} , \overline{β} ) - P ( \overline{α} , β ) P ( α , \overline{β} )}{P ( α , β ) P ( \overline{α} , \overline{β} ) + P ( \overline{α} , β ) P ( α , \overline{β} )}\end{matrix}$$

Youle's-Y:

$$\begin{matrix}φ ( α , β ) = \frac{\sqrt{odds ( α , β )} - 1}{\sqrt{odds ( α , β )} + 1} \\ = \frac{\sqrt{P ( α , β ) P ( \overline{α} , \overline{β} )} - \sqrt{P ( \overline{α} , β ) P ( α , \overline{β} )}}{\sqrt{P ( α , β ) P ( \overline{α} , \overline{β} )} + \sqrt{P ( \overline{α} , β ) P ( α , \overline{β} )}}\end{matrix}$$

Piatetsky-Shapiro's

φ(α|β)=P(α,β)−P(α)P(β)

Added Value

$$φ ( α \vert β ) = max \{ P ( β \vert α ) - P ( β ) , P ( α \vert β ) - P ( α ) \} = \frac{P ( α , β ) - P ( β )}{min \{ P ( α ) , P ( β ) \}}$$

Klosgen

$$\begin{matrix}φ ( α \vert β ) = \sqrt{P ( α , β )} max \{ P ( β \vert α ) - P ( β ) , P ( α \vert β ) - P ( α ) \} \\ = \sqrt{P ( α , β )} [ \frac{P ( α , β ) - P ( β )}{min \{ P ( α ) , P ( β ) \}} ]\end{matrix}$$

Certainty Coefficients

Asymmetric Versions:

$$φ ( α \vert β ) = \frac{P ( α \vert β ) - P ( β )}{1 - P ( β )} ; φ ( β \vert α ) = \frac{P ( β \vert α ) - P ( α )}{1 - P ( α )}$$

Symmetric Version:

$$φ ( α , β ) = max \{ \frac{P ( α \vert β ) - P ( β )}{1 - P ( β )} , \frac{P ( β \vert α ) - P ( α )}{1 - P ( α )} \}$$

Data Mining Measures of Consistency

Support

φ(α,β)=P(α,β)

Confidence

Asymmetric Version:

$$φ ( α \vert β ) = P ( α \vert β ) = \frac{P ( α , β )}{P ( β )} ; φ ( β \vert α ) = P ( β \vert α ) = \frac{P ( α \vert β )}{P ( α )}$$

Symmetric Version:

$$φ ( α , β ) = max \{ P ( α \vert β ) , P ( β \vert α ) \} = \frac{P ( α , β )}{min \{ P ( α ) , P ( β ) \}}$$

Conviction

Asymmetric Version:

$$φ ( α \vert β ) = \frac{P ( \overline{α} ) P ( β )}{P ( \overline{α} , β )} ; φ ( β \vert α ) = \frac{P ( α ) P ( \overline{β} )}{P ( α , \overline{β} )}$$

Symmetric Version:

$$φ ( α , β ) = max \{ \frac{P ( \overline{α} ) P ( β )}{P ( \overline{α} , β )} , \frac{P ( α ) P ( \overline{β} )}{P ( α , \overline{β} )} \}$$

Interest and Cosine

$$Interest \text{:} φ ( α , β ) = \frac{P ( a , b )}{P ( a ) P ( b )} ∈ [ 0 , … , 1 , … , ∞ ]$$

$$Cosine \text{:} φ ( α , β ) = \frac{P ( a , b )}{\sqrt{P ( a ) P ( b )}} ∈ [ 0 , … , \sqrt{P ( a ) P ( b )} , … , 1 ]$$

Collective Strength

$$φ ( α , β ) = [ \frac{P ( α , β ) + P ( \overline{α} , \overline{β} )}{P ( α ) P ( β ) + P ( \overline{α} ) P ( \overline{β} )} ] \times [ \frac{1 - P ( α ) P ( β ) - P ( \overline{α} ) P ( \overline{β} )}{1 - P ( α , β ) - P ( \overline{α} , \overline{β} )} ]$$

Information Theoretic Measures of Consistency

Point-Wise Mutual Information

$$φ ( α , β ) = log [ \frac{P ( a , b )}{P ( a ) P ( b )} ]$$

The Insight/Relationship Determination Module 320 Suite of Applications

The insight/relationship determination module 320 includes a general framework that allows formulation and solution of a number of different problems in retail. For example, it may be used to solve problems as varied as:

(i) customer segmentation using pair-wise similarity relationships between customers,

(ii) creating product bundles or consistent item-sets using pair-wise consistency between products purchased in market basket context, or

(iii) predicting the time and product of the next possible purchase of a customer using pair-wise consistency between products purchased in a purchase sequence context.

From a technology perspective, the various applications of the insight/relationship determination module 320 are divided into three categories:
Product Affinity Applications—that use product consistency relationships to analyze the product space. For example, finding higher order structures such as bundles, bridges, and phrases and using these for cross-sell, co-promotion, store layout optimization, etc.
Customer Affinity Applications—that use customer similarity relationships to analyze the customer space. For example, doing customer segmentation based on increasingly complex definitions of customer-behavior and using these to achieve higher customer centricity.
Purchase Behavior Applications—that use both the products and the customers to create decisions in the joint product, customer space. For example, recommending the right product to the right customer at the right time.

FIG. 16 shows applications within each of these areas both from a technology and business perspective. The following discussion concerns the various product affinity applications created from the insight/relationship determination module 320 analysis.

The insight/relationship determination module 320 Product consistency graphs are the internal representation of the pair-wise co-occurrence consistency relationships created by the process described above. Once the graph is created, the insight/relationship determination module 320 uses graph theoretic and machine learning approaches to find patterns of interest in these graphs. While we could use the pair-wise relationships as such to find useful insights, the real power of the insight/relationship determination module 320 comes from its ability to create higher order structures from these pair-wise relationships in a very novel, scalable, and robust manner, resulting in tremendous generalization that is not possible to achieve by purely data driven approaches. The following discussion focuses on four important higher-order-structures that might constitute actionable insights:

1. Product neighborhood,

2. product bundles,

3. bridge structures, and

4. product phrases.

Before discussing these structures further, we define a useful abstraction called the Product Space.

Product Space Abstraction

The notion of product space was introduced above as a collection of products and their properties. Now having a way to quantify connection strength (co-occurrence consistency) between all pairs of products, this can be used to create a discrete, finite, non-metric product space where:
Each point in this space is a product. There are as many points as there are products.
There is one such product space for each level in the product hierarchy and for each combination of customization, market basket context parameter, and customization.
The pair-wise co-occurrence consistency quantifies the proximity between two points. The higher the consistency, the closer the two points are.
The product space is not metric in the sense that it does not strength of connection between them.

Product Neighborhood

The simplest kind of insight about a product is that regarding the most consistent products sold with the target product in the insight/relationship determination module 320 graph or the products nearest to a product in the Product Space abstraction. This type of insight is captured in the product neighborhood analysis of the insight/relationship determination module 320 graph.

Definition of a Product Neighborhood

The neighborhood of a product is defined as an ordered set of products that are consistently co-purchased with it and satisfying all the neighborhood constraints. The neighborhood of a product γ is denoted by N_{λ}(γ|Φ), where:
Φ is the consistency matrix with respect to which neighborhood is defined:
λ={λ_{scope},λ_{size}} are the neighborhood constraints based the parameters:

N_{λ}(γ|Φ)={x₁,x₂, . . . , x_{K}}
Such that:

φ(γ,xₖ)≧φ(γ,x_{k÷1}):∀k=1 . . . K−1

g_{scope}(xₖ,λ_{scope})=TRUE:∀k=1 . . . K

g_{size}(N_{λ}(γ|Φ),λ_{size})=TRUE:∀k=1 . . . K

Note that the set is ordered by the consistency between the target product and the neighborhood products: The most consistent product is the first neighbor of the target product, and so on. Also note that here are two kinds of constraints associated with a neighborhood:

Scope Constraint: This constraint filters the scope of the products that may or may not be part of the neighborhood. Essentially, these scope-filters are based on product properties and the parameter λ_{scope} encapsulates all the conditions. For example, someone might be interested in the neighborhood to be limited only to the target product's department or some particular department or to only high value products or only to products introduced in the last six months, etc. The function g_{scope}(x,λ_{scope}) returns a true if the product x meets all the criteria in λ_{scope}.

Size Constraint: Depending on the nature of the context used, the choice of the consistency measure, and the target product itself the size of the product neighborhood might be large even after applying the scope constraints. There are three ways to control the neighborhood size:
Limit the number of products in the neighborhood:

g_{size}(N_{λ}(γ|Φ),λ_{size}^{limit})=N_{λ}(γ|Φ)=K≦λ_{size} ^{limit}
Apply an absolute threshold on consistency (absolute consistency radius):

g_{size}(N_{λ}(γ|Φ),λ_{size}^{absolute-threshold})=φ(γ,x_{K})≧λ_{size}^{absolute-threshold}
Apply a relative threshold on the consistency between target and neighborhood product:

$${g}_{size} ( {N}_{λ} ( γ \vert Φ ) , {λ}_{size} ) = \frac{φ ( γ , {x}_{K} )}{φ ( γ , {x}_{1} )} \geq {λ}_{size}^{relative \text{-} threshold}$$

Business Decisions Based on Product Neighborhoods

Product neighborhoods may be used in several retail business decisions. Examples of some are given below:
Product Placement—To increase customer experience resulting in increased customer loyalty and wallet share for the retailer, it may be useful to organize the store in such a way that finding products that its customers need is easy. This applies to both the store and the web layout. Currently, stores are organized so all products that belong to the same category or department are placed together. There are no rules of thumb, however, how the products may be organized within a category or categories may be organized within the departments or how the departments may be organized within the store. Product neighborhood at the department and category level may be used to answer such questions. The general principle is that for every product category, its neighboring categories in the product space should be placed nearby this category.
Customized Store Optimization—Product placement is a piecemeal solution for the overall problem of store optimization. The graphs and product neighborhoods derived from the insight/relationship determination module 320 may be used to optimize the store layout. Store layout may be formulated as a multi-resolution constrained optimization problem. First, the departments are optimally placed in the store. Second, the categories within each department are placed relative to each other in an optimal fashion, and so on. Since graphs may be customized by stores, each store may be independently optimized based on its own co-occurrence consistency obtained from the insight/relationship determination module 320.
Influence Based Strategic Promotions—Several retail business decisions such as pricing optimization, cross-sell, up-sell, etc. depend on how much a product influences the sale of other products. The insight/relationship determination module 320 graphs provide a framework for creating such product influence models based on product neighborhoods. In the next Section, two co-occurrence based product properties: product density and product diversity are defined. These properties may be used appropriately to strategically promote these products to influence the sale of other products with a wide variety of overall business goals.

Neighborhood Based Product Properties

As discussed above, a number of direct and indirect-product properties were introduced. The direct properties such as manufacturer, hierarchy level, etc. are part of the product dictionary. Indirect properties such as total revenue, margin percent per customer, etc. may be derived by simple online analytical processing (OLAP) statistics on transaction data. In the following discussion two more product properties that are based on the neighborhood of the product in the product graph are introduced: Value-based Product Density and Value-based Product Diversity.

Value-Based Product Density

If the business goal for the retailer is to increase the sale of high margin products or high revenue products, a direct approach would be to promote those products more aggressively. An indirect approach would be to promote those products that influence the sale of high margin or high revenue products. This principle can be generalized whereby if the business goal is related to a particular product property then a value-based product density based on its product neighborhood may be defined for each product.

For a given product neighborhood, i.e. neighborhood constraints, consistency measure, and product value-property v (revenue, frequency, etc.), the value-density of a product is defined as the linear combination of the follows:

$${D}_{v} ( γ \vert λ , Φ , θ ) = {\sum }_{x ∈ {N}_{λ} ( γ \vert Φ )} w ( x \vert γ , θ , Φ ) v ( x )$$

Where:
w(γ|x,θ,Φ)=weight-of-influence of the neighboring product x on the target product γ
v(x)=value of product x with respect to which the value-density is computed; and
θ{θ₁,θ₂, . . . }=set of parameters associated with the weight function.

An example of the Gibbs weight function is:

$$w ( x \vert γ , θ , Φ ) = {φ ( γ , x )}^{{θ}_{1}} \times \frac{exp ( {θ}_{2} \times φ ( γ , x ) )}{{\sum }_{{x}^{′} ∈ {N}_{λ} ( γ \vert Φ )} exp ( {θ}_{2} \times φ ( γ , {x}^{′} ) )} \text{:} {θ}_{1} ∈ \{ 0 , 1 \} , {θ}_{2} ∈ [ 0 , ∞ ]$$

The parameter θ₂ can be interpreted as the temperature for the Gibb's distribution. When the parameter θ₁=0 the weights are normalized otherwise the weights take the consistency into account.

Value-based product densities may be used in a number of ways. In the recommendation engine post processing, for example, the value-based density may be used to adjust the recommendation score for different objective functions.

Value-Based Product Diversity

Sometimes the business objective of a retailer is to increase diversity of a customer shopping behavior, i.e. if the customer shops in only one department or category of the retailer, then one way to increase the customer's wallet share is to diversify his purchases in other related categories. This can be accomplished in several ways, for example, by increasing (a) cross-traffic across departments, (b) cross-sell across multiple categories, or (c) diversity of the market basket. The graphs of the insight/relationship determination module 320 may be used to define value-based product diversity of each product. In recommendation engine post-processing, this score may be used to push high diversity score products to specific customers.

For every product γ, product property ν, and product level l above the level of product γ, value based product diversity is defined as the variability in the product density along different categories at level l:

Dᵥ(γ|λ_{scope}=uₗ,Φ,θ)=Dᵥ(γ|m,Φ,θ):∀m ∈ {1, . . . , Mₗ}

Diversity should be low (say zero) if all the neighbors of the products are in the same category as the product itself, otherwise the diversity is high. An example of such a function is:

$$Δ {D}_{v} ( γ \vert l , Φ , θ ) = 1 - \frac{{D}_{v} ( γ \vert Φ , m ( γ ) , θ )}{{\sum }_{m = 1}^{{M}_{l}} {D}_{v} ( γ \vert Φ , m , θ )} \text{:} ∀ m ∈ \{ 1 , … , {M}_{l} \}$$

Product Bundles

One of the most important types of insight in retail pertains to product affinities or product groupings of products that are “co-purchased” in the same context. In the following discussion describes the application of The insight/relationship determination module 320 in finding, what we call, “Product bundles” in a highly scalable, generalized, and efficient way that they exceed both the quality and efficiency of the results of traditional frequency based market basket approaches. A large body of research in market-basket-analysis is focused on efficiently finding frequent item-sets, i.e. a set of products that are purchased in the same market basket. The support of an item-set is the number of market baskets in which it or its superset is purchased. The confidence of any subset of an item-set is the conditional probability that the subset will be purchased, given that the complimentary subset is purchased. Techniques have been developed for breadth-first search of high support item-sets. Due to the reasons explained above, the results of such analysis have been largely unusable because this frequency based approach misses the fundamental observation that the customer behavior is a mixture of projections of latent behaviors. As a result, to find one actionable and insightful item-set, the support threshold has to be lowered so that typically millions of spurious item-sets have to be looked at.

The insight/relationship determination module 320 uses transaction data to first create only pair-wise co-occurrence consistency relationships between products. These are then used to find logical bundles of more than two products. The insight/relationship determination module Product bundles and technique based item-sets are product sets, but they are very different in the way they are created and characterized.

Definition of a Logical Product Bundle

A product bundle for the insight/relationship determination module 320 may be defined as a Soft Clique (completely connected sub-graphs) in the weighted graph of the insight/relationship determination module 320, i.e. a product bundle is a set of products such that the co-occurrence consistency strength between all pairs of products is high. FIG. 8 shows examples of some product bundles. The discussion above explained that the generalization power of the insight/relationship determination module occurs because it extracts only pair-wise co-occurrence consistency strengths from mixture of projections of latent purchase behaviors and uses this to find logical structures instead of actual structures in these graphs.

The insight/relationship determination module 320 uses a measure called bundleness to quantify the cohesiveness or compactness of a product bundle. The cohesiveness of a product bundle is considered high if every product in the product bundle is highly connected to every other product in the bundle. The bundleness in turn is defined as an aggregation of the contribution of each product in the bundle. There are two ways in which a product contributes to a bundle in which it belongs: (a) It can either be the principal or driver or causal product for the bundle or (b) it can be the peripheral or accessory product for the bundle. For example, in the bundle shown in FIG. 10, the Notebook is the principal product and the mouse is the peripheral product of the bundle. In the insight/relationship determination module 320, a single measure of seedness of a product in a bundle is used to quantify its contribution. If the consistency measure used implies causality, then high centrality products cause the bundle.

In general, the seedness of a product in a bundle is defined as the contribution or density of this product in the bundle. Thus the bundleness quantification is a two step process. In the first, seedness computation stage, the seedness of each product is computed and in the second, seedness aggregation stage, the seedness of all products is aggregated to compute the overall bundleness.

Seedness Computation

The seedness of a product in a bundle is loosely defined as the contribution or density of a product to a bundle. There are two roles that a product may play in a product bundle:
Influencer or principal product in the bundle—The Authority products
Follower or peripheral product in the bundle—The Hub products

Borrowing terminology from the analysis of Web structure, the Klineberg's Hubs and Authority formulation in the seedness computation is as follows:
Consider a product bundle: x ={x₁, . . . , xₙ} of n products.
The n×n co-occurrence consistency sub-matrix for this bundle is defined by:

Φ(x)=[φ_{i,j}=φ(xᵢ,xⱼ)]
Note that depending on the consistency measure, this could either be symmetric or non-symmetric. For each product in the bundle, we define two types of scores.
Authority (or Influencer) Score:

a(x|Φ)=(a₁=a(x₁|x,Φ), . . . , aᵢ=a(xᵢ|x,Φ), . . . , aₙ=a(xₙ|x,Φ))
Hubness (or Follower) Score:

h(x|Φ)=(h₁=h(x₁|x,Φ), . . . , hᵢ=h(xᵢ|x,Φ), . . . , hₙ=h(xₙ|x,Φ))

These scores are initially set to I for all the products are iteratively updated based on the following definitions: Authority (Influencer) score of a product is high if it receives a high support from important hubs (followers) and Hubness score of a product is high if it gives high support to important authorities.

a,h=GenerateSeedness(x,Φ,εₘᵢₙ)

### Initialize:ε←Inf

a⁽⁰⁾←[1, 1, . . . , 1];k←0
h⁽⁰⁾←[1, 1, . . . , 1];l←0

Normalize Hubness and Update Authority Measure

$${\hat{h}}^{( l )} ← [ {\hat{h}}_{1}^{( l )} , … , {\hat{h}}_{n}^{( l )} ] where {\hat{h}}_{i}^{( l )} ← \frac{{h}_{i}^{( l )}}{{‖ {h}^{( l )} ‖}_{2}}$$

$${a}^{( k + 1 )} ← [ {a}_{1}^{( k + 1 )} , … , {a}_{n}^{( k + 1 )} ] where {a}_{i}^{( k + 1 )} ← {\sum }_{j = 1}^{n} φ ( {x}_{i} \vert {x}_{j} ) {\hat{h}}_{j}^{( l )}$$

$$k ← k + 1$$

Normalize Authority and Update Hubness Measure

$${\hat{a}}^{( k )} ← [ {\hat{a}}_{1}^{( k )} , … , {\hat{a}}_{n}^{( k )} ] where {\hat{a}}_{i}^{( k )} ← \frac{{a}_{i}^{( k )}}{{‖ {a}^{( k )} ‖}_{2}}$$

$${h}^{( l + 1 )} ← [ {h}_{1}^{( l + 1 )} , … , {h}_{n}^{( l + 1 )} ] where {h}_{i}^{( l + 1 )} ← {\sum }_{j = 1}^{n} φ ( {x}_{j} \vert {x}_{i} ) {\hat{a}}_{j}^{( k )}$$

$$l ← l + 1$$

$$If ( k \geq 2 ) and ( l \geq 2 )$$

$$ɛ ← 1 - min \{ {\hat{a}}^{{( k )}^{T}} {\hat{a}}^{( k )} , {\hat{h}}^{{( l )}^{T}} {\hat{h}}^{( l )} \}$$

Technique 3: Computing the Hubs (Follower Score) and Authority (Influencer Score) in a Product Bundle

The hub and authority measure converge to the first Eigen Vectors of following matrices:

a≡a^{(∞)}←eig₁[Φ(x)Φ(x)^{T}]

h≡h^{(∞)}←eig₁[Φ(x)^{T}Φ(x)]

Where: Φ(x)=[φ_{i,j}=φ(xᵢ|xⱼ)]

If the consistency matrices are symmetric, the hubs and authority scores are the same. If they are non-symmetric, the hubs and authority measures are different. We only consider symmetric consistency measures and hence would only consider authority measures to quantify bundleness of a product bundle.

Seedness Aggregation

There are several ways of aggregating the seedness values of all the products in the product bundle. The insight/relationship determination module 320 uses a Gibbs aggregation for this purpose:

$$π ( x \vert λ , Φ ) = \frac{{\sum }_{i = 1}^{n} a ( {x}_{i} \vert x , Φ ) \times exp [ λ \times a ( {x}_{i} \vert x , Φ ) ]}{{\sum }_{i = 1}^{n} exp [ λ \times a ( {x}_{i} \vert x , Φ ) ]} \text{:} λ ∈ [ - ∞ , + ∞ ]$$

Different settings of the temperature parameter λ yield different aggregation functions:

$$π ( x \vert λ = - ∞ , Φ ) = {min}_{i = 1 … n} \{ a ( {x}_{i} \vert x , Φ ) \}$$

$$π ( x \vert λ = 0 , Φ ) = {avg}_{i = 1 … n} \{ a ( {x}_{i} \vert x , Φ ) \} = \frac{1}{n} {\sum }_{i = 1}^{n} a ( {x}_{i} \vert x , Φ )$$

$$π ( x \vert λ = ∞ , Φ ) = {max}_{i = 1 … n} \{ a ( {x}_{i} \vert x , Φ ) \}$$

Although this defines a wide range of bundleness functions, by the definition of cohesiveness, i.e. every product should be highly connected to every other product in the product bundle, the most appropriate definition of bundleness would be based on the minimum temperature:

$$Bundleness : π ( x \vert Φ ) = π ( x \vert λ = - ∞ , Φ ) = {min}_{i = 1 … n} \{ a ( {x}_{i} \vert x , Φ ) \}$$

Techniques for Finding Cohesive Product Bundles

Similar to the automated item-set mining, the insight/relationship determination module 320 includes an affinity analysis engine that provides for automatically finding high consistency cohesive product bundles given the above definition of cohesiveness and a market basket coo-occurrence consistency measure. Essentially the goal is to find these optimal soft-cliques in the graphs of the insight/relationship determination module 320. Initially, the meaning of optimal in the context of a product bundle is defined and note that this is an NP hard problem. Following this, two broad classes of greedy techniques are described: depth first and breadth first methods.

Problem Formulation

The overall problem of finding all cohesive product bundles in a product space may be formulated in terms of the following simple problem: Given
A The insight/relationship determination module 320 graph represented by an n×n consistency matrix Φ over product universe U
A set of candidate products that may be in the product bundles: C ⊂ U
Where, any product outside this candidate set cannot be part of the product bundle
A set of foundation products that must be in the product bundles:

F ⊂ C ⊂ U
Boundary conditions:

F=Ø, C=U [symbol] All bundles at the product level of the universe F=C [symbol] One bundle: F

The problem is to find a set of all locally optimal product bundles x={x₁, . . . , xₙ} of size two or more such that:

F ⊂ x ⊂ C

π(x|Φ)≧π(x′|Φ):∀x′ ∈ BNeb(x|F,C)

Where:
BNeb(x|F,C)=Bundle Neighborhood of bundle x

The bundle-neighborhood of a bundle is the set of all feasible bundles that may be obtained by either removing a non-foundation product from it or by adding a single candidate product to it.

BNeb(x|F,C)=BNebGrow(x|F,C)∪ BNebShrink(x|F,C)

BNebGrow(x|F,C)={x′=x⊕x:∀x ∈ C−x}

BNebShrink(x|F,C)={x′x\x:∀x ∈ x−F}

In other words, a bundle x is local optima for a given candidate set C if:

$$π ( x \vert Φ ) \geq {max}_{x ⋐ C - x} π ( x ⊕ x \vert Φ )$$

$$π ( x \vert Φ ) \geq {max}_{x ⋐ x - F} π ( x \backslash x \vert Φ )$$

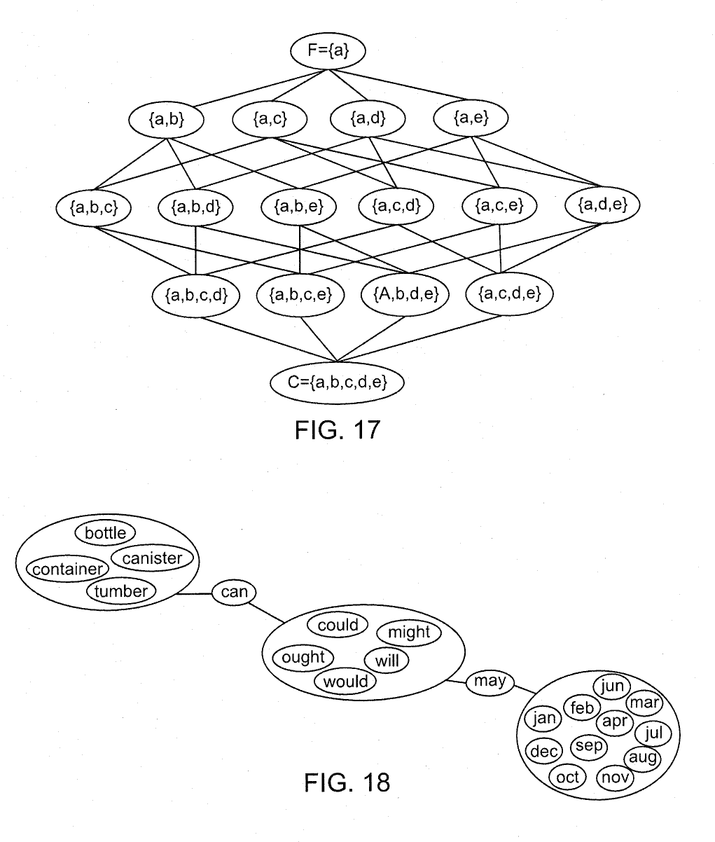

The definition of a bundle as a subset of products bounded by a the foundation set F (as a subset of every product bundle) and a candidate set C (as a superset of every product bundle) together with the definition of the neighborhood function defined above results in an abstraction called the Bundle Lattice-Space (BLS). FIG. 17 shows an example of a bundle lattice space bounded by a foundation set and a candidate set. Each point in this space is a feasible product bundle. A measure of bundleness is associated with each bundle. It also shows examples of the BShrink and BGrow neighbors of a product bundle. If the product bundle is locally optimal then all its neighbors should have a smaller bundleness than it has.

The BGrow and BShrink sets may be further partitioned into two subsets each depending on whether the neighboring bundle has a higher or lower bundleness as factored by a slack-parameter θ:

$$\begin{matrix}\underline{BGrow ( x \vert C ) = {BGrow}_{+} ( x \vert C , {π}_{λ} , θ ) ⋃ {BGrow}_{-} ( x \vert C , {π}_{λ} , θ )} \\ {BGrow}_{+} ( x \vert C , {π}_{λ} , θ ) = \{ {x}^{′} ∈ BGrow ( x \vert C ) \vert {π}_{λ} ( {x}^{′} ) \geq θ \times {π}_{λ} ( x ) \} \\ {BGrow}_{-} ( x \vert C , {π}_{λ} , θ ) = \{ {x}^{′} ∈ BGrow ( x \vert C ) \vert {π}_{λ} ( {x}^{′} ) < θ \times {π}_{λ} ( x ) \}\end{matrix} \\ \begin{matrix}\underline{BShrink ( x \vert F ) = {BShrink}_{+} ( x \vert F , {π}_{λ} , θ ) ⋃ {BShrink}_{-} ( x \vert F , {π}_{λ} , θ )} \\ {BShrink}_{+} ( x \vert F , {π}_{λ} , θ ) = \{ {x}^{′} ∈ BShrink ( x \vert F ) \vert {π}_{λ} ( {x}^{′} ) \geq θ \times {π}_{λ} ( x ) \} \\ {BShrink}_{-} ( x \vert F , {π}_{λ} , θ ) = \{ {x}^{′} ∈ BShrink ( x \vert F ) \vert {π}_{λ} ( {x}^{′} ) < θ \times {π}_{λ} ( x ) \}\end{matrix}$$

The condition for optimality may be stated in a number of ways:

$$\begin{matrix}\underline{Bundle x is Locally Optimal for a given \text{:} Φ , C , F , {π}_{λ} if \text{:}} \\ IsOptimal ( x \vert Φ , C , F , {π}_{λ} ) \\ \begin{matrix}= {π}_{λ} ( x \vert Φ ) \geq max \{ {max}_{x ∈ C - x} {π}_{λ} ( x ⊕ x \vert Φ ) , {max}_{x ∈ x - F} {π}_{λ} ( x \backslash x \vert Φ ) \} \\ = ( {BGrow}_{+} ( x \vert C , {π}_{λ} , 1 ) = ∅ ) and ( {BShrink}_{+} ( x \vert C , {π}_{λ} , 1 ) = ∅ )\end{matrix}\end{matrix}$$

For a given candidate set C and foundation set F, there are O(2^{|C|-|F|}) possible bundles to evaluate in an exhaustive approach. Finding a locally optimal bundle is NP Complete because it reduces to the Clique problem in the simple case that the Authority measure (used to calculate your bundle-ness metric) is “1” or “0”, depending on whether a node is fully connected to other nodes in the bundle. The Clique problem (determining if a graph has a clique of a certain size K) is NP Complete

Depth First Greedy Techniques

Depth first class of techniques start with a single bundle and apply a sequence of grow and shrink operations to find as many locally optimal bundles as possible. In addition to the consistency matrix, Φ, the candidate set, C, and the foundation set, F, a depth first bundle search technique also requires: (1) Root Set, R containing root-bundles to start each the depth search, (2) Explored Set, Z containing the set of product bundles that have already been explored. A typical depth first technique starts off by first creating a Root-Set. From this root-set, it picks one root at a time and performs a depth first search on it by adding/deleting an product from it until local optima is reached. In the process, it may create additional roots-bundles and add to the root set. The process finishes when all the roots have been exhausted. Technique 4 below describes how the insight/relationship determination module 320 uses the Depth first search to create locally optimal product bundles.

Technique 4: Depth first Bundle Creation
B = DepthFirstBundle(F, C, Φ, π_{λ}, θ)

Initialize

Root: R = {r₁ = F}
Set of optimal bundles: B = Ø
Set of explored bundles: Z = Ø

While (R ≠ Ø)

$x ← arg {max}_{r ∈ R} {π}_{λ} ( r \vert Φ )$ $R ← R \backslash x ; Z ← Z ⋃ x$ $If ( IsOptimal ( x \vert Φ , C , F , {π}_{λ} ) ) ⇒ B ← B ⋃ x$ $Z ← Z ⋃ {BGrow}_{-} ( x \vert C , {π}_{λ} , 1 ) ⋃ {BShrink}_{-} ( x \vert F , {π}_{λ} , 1 )$ $R ← R ⋃ {BGrow}_{+} ( x \vert C , {π}_{λ} , θ ) ⋃ {BShrink}_{+} ( x \vert F , {π}_{λ} , θ )$ $R ← R \backslash Z$

Return B

A key observation that makes this technique efficient is that for each bundle x, any of its neighbors in the lattice space with bundleness less than the bundleness of x cannot be local optima. This is used to prune out a number of bundles quickly to make the search faster. Efficient implementation for maintaining the explored set Z for quick look-up and the root set R for quick way of finding the maximum makes this very efficient. The parameter θ controls the stringency of the greediness. It is typically in the range of 0 to infinity with 1 being the typical value to use.

Breadth First Greedy Techniques

Another class of greedy techniques for finding locally optimal bundles is the Breadth First approach. Here, the search for optimal bundles of size k+1 happens only after all the bundles of size k have been explored. There are two main differences in the insight/relationship determination module 320 approach and that used for standard market basket analysis:

1. Quality: the standard market basket analysis technique seeks actual high support item-sets while the insight/relationship determination module 320 seeks logical high consistency bundles. There is a large qualitative difference in the nature, interpretation and usability of the resulting bundles from the two methods. This distinction is already discussed above.

2. Efficiency: the standard market basket analysis technique requires a pass through the data after each iteration to compute the support of each item-set, while The insight/relationship determination module 320 uses the co-occurrence matrix to compute the bundleness without making a pass through the data. This makes The insight/relationship determination module 320 extremely efficient compared to the standard market basket analysis technique technique.

The insight/relationship determination module 320's breadth-first class of techniques for finding locally optimal product bundles start from the foundation set and in each iteration maintains and grows a list of potentially optimal bundles to the next size of product bundles. The standard market basket analysis technique monotonic property also applies to a class of bundleness functions where the parameter λ is low for example: π_{-∞}(x|Φ). In other words, for bundleness measures, a bundle may have high bundleness only if all of its subsets of one size less have high bundleness. This property is used in a way similar to the standard market basket analysis technique to find locally optimal bundles in the Technique 5 described below. In addition to the consistency matrix, Φ, the candidate set, C, and the foundation set, F, a breadth first bundle search technique also requires a Potentials Set, P, of bundles of size s that have a potential to grow into an optimal bundle.

Technique 5: Breadth first bundle creation
B = BreadthFirstBundle(F, C, Φ, π_{λ}, θ, sₘₐₓ)

Initialize

Size s ← 1;Pₛ ← C
Set of optimal bundles: B ← Ø

While (s ≦ min {sₘₐₓ, |C|})

${Q}_{s + 1} ← {⋃}_{x ∈ {P}_{s}} {BGrow}_{+} ( x \vert C , {π}_{λ} , θ )$ ${P}_{s + 1} ← \{ x ∈ {Q}_{s + 1} \vert BShrink ( x \vert F ) ⊆ {P}_{s} \} // All subsets of x are in {P}_{s}$ $s ← s + 1$ $∀ x ∈ {P}_{s} : If ( IsOptimal ( x \vert Φ , C , F , {π}_{λ} ) ) ⇒ B ← B ⋃ x$

Return B

The Breadth vs. Depth first search methods both have their trade-offs in terms of completeness vs. time/space complexity. While the depth first techniques are fast, the breadth first techniques may result in more coverage i.e. find majority of locally optimal bundles.

Business Decisions Based on Product Bundles

Product bundles may be used in several retail business decisions as well as in advanced analysis of retail data. Examples of some are given below:
Assortment Promotions—Often retailers create promotions that involve multiple products. For example, “buy product A and get product B half off” or “buy the entire bundle for 5% less.” Historically, retailers have used their domain knowledge or market surveys to create these product assortments. Recently, with the advent of market basket analysis, some retailers have started using transaction data to find product bundles that make sense to customers. However, there has not been much success with traditional techniques because they could not find logical or natural product assortments for the reasons described earlier. The product bundles created by the insight/relationship determination module 320 using the techniques described above may be used very effectively in creating product assortment promotions because they capture the latent intentions of customers in a way that was not possible before.
Cross-Sell Campaigns—One of the key customer-centric decisions that a retailer is faced with is how to promote the right product to the right customer based on his transaction history. There are a number of ways of approaching this problem: Customer segmentation, transaction history based recommendation engine, and product bundle based product promotions. As described earlier, a customer typically purchases a projection of an intention at a store during a single visit. If a customer's current or recent purchases partially overlap with one or more bundles, decisions about the right products to promote to the customer may be derived from the products in those product bundles that they did not buy. This can be accomplished via a customer score and query templates associated product bundles as discussed later.
Latent Intentions Analysis—Traditionally, retail data mining is done at products level, there is a higher conceptual level in the retail domain—intentions. The product bundles (and later product phrases) of the insight/relationship determination module 320 are the higher order structures that may be thought of as proxy for the latent-logical intentions. In a later discussion we describe how a customer's transaction data may be scored against different product bundles. These scores may be used to characterize whether or not the associated intentions are reflected in the customer's transaction data. This opens up a number of possibilities on how to use these intentions. For example, intentions based customer segmentation, intentions based product recommendation, intention prediction based on past intentions, life style/stage modeling for customers, etc.

Business Projection Scores

Product bundles generated in The insight/relationship determination module 320 represent logical product associations that may or may not exist completely in the transaction data i.e. a single customer may have not bought all the products in a bundle as part of a single market basket. These product bundles may be analyzed by projecting them along the transaction data and creating bundle projection-scores, defined by the a bundle set, a market basket, and a projection scoring function:
Bundle-Set denoted by B={bₖ}ₖ₌₁^{K} is the set of K product bundles against which bundle projection scores are computed. One can think of these as parameters for feature extractors.
Market Basket denoted by x ⊂ U is a market basket obtained from the transaction data. In general, depending on the application, it could be either a single transaction basket or a union of recent customer transactions or all of customer transactions so far. One can think of these as the raw input data for which features are to be created.
Projection-Scoring Function denoted by ƒ(x|bₖ, Φ, λ) is a scoring function that may use the co-occurrence consistency matrix Φ and a set of parameters λ and creates a numeric score. One can think of these as feature extractors.

The insight/relationship determination module 320 supports a large class of projection-scoring functions, for example:
Overlap Score that quantifies the relative overlap between a market basket and a product bundle

$$\begin{matrix} \\ {f}_{overlap \text{-} A} ( x \vert {b}_{k} ) = \frac{\vert x ⋂ {b}_{k} \vert}{\vert x ⋃ {b}_{k} \vert} ; {f}_{overlap \text{-} B} ( x \vert {b}_{k} ) = \frac{\vert x ⋂ {b}_{k} \vert}{min \{ \vert x \vert , \vert {b}_{k} \vert \}} \\ \end{matrix}$$

Coverage Score: that quantifies the fraction of product bundle purchased in the market basket.

$$\begin{matrix} \\ {f}_{coverage} ( x \vert {b}_{k} ) = \frac{\vert x ⋂ {b}_{k} \vert}{\vert {b}_{k} \vert} ; {f}_{wtd \text{-} coverage} ( x \vert {b}_{k} , Φ , λ ) = \frac{{π}_{λ} ( x ⋂ {b}_{k} \vert Φ )}{{π}_{λ} ( {b}_{k} \vert Φ )} \\ \end{matrix}$$

A market basket can now be represented by a set of K bundle-features:

$$\begin{matrix} \\ f ( x \vert B ) = ( f ( x \vert {b}_{1} ) , f ( x \vert {b}_{1} ) , … , f ( x \vert {b}_{K} ) ) \\ \end{matrix}$$

Such a fixed length, intention level feature representation of a market basket, e.g. single visit, recent visits, entire customer, may be used in a number of applications such as intention-based clustering, intention based product recommendations, customer migration through intention-space, intention-based forecasting, etc.

Bundle Based Product Recommendations

There are two ways of making decisions about which products should be promoted to which customer: (1) product-centric customer decisions about top customers for a given product and (2) customer-centric product decisions about top products for a given customer. Product bundles, in conjunction with customer transaction data and projection scores may be used to make both types of decisions. Consider, for example the coverage projection score. If we assume that (1) a product bundle represents a complete intention and (2) that a customer eventually buys either all the products associated with an intention or none of the products, then if a customer has a partial coverage for a bundle, the rest of the products in the bundle may be promoted to the customer. This can be done by first computing a bundle based propensity score for each customer n, product γ combination and is defined as a weighted combination of coverage scores across all available bundles:

$$\begin{matrix} \\ s ( γ , n \vert B ) = δ ( γ ∉ {x}^{( n )} ) \times [ \frac{{\sum }_{b ∈ B} δ ( γ ∈ b ) \times w ( {f}_{overlap} ( x \vert b ) ) \times {f}_{coverage} ( x \vert b )}{{\sum }_{b ∈ B} δ ( γ ∈ b ) \times w ( {f}_{overlap} ( x \vert b ) )} ] \\ \end{matrix}$$

Where:
w(ƒₒᵥₑᵣₗₐₚ(x|b))=Monotonically increasing weight function of overlap
δ(boolean)=1 if boolean argument is true and 0 otherwise

To make product centric customer decisions, we sort the scores across all customers for a particular product in a descending order and pick the top customers. To make customer centric product decisions, all products are sorted for each customer in descending order and top products are picked.

Bridge Structures in the Insight/Relationship Determination Module 320 Graphs

There are two extensions of the product bundle structures: (1) Bridge structures that essentially contain more than one product bundles that share very small number of products, and (2) Product phases that are essentially bundles extended along time. The following discussion focuses on characterizing, discovering, analyzing, and using bridge structures.

Definition of a Logical Bridge Structure

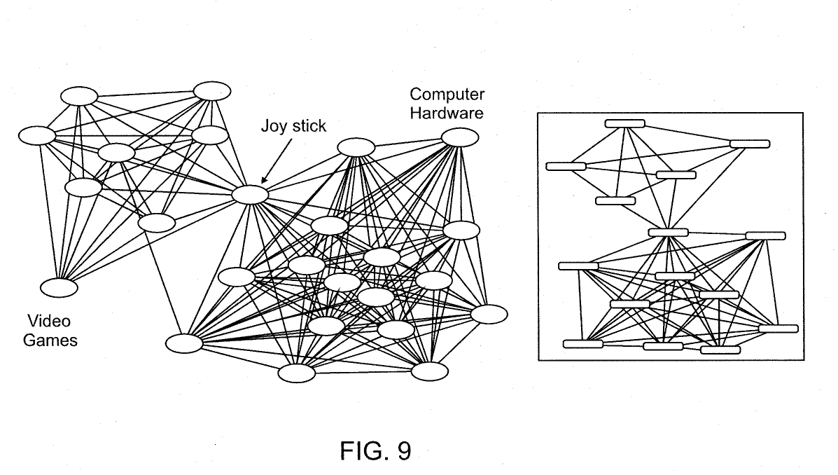

In the insight/relationship determination module 320, a bridge structure is defined as a collection of two or more, otherwise disconnected or sparsely connected product groups, i.e. a product bundle or an individual product, that are connected by a single or small number of bridge product(s). Such structures may be very useful in increasing cross department traffic and strategic product promotions for increased lifetime value of a customer. FIG. 9 shows examples of two bridge structures. A logical bridge structure G={g₀,g} is formally defined by:
Bridge Product(s), g₀=the product(s) that bridge various groups in the bridge structure and
Bridge Groups: g={g₁,g₂, . . . }=the ORDERED set of groups bridged by the structure.
Groups are ordered by the way they relate to the bridge product (more later)
Each group could be either a single product or a product bundle.

Motivation from Polyseme

The key motivation for bridge structures in product graphs from the insight/relationship determination module 320 comes from polyseme in language: A word may have more than one meaning. The right meaning is deduced from the context in which the word is used. FIG. 18 shows an example of two polysemous words: ‘can’ and ‘may.’ The word families shown herein are akin to the product bundles and a single word connecting the two word families is akin to a bridge structure. The only difference is that in FIG. 18 similarity between the meanings of the words is used while in the insight/relationship determination module 320, consistency between products is used to find similar structures.

Bridgeness of a Bridge Structure

Earlier a measure of cohesiveness for a bundle i.e. the “bundleness” measure was defined. Similarly, for each bridge structure a measure called bridgeness is defined that depends on two types of cohesiveness measures:
Intra-Group Cohesiveness is the aggregate of cohesiveness of each group. If the group has only one product, its cohesiveness is zero. But if the group has two or more products (as in a product bundle) then its cohesiveness can be measured in several ways. One way would be to use bundleness of the group as its cohesiveness. This definition, does not use the bundleness measure because the same cannot be done for the other component of the bridgeness measure. Rather, a simple measure of intra-group cohesiveness based on the average of the consistency strength of all edges in the group is used. Formally, for a given bridge structure: G={g₀,g}, and co-occurrence consistency matrix Φ, the intra-group cohesiveness for each group is given by:

$$\begin{matrix} \\ intra ( {g}_{k} \vert Φ ) = \{ \begin{matrix}0 & if \vert {g}_{k} \vert = 1 \\ \frac{1}{\vert {g}_{k} \vert ( \vert {g}_{k} \vert - 1 )} {\sum }_{x ∈ {g}_{k}} {\sum }_{{x}^{′} ∈ {g}_{k} \backslash x} φ ( x , {x}^{′} ) & otherwise\end{matrix} \\ \end{matrix}$$

The overall intra-group cohesiveness may be defined as weighted combination with weight w(gₖ) for group k of the individual intra-group consistencies:

$$\begin{matrix} \\ intra ( g \vert Φ , {k}_{max} ) = \frac{{\sum }_{k = 1}^{{k}_{max}} w ( {g}_{k} ) intra ( {g}_{k} \vert Φ )}{{\sum }_{k = 1}^{{k}_{max}} w ( {g}_{k} )} ; w ( {g}_{k} ) = \{ \begin{matrix}δ ( \vert {g}_{k} \vert > 1 ) \\ \vert {g}_{k} \vert \\ \vert {g}_{k} \vert ( \vert {g}_{k} \vert - 1 )\end{matrix} \\ \end{matrix}$$

Inter-Group Cohesiveness is the aggregate of the consistency connections going across the groups. Again, there are several ways of quantifying this but the definition used here is based on aggregating the inter-group cohesiveness between all pairs of groups and then taking a weighted average of all those. More formally, for every pair of groups: gᵢ and gⱼ, the inter-group cohesiveness is defined as:

$$\begin{matrix} \\ inter ( {g}_{i} , {g}_{j} \vert Φ ) = inter ( {g}_{j} , {g}_{i} \vert Φ ) = \frac{1}{\vert {g}_{i} \vert \times \vert {g}_{i} \vert} {\sum }_{x ∈ {g}_{i}} {\sum }_{{x}^{′} ∈ {g}_{j}} φ ( x , {x}^{′} ) \\ \end{matrix}$$

The overall inter-group cohesiveness may be defined as weighted combination with weight w(gᵢ,gⱼ) for group pair i and j:

$$\begin{matrix} \\ inter ( g \vert Φ , {k}_{max} ) = \frac{{\sum }_{i = 1}^{{k}_{max} - 1} {\sum }_{j = i + 1}^{{k}_{max}} w ( {g}_{i} , {g}_{j} ) inter ( {g}_{i} , {g}_{j} \vert Φ )}{{\sum }_{i = 1}^{{k}_{max} - 1} {\sum }_{j = i + 1}^{{k}_{max}} w ( {g}_{i} , {g}_{j} )} ; w ( {g}_{i} , {g}_{j} ) = \{ \begin{matrix}1 \\ \vert {g}_{i} \vert \times \vert {g}_{j} \vert\end{matrix} \\ \end{matrix}$$

The bridgeness of a bridge structure involving the first kₘₐₓ groups of the bridge structure is defined to be high if the individual groups are relatively more cohesive i.e. their intra-group cohesiveness is higher, than the cohesiveness across the groups, i.e. their inter-group cohesiveness. Again a number of bridgeness measures can be created that satisfy this definition. For example:

$$Bridgeness ( g \vert Φ , {k}_{max} ) = 1 - \frac{intra ( g \vert Φ , {k}_{max} )}{inter ( g \vert Φ , {k}_{max} )}$$

Techniques for Finding Bridge Structure

A large number of graph theoretic, e.g. shortest path, connected components, and network flow based, techniques may be used to find bridge structures as defined above. We describe two classes of techniques to efficiently find bridge structures in the The insight/relationship determination module 320 graph: (1) bundle aggregation technique that uses pre-computed bundles to create bridge structures and (2) a successive bundling technique that starts from scratch and uses depth first search for successively create more bundles to add to the bridge structure.

1. Bundle Overlap Technique

A bridge structure may be defined as a group of two or more bundles that share a small number of bridge products. An ideal bridge contains a single bridge product shared between two large bundles. Let B be the set of bundles found at any product level using the methods described above, from which to create bridge structures. The basic approach is to start with a root bundle, keep adding more and more bundles to it such that there is a non-zero overlap with the current set of bridge products.

This technique is very efficient because it uses pre-computed product bundles and only finds marginally overlapping groups, but it does not guarantee finding structures with high bridgeness and its performance depends on the quality of product bundles used. Finally, although it tries to minimize the overlap between groups or bundles, it does not guarantee a single bridge product.

Technique 6: Creating Bridge Structures from Bundle Aggregation
G = BridgesByBundleAggregation (B)

Input: B = {bₘ}ₘ₌₁^{M} =set of m product bundles
Initialize: G ← Ø ;k ← 1;

Foreach m = 1 . . . M

Cₘ ={1 ≦m^{′} ≠ m ≦ M |bₘ ∩ bₘ_{^{′}} ≠ Ø}
l ← 1; gₗ ← bₘ;g₀^{(l)} ← bₘ
While (Cₘ ≠ Ø)

$l ← l + 1$ $μ ← {arg min}_{{m}^{′} ∈ {C}_{m}} \vert {g}_{0}^{( l )} ⋂ {b}_{{m}^{′}} \vert$ ${g}_{0}^{( l )} ← {g}_{0}^{( l - 1 )} ⋂ {b}_{μ} ; {g}_{l} ← {b}_{μ}$ ${C}_{m} ← \{ {m}^{′} ∈ {C}_{m} \backslash μ \vert {g}_{0}^{( l )} ⋂ {b}_{{m}^{′}} \neq ∅ \}$

If (l ≧ 2) // Found a bridge structure

Foreach q = 2 . . . l

Gₖ ← }g₀^{(q)},g₁, . . . , g_{q}};G ← G ⊕ Gₖ;k ← K + 1

2. Successive Bundling Technique

The bundle aggregation approach depends on pre-created product bundles and, hence, they may not be comprehensive in the sense that not all bundles or groups associated with a group might be discovered as the search for the groups is limited only to the pre-computed bundles. In the successive bundling approach, the starting point is a product that is a potential bridge product. Product bundles are grown using depth first approach such that the foundation set contains the product and the candidate set is limited to the neighborhood of the product. As a bundle is created and added to the bridge, it is removed from the neighborhood. In successive iterations, the reduced neighborhood is used as the candidate set and the process continues until all bundles are found. The process is then repeated for all products as potential bridges. This exhaustive yet efficient method yields a large number of viable bridges.

Before describing the successive bundling technique, a GrowBundle function is defined and Technique 7 is used in it. This function takes in a candidate set, a foundation set, and an initial or root set of products and applies a sequence of grow and shrink operations to find the first locally optimal bundle it can find in the depth first mode.

Technique 7: Greedy GrowBundle Function
b = GrowBundle(x₀, C₀, Φ, π_{λ}, θ)
Initialize: k ← |x₀|;bₖ ← x₀;qₖ ← π_{λ}(bₖ)
${C}_{k} ← \{ {x}^{′} ∈ {C}_{0} \vert {min}_{x ∈ {C}_{k}} \{ φ ( x , {x}^{′} ) \} > 0 \} // Connected to ALL products in the bundle$ $While ( {C}_{k} \neq ∅ )$

$\tilde{q} ← {max}_{x ∈ {C}_{k}} \{ {π}_{λ} ( {b}_{k} ⊕ x ) \} ; \tilde{x} ← {arg max}_{x ∈ {C}_{k}} \{ {π}_{λ} ( {b}_{k} ⊕ x ) \} // Best product to add$ $If ( \hat{q} \leq θ {q}_{k} ) ⇒ Return {b}_{k}$ $k ← k + 1 ; {b}_{k} ← {b}_{k - 1} ⊕ \tilde{x} ; {q}_{k} ← \tilde{q}$ ${C}_{k} ← \{ {x}^{′} ∈ {C}_{k} \backslash \tilde{x} \vert φ ( \tilde{x} , {x}^{′} ) > 0 \}$

Return bₖ

The GrowBundle is called successively to find subsequent product bundles in a bridge structures as shown in the Successive bundling Technique 8 below. It requires a candidate set C from which the bridge and group products may be drawn (in general this could be all the products at a certain level), the consistency matrix, the bundleness function and bundleness threshold θ to control the stringency and the neighborhood parameter ν to control the scope and size of the bridge product neighborhood.

Technique 8: Creating Bridge Structures by Successive bundling
G = BridgesBySuccessiveBundling (C, Φ, π_{λ}, θ, v)

Initialize: G ← Ø
Foreach γ ε C // Consider each product as a potential bridge product

g₀ ← {γ};l ← 0;
N ← C∩Nᵥ (γ|Φ) // Candidate Neighborhood to grow bridge structure
While (N ≠ Ø)

${γ}_{0} ← {arg max}_{x ∈ N} φ ( γ , x ) // Best product to start the next bundle$ ${x}_{0} ← \{ γ , {γ}_{0} \} ; l ← l + 1 ;$ ${g}_{l} ← GrowBundle ( {x}_{0} , N , Φ , {π}_{λ} , θ )$ $N ← N \backslash {g}_{l} ;$

If (l > 1)

G_{γ} ← {g₀,g₁, . . . , gₗ};G ← G ⊕ G_{γ}

Special Bridge Structures

So far there are no constraints imposed on how the bridge structures are created except for the candidate set. However, special bridge structures may be discovered by using appropriate constraints on the set of products that the bridge structure is allowed to grow from. One way to create special bridge structure is to define a special candidate sets for different roles in the bridges structure, e.g. bridge product role, group product role, instead of using a single candidate set.
Candidate set for Bridge products: This is the set of products that may be used as bridge products. A retailer might include products that have high price elasticity, or has coupons for these, or are overstocked, or the like. In other words bridge candidate products are those that can be easily promoted without much revenue or margin impact.
Candidate set for each of the product groups: This is the set of products that the retailer wants to find bridges across. For example, a retailer might want to find bridge products between department A and department B, or between products by manufacturer A and those by manufacturer B, or brand A and brand B, or high value products and low value products, etc. For any of these, appropriately chosen candidate set for the two (or more) product groups leads to the special bridge structures.

Technique 8 is modified to do special bridges as follows: Instead of sending a single candidate set, now there is one candidate set for the set of bridge products and one candidate set for (possibly each of the) product groups. Using the depth first bundling technique, product bundles are created such that they must include a candidate bridge product i.e. the foundation set contains the bridge product, and the remaining products of the bundle come from the candidate set of the corresponding group that are also the neighbors of the potential bridge product. High bridgeness structures are selected from the Cartesian product of bundles across the groups.

Technique 9: Creating Special bridge structures

```
G = SpecialBridgesBySuccessiveBundling(C,Φ,π_{λ},θ,ν)
Input: C = {C₀,C₁,C₂} // Different candidate sets for bridges and groups
Initialize: G ← Ø
- Foreach γ ∈ C₀ // Consider each product as a potential bridge product
  - Foreach l = 1...2;
    - Bₗ ← DepthFirstBundle({γ},Cₗ ∩ Nᵥ (γ |Φ),Φ,π_{λ},θ)
  - Foreach b₁ ∈ B₁
    - Foreach b₂ ∈ B₂
      - G ← G ⊕ {g₀ = {γ},g₁ = b₁,g₂ = b₂}
- Sort all bridges in G in descending order of their bridgeness. Pick top M
- Return G
```

Business Decisions from Bridge Structures

Bridge structures embedded in the insight/relationship determination module 320 graphs may provide insights about what products link otherwise disconnected products. Such insight may be used in a number of ways:
Cross-Department Traffic: Typically, most intentional purchases are limited to a single or small number of departments or product categories. A retailer's business objective might be to increase the customer's wallet share by inciting such single/limited department customers to explore other departments in the store. Bridge structures provide a way to find products that may be used to create precisely such incitements. For example, a customer who stays in a low margin electronics department may be incited to check-out the high margin jewelry department if a bridge product between the two departments, such as a wrist watch or its signage, is placed strategically. Special bridge structures such as the ones described above may be used to identify such bridge products between specific departments.
Strategic Product promotions of increasing Customer value: One of the business objectives for a retailer may be to increase customer's value by moving them from their current purchase behavior to an alternative higher value behavior. This again may be achieved by strategically promoting the right bridge product between the two groups of products. The insight/relationship determination module 320 provides flexibility in how a low value and high value behavior is characterized in terms of product groups associated with such behavior and then use the special bridge structures to find bridges between the two.
Increasing customer Diversity: Diversity of a customer's market basket is defined by the number of different departments or categories the customer shops in at the retailer. The larger the customer diversity, typically, higher the wallet share for the retailer. Bridge products may be used strategically to increase customer diversity by using special cross-department bridge structures.

Bridge Projection Scores

Both product bundles and bridge structures are logical structures as opposed to actual structures. Therefore, typically, a single customer buys either none of the products or a subset of the products associated with such structures. Described earlier were several ways of projecting a customer against a bundle resulting in various bundle-projection-scores that may be used in either making decisions directly or used for further analysis. Similarly, bridge structures may also be used to create a number of bridge-projection-scores. These scores are defined by a bundle structure, a market basket, and a projection scoring function:
Bridge-structure denoted by G={gₗ}ₗ₌₀^{L} contains one or more bridge products connecting two or more product groups.
Market Basket denoted by x ⊂ U is a market basket obtained from the transaction data. In general, depending on the application, it could be either a single transaction basket or a union of recent customer transactions or all of customer transactions so far.
Projection-Scoring Function denoted by ƒ(x|G,Φ,λ) is a scoring function that may use the co-occurrence consistency matrix Φ and a set of parameters A and creates a numeric score.

There are several projection scores that may be computed from a bridge structure and market basket combination. For example:
Bridge-Purchased Indicator: A binary function that indicates whether a bridge product of the bridge structure is in the market basket:

$${f}_{indicator} ( x \vert G , 0 ) = δ ( x ⋂ {g}_{0} \neq Ø )$$

Group-Purchase Indicator: A binary function for each group in the bridge structure that indicates whether a product from that group is in the market basket.

$${f}_{indicator} ( x \vert G , l ) = δ ( x ⋂ {g}_{l} \neq Ø ) \text{:} ∀ l = 1 … L$$

Group-Overlap Scores: For each group in the bridge structure, the overlap of that group in the market basket (as defined for product bundles).

$${f}_{overlap \text{-} A} ( x \vert G , l ) = \frac{\vert x ⋂ {g}_{l} \vert}{\vert x ⋃ {g}_{l} \vert} ;$$

$${f}_{overlap \text{-} B} ( x \vert G , l ) = \frac{\vert x ⋂ {g}_{l} \vert}{min \{ \vert x \vert , \vert {g}_{l} \vert \}} \text{:} ∀ l = 1 … L$$

Group-Coverage Scores: For each group in the bridge structure, the coverage of that group in the market basket (as defined for product bundles).

$${f}_{coverage} ( x \vert G , l ) = \frac{\vert x ⋂ {g}_{l} \vert}{\vert {g}_{l} \vert} ;$$

$${f}_{wtd \text{-} coverage} ( x \vert G , l , Φ , λ ) = \frac{{π}_{λ} ( x ⋂ {g}_{l} \vert Φ )}{{π}_{λ} ( {g}_{l} \vert Φ )}$$

Group-Aggregate Scores: A number of aggregations of the group coverage and group overlap scores may also be created from these group scores.

Product Phrases or Purchase Sequences

Product bundles are created using market basket context. The market basket context loses the temporal aspect of product relationships, however broad the time window it may use. The following discussion defines an extension of product bundles in another higher order structure known as a product phrase or consistent purchase sequence created using the insight/relationship determination module 320 framework. Essentially, a product phrase is a product bundle equivalent for purchase sequence context. Traditional frequency based methods extend the known standard market basket techniques to create high frequency purchase sequences. However, because transaction data is a mixture of projections of latent intensions that may extend across time, frequency based methods are limited in finding actionable, insightful, and logical product phrases. The same argument for product bundles also applies to product phrases.

The insight/relationship determination module 320 uses transaction data first to create only pair-wise co-occurrence consistency relationships between products by including both the market basket and purchase sequence contexts. This combination gives a tremendous power to the insight/relationship determination module 320 for representing complex higher order structures including product bundles, product phrases, and sequence of market baskets and quantify their co-occurrence consistency. The following discussion defines a product phrase and present techniques to create these phrases.

Definition of a Logical Product Phrase

A product phrase is defined as a logical product bundle across time. In other words, it is a consistent time-stamped sequence of products such that each product is consistently co-occurs with all others in the phrase with their relative time-lags. In its most general definition, a logical phrase subsumes the definition of a logical bundle and uses both market basket as well as purchase sequence contexts, i.e. a combination that is referred to as the Fluid Context in the insight/relationship determination module 320, to create it.

Formally, a product phrase [symbol] x,Δt [symbol] is defined by two sets:
Product Set: x={x₁,x₂, . . . , xₙ} containing the set of products in the phrase.
Pair-wise Time Lags: Δt={Δtᵢⱼ:1≦i≦j≦n} contains time-lags between all product pairs.

Time lags are measured in a time resolution unit which could be days, weeks, months, quarters, or years depending on the application and retailer. The time-lags must satisfy the following constraints:

$$Δ {t}_{ij} = {\sum }_{k = i}^{j - 1} Δ {t}_{k , k + 1} \pm {ɛ}_{j - i} \text{:} ∀ 1 \leq i < j \leq n$$

The slack parameter ε_{Δi} determines how strictly these constraints are imposed depending on how far the products are in the phrase. Also, note that this definition includes product bundles as a special case where all time-lags are zero:

$$〈 x , 0 〉 i . e . Δ {t}_{ij} = 0 \text{:} ∀ 1 \leq i < j \leq n$$

FIG. 15 shows a product phrase with six products and some of the associated time-lags.

Fluid Context

The context rich the insight/relationship determination module 320 framework supports two broad types of contexts: market basket context and purchase sequence context. For exploring higher order structures as general as product phrases, as defined above, we need a combination of both these context types into a single context framework. This combination is known as the Fluid Context. Essentially fluid context is obtained by concatenating the two-dimensional co-occurrence matrices along the time-lag dimension. The first frame in this fluid context video is the market basket context (Δτ=0) with a window size equal to the time resolution. Subsequent frames are the purchase sequence contexts with their respective Δτ's. Fluid context is created in three steps:
Co-occurrence Count: Using the market basket and purchase sequence contexts, the four counts for all time-lags are computed as described earlier:

η(α,β|Δτ): Co-occurrence count
η(α,•|Δτ): From Margin
η(•,β|Δτ): To Margin
η(•,•|Δτ): Totals

Temporal Smoothing: All the counts, i.e. co-occurrence, margins, and totals, are smoothed using a low-pass filter or a smoothing kernels with different shapes, i.e. rectangular, triangular, Gaussian, that replaces the raw count with a weighted average based on neighboring counts:

$$\hat{η} ( Δ τ ) = \frac{{\sum }_{Δ t = Δ t - σ}^{Δ τ + σ} {w}_{σ} ( \vert Δ τ - Δ t \vert ) η ( Δ t )}{{\sum }_{Δ t = Δ t - σ}^{Δ τ + σ} {w}_{σ} ( \vert Δ τ - Δ t \vert )} ;$$

$${w}_{σ} ( t ) = \{ \begin{matrix}1 & Rectangular window \\ ( 1 + σ - t ) & Triangular Window \\ exp [ - 0.5 {( t / σ )}^{2} ] & Gaussian Window\end{matrix}$$

Consistency Calculation: The smoothed counts are then used to compute consistencies using any of the consistency measures provided above.

A fluid context is represented by a three dimensional matrix:

$$Φ \text{:} U \times U \times Δ T \to R \text{:} [ φ ( α , β \vert Δ τ ) ] \text{:} ∀ α , \\ β ∈ U , Δ τ ∈ Δ T = \{ 0 , … , Δ T \}$$

Cohesiveness of a Product Phrase: “Phraseness”

Cohesiveness of a phrase is quantified by a measure called phraseness which is akin to the bundleness measure of cohesiveness of a product bundle. The only difference is that in product bundles, market basket context is used and in phrases, fluid context is used. The three-stage process for computing phraseness is similar to the process of computing bundleness:
Extract Phrase-Sub-matrix from Fluid Context Matrix: Given a fluid context matrix Φ and a phrase: (x,Δt) the non-symmetric phrase sub-matrix is given by:

$$Φ ( 〈 x , Δ t 〉 ) = {[ {φ}_{ij} = φ ( {x}_{i} , {x}_{j} \vert Δ {t}_{ij} ) ]}_{1 \leq i , j \leq n}$$

Compute Seedness of each product: The seedness of each product in a phrase is computed using the same hubs and authority based Technique 3 used to compute the seedness in product bundles. Note however, that since the phrase sub-matrix is not symmetric, the hubness and authority measures of a product are different in general for a phrase. The seedness measure is associated with authority. The hubness of a product in the phrase indicates a follower role or tailness measure of the product.

$$a ≡ {a}^{( ∞ )} ← {eig}_{1} [ Φ ( 〈 x , Δ t 〉 ) {Φ ( 〈 x , Δ t 〉 )}^{T} ]$$

$$h ≡ {h}^{( ∞ )} ← {eig}_{1} [ {Φ ( 〈 x , Δ t 〉 )}^{T} Φ ( 〈 x , Δ t 〉 ) ] .$$

Aggregate Phraseness: For the purposes of an overall cohesiveness of a phrase we don't distinguish between the seedness or tailness measure of a product and use the maximum or average of the two in aggregation.

$${π}_{λ} ( 〈 x , Δ t 〉 \vert Φ ) = \frac{{\sum }_{i = 1}^{n} {q}_{i} \times exp [ λ \times {q}_{i} ]}{{\sum }_{i = 1}^{n} \dot{exp} [ λ \times {q}_{i} ]} \text{:} λ ∈ [ - ∞ , + ∞ ]$$

$${q}_{i} = \{ \begin{matrix}max \{ a ( {x}_{i} \vert 〈 x , Δ t 〉 , Φ ) , h ( {x}_{i} \vert 〈 x , Δ t 〉 , Φ ) \} \text{:} ∀ i = 1 … n \\ \frac{a ( {x}_{i} \vert 〈 x , Δ t 〉 , Φ ) + h ( {x}_{i} \vert 〈 x , Δ t 〉 , Φ )}{2} \text{:} ∀ i = 1 … n\end{matrix}$$

Techniques for Finding Cohesive Product Phrases

Techniques described earlier for finding product bundles using market basket context based in the insight/relationship determination module graphs may be extended directly to find phrases by replacing the market basket context with fluid context and including additional search along the time-lag.

Insights and Business Decisions from Product Phrases

Product phrases may be used in a number of business decisions that span across time. For example:
Product Prediction: For any customer, if his transaction history is known, product phrases may be used to predict what product the customer might buy next and when. This is used in the insight/relationship determination module 320's recommendation engine, as described below.
Demand Forecasting: Because each customer's future purchase can be predicted using purchase sequence analysis, aggregating these by each product gives a good estimate of when, which product might be sold more. This is especially true for grocery type retailers where the shelf-life of a number of consumables is relatively small and inventory management is a key cost affecting issue.
Career-Path Analysis: Customers are not static entities: their life style and life stage change over time and so does their purchase behavior. Using key product phrases and product bundles, it is possible to predict where the customer is and which way he is heading.
Identifying Trigger Products with Long Coat-Tails: Often the purchase of a product might result in a series of purchases with or after this purchase. For example, a PC might result in a future purchase of a printer, cartridge, scanner, CD's, software, and the like. Such products are called trigger products. High consistency, high value phrases may be used to identify key trigger products that result in the sale of a number of high-value products. Strategic promotion of these products can increase the overall life-time value of the customer.

Recommendation Engine

Product neighborhoods, product bundles, bridge structures, and product phrases are all examples of product affinity applications of the insight/relationship determination module 320 framework. These applications seek relationships between pairs of products resulting in a graph and discover such higher order structures in it. Most of these applications are geared towards discovering actionable insights that span across a large number of customers. The following discussion describes a highly (a) customer centric, (b) data driven, (c) transaction oriented purchase behavior application of the insight/relationship determination module 320 framework, i.e. the Recommendation Engine. A goal for a Recommendation Engine application is to offer the right product to the right customer at the right time at the right price through the right channel so as to maximize the propensity that the customer actually take-up the offer and buy the product or products. A recommendation engine allows retailers to match their content with customer intent through a very systematic process that may be deployed in various channels and customer touch points.

The insight/relationship determination module 320 framework lends itself very naturally to a recommendation engine application because it captures customer's purchase behavior in a very versatile, unique, and scalable manner in the form of insight/relationship determination module graphs. In the following discussion, the various dimensions of a recommendation engine application are introduced and described increasingly complex and more sophisticated recommendation engines can be created from the insight/relationship determination module 320 framework. These recommendation engines can tell not just what is the right product but also when is the right time to offer that product to a particular customer.

Definition of a Recommendation Engine Application

Typically, a recommendation engine attempts to answer the following business question: Given the transaction history of a customer, what are the most likely products the customer is going to buy next? In The insight/relationship determination module 320 this definition is taken one step further and to try and answer not just what product the customer will buy next but also when is he most likely to buy it. Thus, the recommendation engine has three essential dimensions:

1. Products—that are being considered for recommendation

2. Customers—to who one or more products are recommended; and

3. Time—at which recommendation of specific products to specific customers is made.

A general purpose recommendation engine should therefore be able to create a purchase propensity score for every combination of product, customer, and time, i.e. it takes the form of a three dimensional matrix:

```
Recommendation Propensity Score =ρ(u,t|x, Θ)
Where:
  - u = product to be recommended
  - t = time at which recommendation is made
  - x = { [symbol] t₁,x₁ [symbol] ,..., [symbol] t_{L},x_{L} [symbol] } = customer transaction history
  - Θ = recommendation engine model parameters
```

Recommendation Process

FIG. 20 shows the recommendation process starting from transaction data to deployment. There are four main stages in the entire process.

1. Recommendation Engine—takes the raw customer transaction history, the set of products in the recommendation pool and the set of times at which recommendations have to be made. It then generates a propensity score matrix described above with a score for each combination of customer, product, and time. Business constraints, e.g. recommend only to customers who bought in the last 30 days or recommend products only from a particular product category, may be used to filter or customize the three dimensions.

2. Post-Processor—The recommendation engine uses only customer history to create propensity scores that capture potential customer intent. They do not capture retailer's intent. The post-processor allows the retailers to adjust the scores to reflect some of their business objectives. For example, a retailer might want to push the seasonal products or products that lead to increased revenue, margin, market basket size, or diversity. The insight/relationship determination module 320 provides a number of post-processors that may be used individually or in combination to adjust the propensity scores.

3. Business Rules Engine—Some business constraints and objectives may be incorporated in the scores but others are implemented simply as business rules. For example, a retailer might want to limit the number of recommendations per product category, limit the total discount value given to a customer, etc. Such rules are implemented in the third stage where the propensity scores are used to create top R recommendations per customer.

4. Channel Specific Deployment—Once the recommendations are created for each customer, the retailer has a choice to deliver those recommendations using various channels. For example, through direct mail or e-mail campaigns, through their web-site, through in-store coupons at the entry Kiosk or point of sale, or through a salesman. The decision about the right channel depends on the nature of the product being recommended and the customer's channel preferences. These decisions are made in the deployment stage.

Before we describe the recommendation engine and the post-processing stages, let important deployment issues be considered.

Deployment Issues

There are several important issues that affect the nature of the deployment and functionality of a recommendation engine: (1) Recommendation Mode—products for a customer or customers for a product?; (2) Recommendation Triggers—Real-time vs. Batch mode?; and (3) Recommendation Scope—what aspects of a customer's transaction should be considered.

1. Recommendation Modes: Customer vs. Product vs. Time—The insight/relationship determination module 320 recommendation engine can be configured to work in three modes depending on the business requirements.
Product-Centric Recommendations answers questions such as “What are the top customers to which a particular product should be offered at a specific time?” Such decisions may be necessary, for example, when a retailer has a limited number of coupons from a product manufacturer and he wants to use these coupons efficiently i.e. give these coupons to only those customers who actually use the coupons and therefore increase the conversion rate.
Customer-Centric Recommendations answers questions such as “What are the top products that a particular customer should be offered at a specific time? ” Such decisions may be necessary, for example, when a retailer has a limited budget for a promotion campaign that involves multiple products and there is a limit on how many products he can promote to a single customer. Thus, the retailer may want to find that set of products that a particular customer is most likely to purchase based on his transaction history and other factors.
Time Centric Recommendations: answers questions such as “What are the best product and customer combinations at a specific time? ” Such decisions may be necessary for example, when a retailer has a pool of products and a pool of customers to choose from and he wants to create an e-mail campaign for say next week and wants to limit the number of product offers per customer and yet optimize the conversion rate in the overall joint space.

The insight/relationship determination module 320 definition of the recommendation engine allows all the three modes.

2. Recommendation Triggers: Real-time vs. Batch-Mode—A recommendation decision might be triggered in a number of ways. Based on their decision time requirements, triggers may be classified as:

(a) Real-time or Near-Real time triggers require that the recommendation scores are updated based on the triggers. Examples of such triggers are:
Customer logs into a retailer's on-line store. Web page tailored based on transaction history. May be pre-computed but deployed in real-time.
Customer adds a product to cart. Transaction history is affected so the propensity scores need to be re-computed and new sets of recommendations need to be generated.
Customer checks-out in store or web-site. Transaction history change requires that the propensity scores be re-computed and recommendations for next visit be generated.

(b) Batch-mode Triggers require that the recommendation scores are updated based on pre-planned campaigns. Example of such a trigger is a weekly Campaign where E-mails or direct mail containing customer centric offers are sent out. A batch process may be used to generate and optimize the campaigns based on recent customer history.

3. Recommendation Scope: Defining History—Propensity scores depend on the customer history. There are a number of ways in which a customer history might be defined. Appropriate definition of customer history must be used in different business situations. Examples-of some of the ways in which customer history may be defined are given below:
Current purchase—For anonymous customers, the customer history is not available. In such cases, all we have is their current purchase and recommendations are based on these products only.
Recent purchases—Even when the customer history is known, for certain retailers, such as home improvement, the purchase behavior might be highly time-localized i.e. future purchases might just depend on recent purchases where recent may be say last three months.
Entire history as a market basket—In some retail domains such as grocery, the time component might not be as important and only what the customers bought in the past is important. In such domains, an entire customer history weighted by recent products may be used while ignoring the time component.
Entire history as a sequence of market baskets—In some retail domains such as electronics, the time interval between successive purchases of specific products, e.g. cartridge after printer, might be important. In such domains, the customer history may be treated as a time-stamped sequence of market baskets to create precise and timely future recommendations.
Products browsed—So far we have considered only products purchased as part of customer history. There are two other ways in which a customer interacts with products. The customer may just browse the product to consider for purchasing such as in clothing, the customer might try-it-on or read the table of contents before buying a book or sampling the music before buying a CD or read the reviews before buying a high end product. The fact that the customer took time at least to browse these products shows that he has some interest in them and, therefore, even if he does not purchase them, they can still be used as part of the customer history along with the products he did purchase.

In the recommendation engines presented below, the goal is to cross-sell products that the customer did not purchase in the past. That is why the past purchased products are deliberately removed from the recommendation list. It is trivial to add them in, as discussed in one of the post-processing engines, later.

At the heart of the recommendation scoring is the problem of creating a propensity or likelihood score for what a customer might buy in the near or far away future based on his customer history. In the following discussion, we present two types of recommendation engines based on (a) the nature of the context used, (b) interpretation of customer history, and (c) temporal-scope of the resulting recommendations: The (1) Market Basket Recommendation Engine (MBRE) and (2) Purchase Sequence Recommendation Engine (PSRE). FIG. 17 shows the difference between the two in terms of how they interpret customer history. The MBRE treats customer history as a market basket comprising of products purchased in recent past. All traditional recommendation engines also use the same view. However, the way insight/relationship determination module 320 creates the recommendations is different from the other methods. The PSRE treats customer history as what it is i.e. a time-stamped sequence of market baskets.

Market Basket Recommendation Engine

When either the customer's historical purchases are unknown and only current purchases can be used for making recommendations, or when the customer history is to be interpreted as a market basket and when recommendations for the near future have to be generated, then The insight/relationship determination module 320's Market Basket Recommendation Engine may be used. In MBRE customer history is interpreted as a market basket, i.e. current visit, union of recent visits, history weighted all visit. Any future target product for which the recommendation score has to be generated is considered a part of the input market basket that is not in it yet. Note that the propensity score for MBRE

ρ(u,t|x,Φ=ρ(u|x,Φ) recommends products that the customer would buy in the near future and, hence, the time dimensions is not used here.

Creating the MBRE Recommendation Model

The market basket recommendation is based on coarse market basket context. A window parameter ω denotes the time window of each market basket. Earlier we have described how market basket consistency matrix is created from the transaction data, given the window parameter and product level. This counts matrix is then converted into a consistency matrix using any of the consistency measures available in the insight/relationship determination module 320 library. This matrix serves as the recommendation model for an MBRE. In general this model depends on the (a) choice of the window parameter, (b) choice of the consistency measure, and (c) any customizations, e.g. customer segment, seasonality, applied to the transaction data.

Generating the MBRE Recommendation Score

Given the input market basket customer history, x, the recommendation model in the form of the market basket based co-occurrence matrix, Φ, the propensity score ρ(u|x,Φ) for target product u may be computed in several ways, for example:

1. Gibb's Aggregated Consistency Score—The simplest class of scoring functions simply aggregates the consistencies between the products in the market basket with the target product. The insight/relationship determination module 320 uses a general class of aggregation function known as the Gibb's aggregation based on Gibb's distribution that weigh the different products in the market basket according to their consistency strength with the target product.

$${ρ}_{λ} ( u \vert x , Φ ) = δ ( u ∉ x ) \frac{{\sum }_{x ∈ x} φ ( x , u ) \times exp [ λ \times φ ( x , u ) ]}{{\sum }_{x ∈ x} exp [ λ \times φ ( x , u ) ]}$$

$${ρ}_{0} ( u \vert x , Φ ) = \frac{δ ( u ∉ x )}{\vert x \vert} {\sum }_{x ∈ x} φ ( x , u )$$

$${ρ}_{∞} ( u \vert x , Φ ) = δ ( u ∉ x ) {max}_{x ∈ x} \{ φ ( x , u ) \}$$

The parameter λ ∈[0,∞] controls the degree to which the higher consistency products are favored. While these scores are fast and easy to compute they assume independence among the products in the market basket.

2. Single Bundle Normalized Score—Transaction data is a mixture of projections of multiple intentions. In this score, we assume that a market basket represents a single intention and treat it as an incomplete intention whereby adding the target product would make it more complete. Thus, a propensity score may be defined as the degree by which the bundleness increases when the product is added.

$${ρ}_{λ} ( u \vert x , Φ ) = δ ( u ∉ x ) \frac{{π}_{λ} ( u ⊕ x \vert Φ )}{δ ( {π}_{λ} ( x \vert Φ ) = 0 ) + {π}_{λ} ( x \vert Φ )}$$

3. Mixture-of-Bundles Normalized Score—Although the single bundle normalized score accounts for dependence among products, it still assumes that the market basket is a single intention. In general, a market basket is a mixture of bundles or intentions. The mixture-of-bundles normalized score goes beyond the single bundle assumption. It first finds all the individual bundles in the market basket and then uses the bundle that maximizes the single bundle normalized score. It also compares these bundles against single products as well as the entire market basket, i.e. the two extremes.

$${ρ}_{λ} ( u \vert x , Φ ) = δ ( u ∉ x ) {max}_{b ∈ B ( x \vert Φ )} \{ \frac{{π}_{λ} ( u ⊕ b \vert Φ )}{δ ( {π}_{λ} ( b \vert Φ ) = 0 ) + {π}_{λ} ( b \vert Φ )} \}$$

$$B ( x \vert Φ ) = \{ x \} ⋃ Bundles ( x \vert Φ ) ⋃ S ( x )$$

$$S ( x ) = \{ \{ x \} \vert ∀ x ∈ x \} // set of all single elements subsets of x$$

Purchase Sequence Recommendation Engine

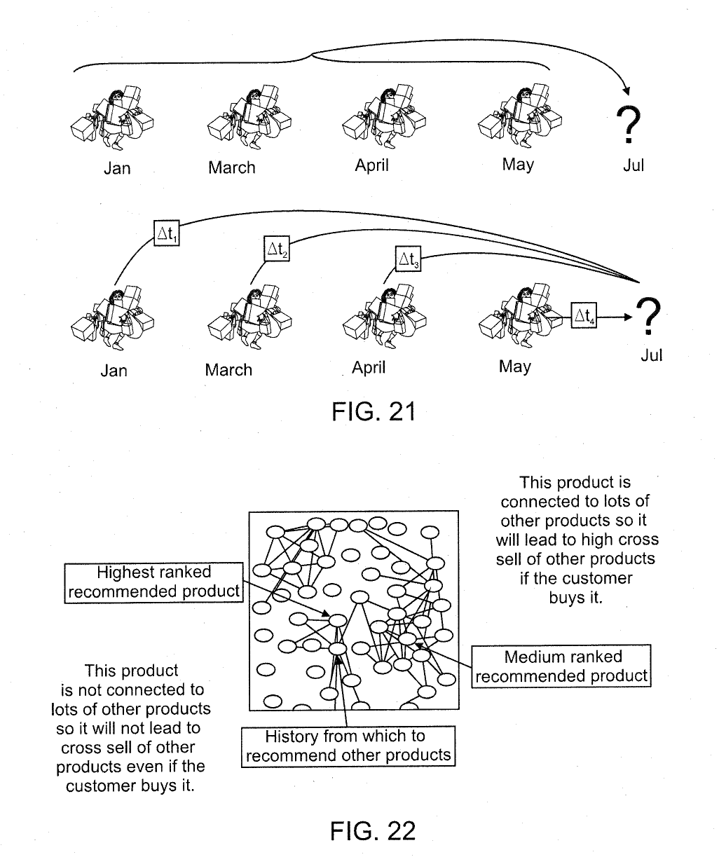

In the market basket based recommendation engine, the timing of the product is not taken into account. Both the input customer history and the target products are interpreted as market baskets. For retailers where timing of purchase is important, the insight/relationship determination module 320 framework provides the ability to use not just what was bought in the past but also when it was bought and use that to recommend not just what will be bought in the future by the customer but also when it is to be bought. As shown in FIG. 21, the purchase sequence context uses the time-lag between any past purchase and the time of recommendation to create both timely and precise recommendations.

Creating the PSRE Recommendation Model

The PSRE recommendation model is essentially the Fluid Context matrix described earlier. It depends on (a) the time resolution (weeks, months, quarters, . . . ), (b) type of kernel and kernel parameter used for temporal smoothing of the fluid context counts, (c) consistency matrix used, and of course (d) customization or transaction data slice used to compute the fluid co-occurrence counts.

Generating the PSRE Recommendation Score

Given the input purchase sequence customer history:

x̅=( [symbol] x₁,t [symbol] , . . . [symbol] x₁,t₁ [symbol] )= [symbol] x,Δt

[symbol]

x={x₁, . . . , x_{L}};Δt={Δtᵢⱼ=tⱼ−tᵢ}_{1≦i<j≦L}

and the fluid context matrix (recommendation model) matrix, Φ, the propensity score ρ(u,t| x̅,Φ) for target product u at time t may be computed in several ways, similar to the MBRE:

1. Gibb's Aggregated Consistency Score—The simplest class of scoring functions used in MBRE is also applicable in the PSRE.

$${ρ}_{λ} ( u , t \vert \tilde{x} , Φ ) = δ ( u ∉ x ) \frac{\begin{matrix}{\sum }_{l = 1}^{L} φ ( {x}_{l} , u \vert Δ ( t , {t}_{l} ) ) \times \\ exp [ λ \times φ ( {x}_{l} , u \vert Δ ( t , {t}_{l} ) ) ]\end{matrix}}{{\sum }_{l = 1}^{L} exp [ λ \times φ ( {x}_{l} , u \vert Δ ( t , {t}_{l} ) ) ]}$$

$${ρ}_{0} ( u , t \vert \tilde{x} , \tilde{Φ} ) = \frac{δ ( u ∉ x )}{L} {\sum }_{l = 1}^{L} φ ( {x}_{l} , u \vert Δ ( t , {t}_{l} ) )$$

$${ρ}_{∞} ( u , t \vert \tilde{x} , Φ ) = δ ( u ∉ x ) {max}_{l = 1 … L} \{ φ ( {x}_{l} , u \vert Δ ( t , {t}_{l} ) ) \}$$

Note how the time-lag between a historical purchase at time tₗ and the recommendation time: t, given by Δ(t,tₗ)=tₗ−t, is used to pick the time-lag dimensions in the fluid context matrix. This is one applications of the fluid context's time-lag dimension. Although, it is fast to compute and easy to interpret, the Gibb's aggregate consistency score assumes that all past products and their times are independent of each other, which is not necessarily true.

2. Single-Phrase Normalized Score—Transaction data is a mixture of projections of multiple intentions spanning across time. In this score, we assume that a purchase history represents a single intention and treat it as an incomplete intention whereby adding the target product at the decision time t would make it more complete. Thus, a propensity score may be defined as the degree by which the phraseness increases when the product is added at the decision time.

$${ρ}_{λ} ( u , t \vert \tilde{x} , Φ ) = δ ( u ∉ x ) \frac{{π}_{λ} ( \tilde{x} ⊕ 〈 u , t 〉 \vert Φ )}{δ ( {π}_{λ} ( \tilde{x} \vert Φ ) = 0 ) + {π}_{λ} ( \tilde{x} \vert Φ )}$$

3. Mixture-of-Phrases Normalized Score—Although the single bundle normalized score accounts for dependence among products, it still assumes that the entire purchase history is a single intention. In general a purchase sequence is a mixture of phrases or intentions across time. The mixture-of-phrases normalized score goes beyond the single phrase assumption. It first finds all the individual phrases in the purchase sequence and then uses the phrase that maximizes the single phrase normalized score. It also compares the score against all the single element phrases as well as the entire phrase, i.e. the two extreme cases.

$${ρ}_{λ} ( u , t \vert \tilde{x} , Φ ) = δ ( u ∉ x ) {max}_{p ∈ P ( \tilde{x} \vert Φ )} \{ \frac{{π}_{λ} ( p ⊕ u \vert Φ )}{δ ( {π}_{λ} ( p \vert Φ ) = 0 ) + {π}_{λ} ( p \vert Φ )} \}$$

$$P ( \tilde{x} \vert Φ ) = \{ \tilde{x} \} ⋃ Phrases ( \tilde{x} \vert Φ ) ⋃ S ( \tilde{x} )$$

$$S ( \tilde{x} ) = \{ {\{ 〈 {x}_{l} , {t}_{l} 〉 \}}_{l = 1}^{L} \} // set of all single elements subsets of \tilde{x}$$

Post-Processing Recommendation Scores

The recommendation propensity scores obtained by the recommendation engines as described above depend only on the transaction history of the customer. The propensity scores do not incorporate retailer's business objective yet. In the following discussion various possible business objectives and ways to post-process or adjust the propensity scores obtained from the recommendation engines to reflect those business objectives are presented. The post-processing combines the recommendation scores with adjustment coefficients. Based on how these adjustment coefficients are derived, there are two broad types of score adjustments:

1. First order, transaction data driven score adjustments in which the adjustment coefficients are computed directly from the transaction data. Examples are seasonality, value, and loyalty adjustments.

2. Second order Consistency matrix driven score adjustments in which the adjustment coefficients are computed from the consistency matrices. Examples are density, diversity, and future customer value adjustments.

Some of the important score adjustments are described below:

(a) First Order: Seasonality Adjustment

In any retailer's product space, some products are more seasonal than others and retailer's might be interested in adjusting the recommendation scores such that products that have a higher likelihood of being purchased in a particular season are pushed up in the recommendation list in a systematic way. This is done in the insight/relationship determination module 320 by first computing a Seasonality Score for each product, for each season. This score is high if the product is sold in a particular season more than expected. There are a number of ways to create the seasonality scores. One of the simple methods is as follows:

Let's say seasons are defined by a set of time zones for example each week could be a time zone, each month, each quarter, or each season (summer, back-to-school, holidays, etc.). We can then compute a seasonal value of a product in each season as well as its expected value across all seasons. Deviation from the expected value quantify the degree of seasonality adjustment. More formally:
Let S={s₁, . . . , s_{K}} be K seasons. Each season could simply be a start-day and end-day pair.
Let {V(u|sₖ)}ₖ₋₁^{K} denote value, e.g. revenue, margin, etc., of a product u across all seasons.
Let {N(sₖ)}ₖ₌₁^{K} be the normalizer, e.g. number of customers/transactions for each season.

$$Let V ( u ) = {\sum }_{k = 1}^{K} V ( u \vert {s}_{k} )$$

be the total value of the product u across all seasons.

$$Let N = {\sum }_{k = 1}^{K} N ( {s}_{k} )$$

be the total normalizer across all seasons.
Then the deviation from the expected value of a product in a season is given by:

$${Δ}_{diff} V ( u \vert {s}_{k} ) = f ( \frac{V ( u \vert {s}_{k} )}{N ( {s}_{k} )} - \frac{V ( u )}{N} ) \text{:} Difference ( Additive ) Deviation$$

$${Δ}_{ratio} V ( u \vert {s}_{k} ) = f ( log [ \frac{V ( u \vert {s}_{k} ) \times N}{V ( u ) \times N ( {s}_{k} )} ] ) \text{:} Ratio ( Multiplicative ) Deviation$$

The function ƒ applies some kind of bounding on the deviations around the zero mark. For example, a lower/higher cut-off or a smooth sigmoid, etc.
A product is deemed seasonal if some aggregate of magnitudes of these deviations is large, for example:

$${σ}_{λ} ( u ) = \frac{{\sum }_{k = 1}^{K} \vert Δ V ( u \vert {s}_{k} ) \vert \times exp ( λ \times \vert Δ V ( u \vert {s}_{k} ) \vert )}{{\sum }_{k = 1}^{K} exp ( λ \times \vert Δ V ( u \vert {s}_{k} ) \vert )}$$

Two parameters may be used to create seasonality adjustments: The seasonal deviation of a product from the expected: ΔV(u|sₖ) and the seasonality coefficient σ_{λ}(u) that indicates whether or not the product is seasonal. Because the unit of the recommendation score does not match the unit of the seasonality adjustment, adjustments in the relative scores or ranks may be used as follows:
Let ρ_{λ}_{₁}(u,t|\tilde{x},Φ)=ρ(u,t) be the recommendation score for product u at time t.
Let x_{ρ}(u,t) be the recommended relative score or rank of product u compared to all other products in the candidate set C for which recommendation is generated. For example:

$${x}_{ρ}^{max} ( u , t ) = \frac{ρ ( u , t )}{{max}_{v ∈ C \backslash x} \{ ρ ( v , t ) \}} ;$$

$${x}_{ρ}^{z \text{-} score} ( u , t ) = \frac{ρ ( u , t ) - μ ( \{ ρ ( v , t ) \text{:} ∀ v ∈ C \} )}{σ ( \{ ρ ( v , t ) \text{:} ∀ v ∈ C \} )}$$

$${x}_{ρ}^{rank} ( u , t ) = \frac{1}{\vert C \vert} {\sum }_{v ∈ C} δ ( ρ ( u , t ) \geq ρ ( v , t ) )$$

Let s(t)be the season for time I.
Let x_{s-V}(u,s(t)) be the seasonal relative score or rank of product u with respect to its value V compared to all other products. For example:

$${x}_{s - V}^{max} ( u , s ( t ) ) = \frac{Δ V ( u , s ( t ) )}{{max}_{v ∈ C \backslash x} \{ Δ V ( v , s ( t ) ) \}} ;$$

$${x}_{s - V}^{z \text{-} score} ( u , s ( t ) ) = \frac{Δ V ( u , s ( t ) ) - μ ( \{ Δ V ( v , s ( t ) ) \text{:} ∀ v ∈ C \} )}{σ ( \{ Δ V ( v , s ( t ) ) \text{:} ∀ v ∈ C \} )}$$

$${x}_{s - V}^{rank} ( u , s ( t ) ) = \frac{1}{\vert C \vert} {\sum }_{v ∈ C} δ ( Δ V ( u , s ( t ) ) \geq Δ V ( v , s ( t ) ) )$$

Then these scores x_{ρ}(u,t) and x_{s-V}(u,s(t)) may be combined in several ways. For example:

$${x}_{combined} ( u , t \vert γ ) = ( 1 - α ( {γ}_{s} , σ ( u ) ) ) \times {x}_{ρ} ( u , t ) + α ( {γ}_{s} , σ ( u ) ) \times {x}_{s - V} ( u , s ( t ) )$$

Here α(γₛ,σ(u))∈[0,1] is the combination coefficient that depends on a user defined parameter γₛ ∈[0,1] that indicates the degree to which seasonality adjustment has to be applied and the seasonality coefficient σ(u) of the product u.

(b) First Order: Value Adjustment

A retailer might be interested in pushing in high-value products to the customer. This up-sell business objective might be combined with the recommendation scores by creating a value-score for each product and the value property. i.e. revenue, margin, margin percent, etc. These value-scores are then normalized, e.g. max, z-score, rank, and combined with the recommendation score to increase or decrease the overall score of a high/low value product.

(c) First Order: Loyalty Adjustment

The recommendation scores are created only for the products that the customer did not purchase in the input customer history. This makes sense when the goal of recommendation is only cross-sell and expand customer's wallet share to products that he has not bought in the past. One of the business objectives, however, could be to increase customer loyalty and repeat visits. This is done safely by recommending the customer those products that he bought in the recent past and encourage more purchases of the same. For retailers where there are a lot of repeat purchases, for example grocery retailers, this is particularly useful.

The simplest way to do this is to create a value-distribution of each product that the customer purchased in the past. Compare this to the value-distribution of the average customer or the average value distribution of that product. If a customer showed higher value than average on a particular product then increase the loyalty-score for that product for that customer. More formally, let:
Consider all customer's history: X={\tilde{x}⁽ⁿ⁾}: x̅⁽ⁿ⁾={ [symbol] x₁⁽ⁿ⁾,t₁⁽ⁿ⁾ [symbol] . . . [symbol] x_{L}_{ₙ}⁽ⁿ⁾,t_{L}_{ₙ}⁽ⁿ⁾ [symbol] }
Compute the weight of each product e.g. history decaying weighting:

$${w}_{l}^{( n )} ( t , λ ) = \frac{exp [ λ \times ( t - {t}_{l}^{( n )} ) ]}{{\sum }_{k = 1}^{{L}_{n}} exp [ λ \times ( t - {t}_{k}^{( n )} ) ]}$$

Compute the average weighted value of each product u and the product value V(u):

$$V ( u \vert X , λ ) = \frac{{\sum }_{n = 1}^{N} {\sum }_{l = 1}^{{L}_{n}} δ ( u = {x}_{l}^{( n )} ) {w}_{l}^{( n )} ( t , λ ) V ( {x}_{l}^{( n )} )}{{\sum }_{n = 1}^{N} {\sum }_{l = 1}^{{L}_{n}} δ ( u = {x}_{l}^{( n )} ) {w}_{l}^{( n )} ( t , λ )}$$

For any specific customer with purchase history: \tilde{x}={ [symbol] x₁,t₁ [symbol] . . . , [symbol] x_{L},t_{L} [symbol] }, product value is given by:

$$V ( u \vert \tilde{x} , λ ) = \frac{{\sum }_{l = 1}^{L} δ ( u = {x}_{l} ) {w}_{l} ( t , λ ) V ( {x}_{l} )}{{\sum }_{l = 1}^{L} δ ( u = {x}_{l} ) {w}_{l} ( t , λ )}$$

Compute the deviation of a product value from the expected:

$$Δ {V}_{diff} ( u \vert \tilde{x} , λ ) = f ( \frac{V ( u \vert \tilde{x} , λ ) - V ( u \vert X , λ )}{V ( u \vert X , λ )} )$$

These deviations are used as loyalty coefficients. If a retailer is making R recommendations, then he may decide to use all of them based on history weighting or any fraction of them based on loyalty coefficients and the rest based on recommendation scores.

(d) Second Order: Density Adjustment

FIG. 22 shows a recommendation example, where product 0 represents customer history and products 1, 2, 3, etc. represent the top products recommended by a recommendation engine. If the retailer recommends the first product, it does not connect to a number of other products; but if he recommends the medium ranked 25^{th} product, then there is a good chance that a number of other products in its rather dense neighborhood might also be purchased by the customer. Thus, if the business objective is to increase the market basket size of a customer then the recommendation scores may be adjusted by product density scores.

Introduced earlier was a consistency based density score for a product that uses the consistencies with its neighboring products to quantify how well this product goes with other products. Recommendation score is therefore adjusted to push high density products for increased market basket sizes.

(e) Second Order: Diversity Adjustment

If the business objective is to increase the diversity of a customer's market basket along different categories or departments, then the diversity score may be used in the post-processing. Earlier how to compute the diversity score of a product was described. There are other variants of the diversity score where it is specific to a particular department i.e. if the retailer wants to increase the sale in a particular department then products that have high consistency with that department get a higher diversity score. Appropriate variants of these diversity scores may be used to adjust the recommendation scores.

(f) Second Order: Life-Time Value Adjustment

There are some products that lead to the sale of other products either in the current or future visits. If the goal of the retailer is to increase the customer lifetime value, then such products should be promoted to the customer. Similar to the density measure, computed from market basket context, a life-time value for each product is computed from the purchase sequence context. These scores may be used to push such products that increase the life-time value of customers.

Combining Multiple Customizations in the Insight/Relationship Determination Module 320

Discussed above was the use of a single consistency matrix in either creating insights such as bridges, bundles, and phrases or generating decisions, such as using recommendation engine. The insight/relationship determination module 320 also allows combining multiple consistency matrices as long as they are at the same product level and are created with the same context parameters. This is an important feature that may be used for either:

1. Dealing with Sparsity—It may happen that a particular customer segment may not have enough customers and the counts matrix does not have statistically significant counts to compute consistencies. In such cases a bake-off model may be used where counts from the overall co-occurrence counts matrix based on all the customers are combined linearly with the counts of this segment's co-occurrence matrix resulting in statistically significant counts.

2. Creating Interpolated Solutions—A retailer might be interested in comparing a particular segment against the overall population to find out what is unique in this segment's co-occurrence behavior. Additionally, a retailer might be interested in interpolating between a segment and the overall population to create more insights and improve the accuracy of the recommendation engine if it is possible.

The segment level and the overall population level analysis from the insight/relationship determination module 320 may be combined at several stages each of which has their own advantages and disadvantages.

1. Counts Combination—Here the raw co-occurrence counts from all customers (averaged per customer) can be linearly combined with the raw co-occurrence counts from a customer segment. This combination helps in sparsity problems in this early stage of graph generation from the insight/relationship determination module 320.

2. Consistency Combination—Instead of combining the counts, the consistency measures of the co-occurrence consistency matrices can be combined. This is useful in both trying alternative interpolations of the insight generation, as well as the recommendation engines.

3. Recommendation Scores—For recommendation engine application, the recommendation score may be computed for a customer based on the overall recommendation model as well as the recommendation model based on this customer's segment based recommendation model. These two scores may be combined in various ways to come up with potentially more accurate propensity scores.

Thus the insight/relationship determination module 320 provides a lot of flexibility in dealing with multiple product spaces both in comparing them and combining them.

Dealing with Data Sparsity in the Insight/Relationship Determination Module 320

The insight/relationship determination module 320 is data hungry, i.e. the more transaction data it gets, the better. A general rule of thumb in the insight/relationship determination module 320 is that as the number of products in the product space grows, the number of context instances should grow quadratically for the same degree of statistical significance. The number of context instances for a given context type and context parameters depends on: (a) number of customers, (b) number of transactions per customer, and (c) number of products per transactions. There might be situations where there is not enough such as: (a) Number of customers in a segment is small, (2) Retailer is relatively new has only recently started collecting transaction data, (3) A product is relatively new and not enough transaction data associated with the product, i.e. product margin, is available, (4) analysis is done at a fine product resolution with too many products relative to the transaction data or number of context instances, or (5) sparse customer purchases in the retailer, e.g. furniture, high-end electronics, etc. have very few transactions per customer. There are three ways of dealing with such spartisy in the insight/relationship determination module 320 framework.

1. Product Level Backoff Count Smoothing—If the number of products is large or the transaction data is not enough for a product for one or more of the reasons listed above then the insight/relationship determination module 320 uses the hierarchy structure of the product space to smooth out the co-occurrence counts. For any two products at a certain product resolution, if either the margin or co-occurrence counts are low, then counts from the coarser product level are used to smooth the counts at this level. The smoothing can use not just the parent level but also grand-parent level if there is a need. As the statistical significance at the desired product level increases due to, say, additional transaction data becoming available over a period of time, the contribution of the coarser levels decreases systematically.

2. Customization Level Backoff Smoothing—If the overall customers are large enough but an important customer segment, i.e. say high value customers or a particular customer segment or a particular store or region, does not have enough customers then the co-occurrence counts or consistencies based on all the customers may be used to smooth the counts or consistencies of this segment. If there is a multi-level customer hierarchy with segments and sub-segments and so on then this approach is generalized to use the parent segment of a sub-segment to smooth the segment counts.

3. Context Coarseness Smoothing—If the domain is such that the number of transactions per customer or number of products per transaction is low, then the context can be chosen at the right level of coarseness. For example, if for a retail domain a typical customer makes only two visits to the store per year then the window parameter for the market basket window may be as coarse as a year or two years and the time-resolution for the purchase sequence context may be as coarse as a quarter or six months. The right amount of context coarseness can result in statistical significance of the counts and consistencies.

Any combination of these techniques may be used in the insight/relationship determination module 320 framework depending on the nature, quantity, and quality (noise-to-signal ratio) of the transaction data.

Predictive Time To Event Module

The insights and relationships found in the transaction data by the insight/relationship module 320 and then input to the predictive time to event module 330. The predictive time to event module 330 can be hardware, software or a combination of both hardware and software. The predictive time to event module 330 may also be called or termed an analytic engine which may be a portion of the processor and software that forms the analytic engine for other modules or can be a separate processor and software.

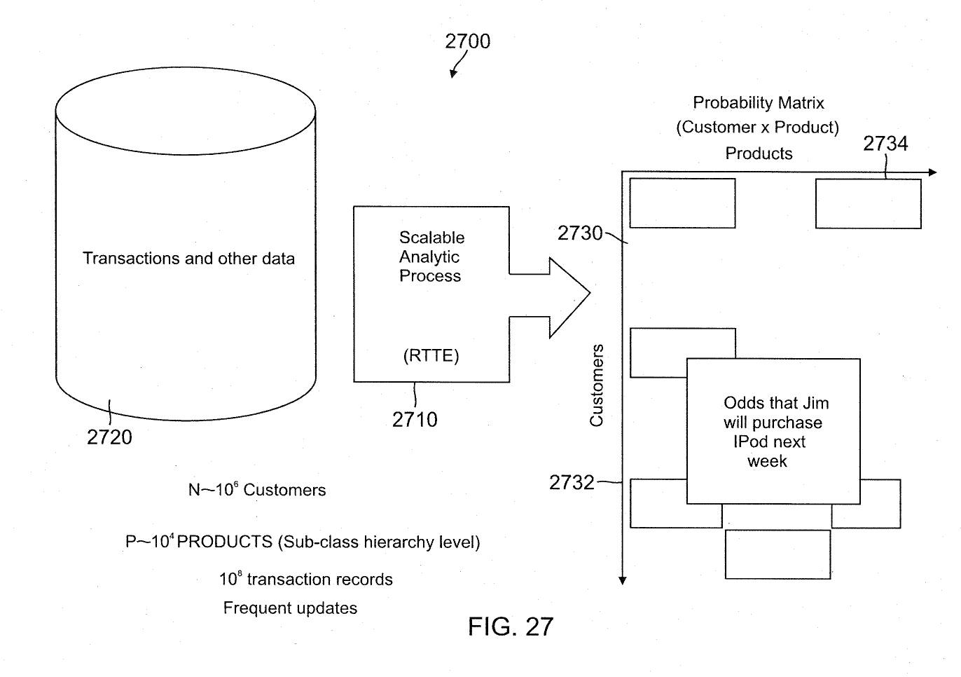

FIG. 27 is an overview of one embodiment of the predictive time-to event (TTE) component 320. In one embodiment, the predictive time-to-event (TTE) component 320 may be implemented as a large-scale analytic process or program 2710 for processing large amounts of transaction data 2720 to create models which predict how likely a given customer is to purchase a given product in a given time frame. More generally, this predictive time-to-event component 320 can use large amounts of discrete event data, including data in addition to transaction data, to build models which predict how likely an entity (not just a person) is to perform or encounter an event (not just a purchase). It should be noted that this process is not only applicable to a retail environment but is also applicable to many other environments. The output of the large-scale analytic process is a probability matrix 2730 of customers 2732 (y-axis) vs. products 2734 (y-axis). The probability matrix 2730 is for a set length of time. Although the above describes a retail application, it should be noted that there are other applications. For example, predictive time-to-event component 320 can predict what credit card transactions a customer is likely to make given the transactions they have made in the past, or given a patients past medical history the likelihood the patient would contract a given sickness in the near future can be determined, or the kind or type of medicine the patient will take next. These and many other situations can also be addressed using the predictive time-to-event component. Therefore, although a retail situation is described, there is wide application to other areas of this invention.

The core requirement for the TTE component 320 and process is a dataset of discrete event data 2720 for a set of entities. The dataset must include N time series of discrete events/transactions (N could be the number of individuals tracked in a longitudinal study.) A unique match key for each individual. Also required are P discrete event types (P could be the number of behaviors exhibited by the individuals, or the number of actions taken on the individuals, or the number of external events that may matter for the analysis, or all together. Also required is a date/time stamp associated with each event. For example a dataset containing a list of purchase transactions for different customers over a given time period would meet this requirement.

Additional inputs can also be accommodated. For example, other events may be defined by marketing actions on the customers, product price changes, public holidays, competitor actions, weather conditions, economic indicators, season and other time measures, and the like. These events could be collected in other databases, or gathered informally. Still other data can include individual information (demographics, credit information, etc.) and product information (size, color, etc.)

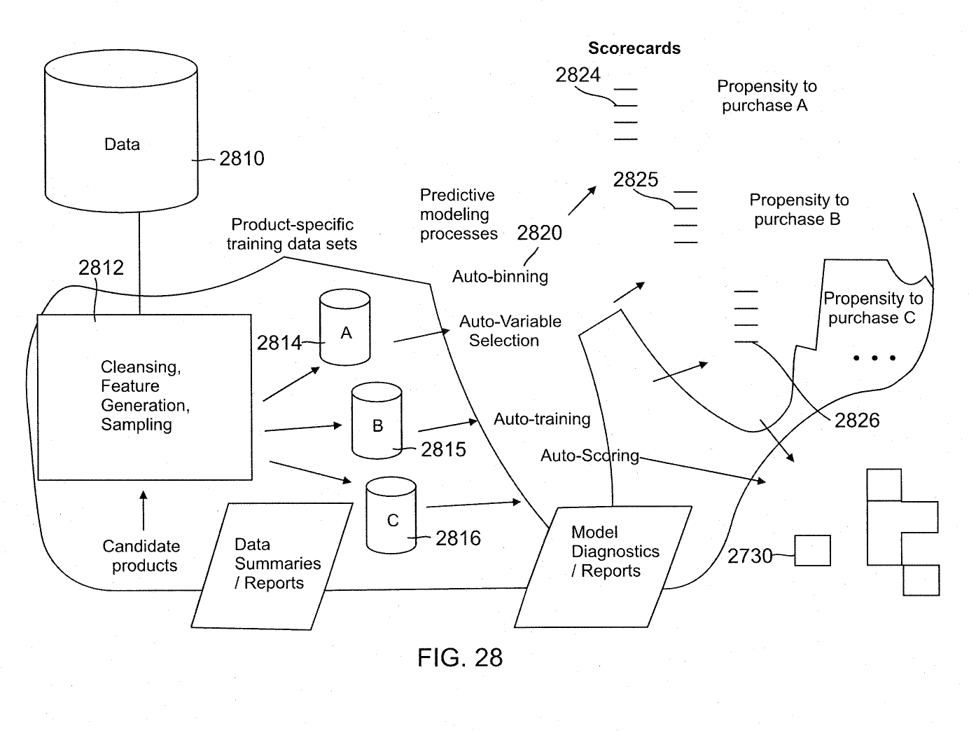

FIG. 28 is a schematic diagram of the analytic process 2710 performed by the predictive time-to-event component 320. The TTE analytic process 2800 is a highly automated process of generating data for and building a large number of scorecards. The various stages of this process perform a task needed to building the scorecards or analyze data.

The event data 2810 is passed into a cleaning, statistics generating and feature generation process 2812. The feature generation process produces a unique independent training dataset 2814, 2815, 2816 for each target product which will be modeled. Each training data set includes many labeled examples used to train a scorecard. An example is given by a vector of numeric predictive feature values, and an associated binary outcome label. An example feature could be the recency of any particular event, or its frequency, or the current season, or an economic index, or the like. There are potentially thousands or even millions of features. The training dataset 2814, 2815, 2816 is appropriately down sampled and labeled for the target.

Each training dataset 2814, 2815, 2816 is then put through a series of binning, variable reduction, model training, scoring and analyzing steps 2820. The analyzing steps include Filtering out characteristics with little power to predict the outcome, and maintaining a set of most predictive characteristics. Automatic scorecard characteristic selection and fitting of the weights in the scorecard. This results in a final scorecard model for each target product 2824, 2825, 2826, with a accompanying performance measure and validation reports. In other words, P scorecards are developed. One scorecard is developed for each training data set. Lastly all of the customers in the training dataset are scored using the developed models to produce the customer product propensity matrix 2730, which predicts the likelihood of each customer to buy each modeled product in the next time period.

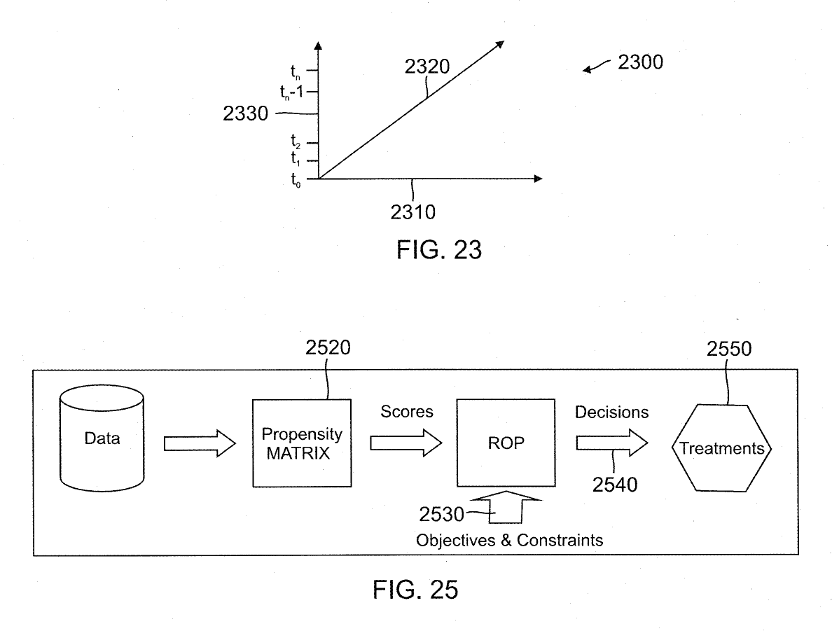

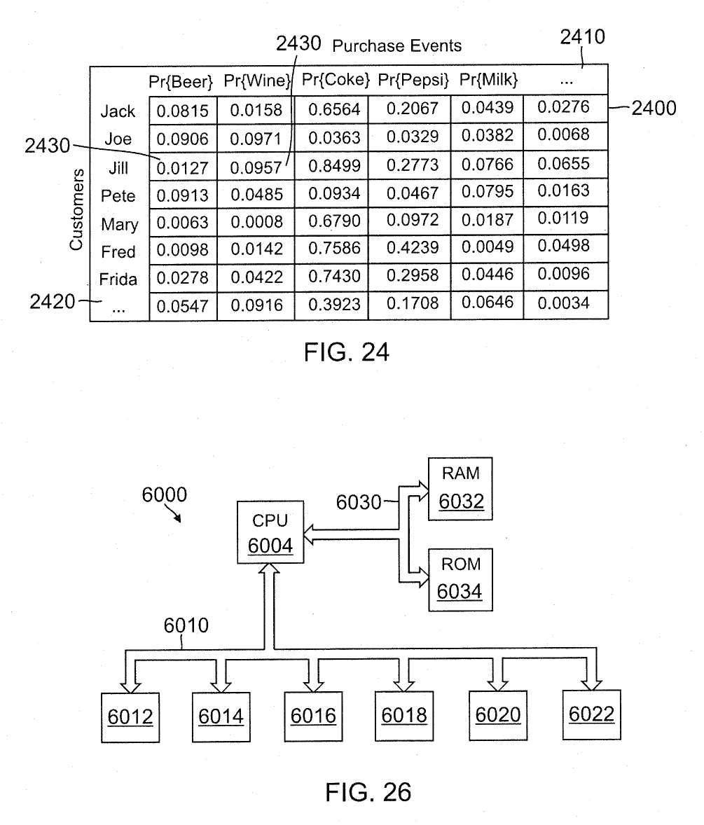

The predictive time-to-event component 320 can also produce one prospensity matrix or more propensity matrices (which are discussed in more detail below along with FIGS. 23-24) for all customers in the input dataset. The propensity matrix is a subset of the probability matrix for a given time period. This matrix is stored in a set of files, with one output file corresponding to one input line item transaction file. The columns of the output file are the propensity of a customer to buy each of the target products (one column per product), and a column of the customer id. Each row is a single customer found in the corresponding input line item transaction file.

TTE produces a set of models, one scorecard model per target product. These models can be used directly to score out datasets. TTE is an automated process of generating data for, and building, a large number of scorecards. In order to build the large number of models required by the TTE component, a large amount of processing power is required. To obtain this multiple computers are used in parallel. In one embodiment, a large amount of under utilized computing power, is used to run various jobs required.

The result of the process associated with the TTE component 320 and the process 2710, is that a set of propensity matrices can be produced for several future time periods so as to define the relationship between the risk of an event occurring in each of several discrete time periods. It should be noted that the predictors can change their values in each of the future time periods so that a decision can be made to send a marketing offer while it has the most probability of maturing into a sale.

The results as time movers on are fed back to both the insight/relationship determination component 310 and the predictive time-to-event component 320. Scoring is repeated at regular time intervals, as determined by the business (e.g. every night, every weekend, or the like). The score value of a particular individual and a particular event can change over the course of time, either due to recent events experienced by the individual, or due to the passage of time itself. The score values (i.e. likelihoods) of all individuals for all events of interest are input into a decision optimization. For example, a retailer may use the scores in a recommendation engine, which matches customers to products for which they have a high propensity.

In operation, statistics of model performance are automatically generated and tested against known and estimated distributions of the statistic. When the likelihood of observing a value for the statistic falls below an a-priori determined performance cutoff the models are deemed “stale” and automatically rebuilt.

FIG. 23 shows a propensity matrix 2300 that includes an x-axis 2310 for events and a y-axis 2320 for individual customers and a z-axis.2330 for various times. Such as propensity matrix 2300 can be used as part of a recommendation engine to answer any of the following questions:
What are the best products to recommend to a customer at a certain time, e.g. say today or next week?
What are the best customers to whom a particular product should be recommended at a certain time?
What is the best time to recommend a particular product to a particular customer?

These questions can be answered by fixing the two out of the three dimensions, and picking the top scoring combination for the third dimension.

FIG. 24 shows a propensity matrix 2400 is for one of selected times from the three dimensional propensity matrix, according to an example embodiment. The propensity matrix will now be discussed in further detail. FIG. 24 is the matrix at one time, tₙ₋₃. In other words, the matrix shown is two-dimensional and is for one time tₙ₋₃ along the time or z-axis in FIG. 23. For at least some of the other times, tₙ₋₂, tₙ₋₁, . . . , tₙ, there will be similar propensity matrices. As can be seen in FIG. 24, there is an x-axis 2410 that includes the various events and there is a y-axis 2420 that includes the various customers. A number of cells, such as cell 2430, are on the propensity matrix 2400. The cell includes a number that relates to the propensity of the event occurring at the time tₙ₋₃ for a particular customer. For example, cell 2430 includes a value which is the propensity or risk that customer Jill will buy beer at time tₙ₋₃. The propensity matrix 2400 also includes a cell 2431 that includes a value which is the propensity or risk that customer Jill will buy wine at time tₙ₋₃. The values are between zero (no chance or propensity for the event occurring) and one (absolutely certain that the event will happen for that time). The propensity matrix 2400 includes cells for the propensity of an event happening during the time period for each of a number of events. In a retail situation, the events are sales of the various products. If this is for a retailer, the propensity matrix can include a multiplicity of products which cross all sorts of sub categories and also can include a multiplicity of customers that the retailer has information on from the data warehouse. The events, in a retail setting, are many times related to the propensity or risk of a sale occurring for a particular product. The risks or propensity of an event happening for a particular customer are determined for a selected a time frame

FIG. 25 shows a flow diagram of an optimization of a recommendation engine, according to an example embodiment. The data, in the form of a multiple dimensioned matrix, is scored or provided with propensities or risk factors for the occurrence of a number of specific events during a desired time. The result is a propensity matrix 2300 having cells for each combination of customer and event. In each cell or in many of the cells, there is a risk factor or propensity number reflective of the probability of the event happening in that particular time frame. The scores are input to the selection module. The selection module can be a recommendation optimization module 2520. The scores or individual propensity values for a plurality of cells are input to the recommendation optimization module 2520. Also input to the recommendation optimization module 2520 are objectives and constraints 2530. These objectives and constraints 2530 can be rules reflective of the basis for the making the recommendations. For example, the objectives and constraints 2530 can include which products or product group from which to make recommendations. They could include one or many products. They could include products under one brand. The rules and constraints 2530 could also include, in an alternative embodiment, the customers to whom to make recommendations. Still another objective and constraint 2530 might be a budget associated with making recommendations. The company paying for the recommendations might want to allocate a selected amount of resource to the effort. It also might want to constrain the recommendations to a certain number of time periods or it might want to constrain the recommendations to those actions which would have a propensity value above a selected threshold. Given the objectives and constraints 2530 as well as the scores, a recommendation optimization module 2540 optimizes the cells that remain. Decisions 2540 can then be made in response to the optimization process. The decisions will be made in response to the cells that remain after the optimization process. The decisions 2540 made result in specific treatments 2550 or marketing actions.

The propensity matrix can be optimized for various sets of given conditions. As mentioned above, one of the variables may be held constant and then the most likely propensities may be the basis for certain optimizations. For example, the propensities or risks associated with a sale of beer for a selected time can be input for making recommendations to a particular set of customers. By the same token, certain customers can be looked at for their propensities over a time frame. In each case, several time frames can also be looked at. Business rules can be applied as a set of restrictions to the propensity matrix. After application of the business rules the matrix can then be optimized. For example, the highest propensities may be selected over a three month period. Recommendations would be assigned a cost, and the highest propensity actions would be taken for a given budget.

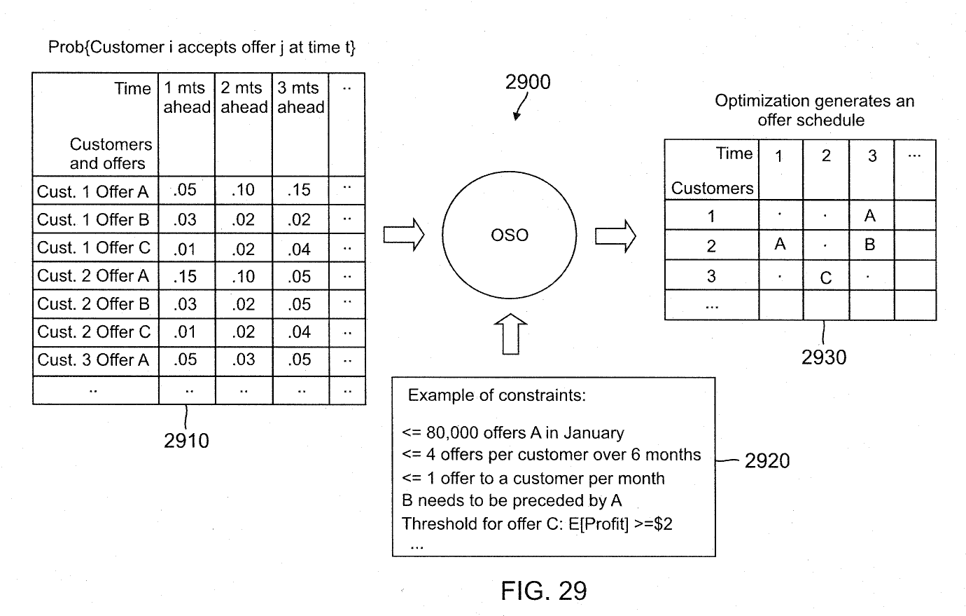

For a selected set of constraints, propensity matrices can be reviewed for a number of time frames and the occurrences of time for customers for a set of events can be compiled into an optimized offer schedule. FIG. 29 depicts this process 2900. A series of customers and offers are compiled along with multiple selected time periods 2910. The compiled results are input to the offer scheduling optimization process. Constraints 2920 are placed on the process. The result is that by considering the constraints a schedule of offers that is substantially optimized 2930 can be produced.

A method of selecting actions with respect to a plurality of customers includes storing transition data, determining a relationship between a first entity, a second entity, and a third entity from information that includes the transaction data, ranking the possibility of a first future event occurring in a first selected time period for a first subset of the plurality of customers based on the relationship between the first entity, the second entity and the third entity; and ranking the possibility of a second future event occurring in a second selected time period for the first subset of the plurality of customers based on the relationship between the first entity, the second entity and the third entity. Some embodiments of the method further ranking the possibility of a third future event occurring in a first selected time period for a second subset of the plurality of customers based on the relationship between the first entity, the second entity and the third entity, and ranking the possibility of a fourth future event occurring in a second selected time period for the second subset of the plurality of customers based on the relationship between the first entity, the second entity and the third entity. The method can also include selecting one of the first, second, third or fourth future events based on the ranking of those events possibly occurring. The method for selecting actions with respect to a plurality of customers also may include selecting a combination of the first, second, third or fourth future events based on the ranking of those events possibly occurring. In still another embodiment, the method for selecting actions with respect to a plurality of customers also includes selecting a combination of the first, second, third or fourth future events based on optimizing a select amount of resources associated with at least one of the first entity, the second entity and the third entity. In one embodiment of the method at least one of the first entity, the second entity, and the third entity is a marketing action.

Technical Implementation

Exemplary Digital Data Processing Apparatus

A block diagram of a computer system 6000 that executes programming for performing the above methods is shown in FIG. 27. A general computing device in the form of a computer 6010, may include a processing unit 6002, memory 6004, removable storage 6012, and non-removable storage 6014. Memory 6004 may include volatile memory 6006 and non volatile memory 6008. Computer 6010 may include or have access to a computing environment that includes a variety of computer-readable media, such as volatile memory 6006 and non-volatile memory 6008, removable storage 6012 and non-removable storage 6014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 6010 may include or have access to a computing environment that includes input 6016, output 6018, and a communication connection 6020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. The microprocessor 210 or other selected circuitry or components of the disk drive may be such a computer system.

Computer-readable instructions stored on a computer-readable medium are executable by the processing unit 6002 of the computer 6010. A hard drive, CD-ROM, and RAM are some examples of articles including a computer-readable medium. A machine-readable medium provides instructions-that, when executed by a machine, cause the machine to read transaction data, determine a relationship between a first entity and a second entity from the transaction data, rank the possibility of a future event occurring in a first selected time period based on the relationship between the first entity and the second entity, and rank the possibility of a future action occurring in a second selected time period based on the relationship between the first entity and the second entity. The instructions, in some embodiments, further cause the machine to quantify the relationship between the first entity and the second entity. In another embodiment, the machine-readable medium provides instructions that, when executed by a machine, further cause the machine to select one of the first selected time period or the second selected time period based on the ranking of the possibility of a future event occurring in the first selected time period, and the ranking of the possibility of a future event occurring in the first selected time period. The machine-readable medium, in still further embodiments, provides instructions that, when executed by a machine, further cause the machine to determine a relationship between the first entity and the second entity and a third entity. The third entity may be a marketing action, or demographic information, or the like.

Logic Circuitry

In contrast to the digital data processing apparatus or computer system 6000 discussed above, a different embodiment of this disclosure uses logic circuitry instead of computer-executed instructions to implement processing entities of the system. Depending upon the particular requirements of the application in the areas of speed, expense, tooling costs, and the like, this logic may be implemented by constructing an application-specific integrated circuit (ASIC) Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

A system for selecting a next action includes a memory for storing transaction data, a insight/relationship determination module, and a rank module. The insight/relationship determination module determines a relationship between a first entity and a second entity from the transaction data. The rank module ranks the possibility of a future event occurring in a first selected time period based on the relationship between the first entity and the second entity, and for ranking the possibility of a future action occurring in a second selected time period based on the relationship between the first entity and the second entity. In one embodiment, the insight/relationship determination module quantifies the relationship between the first entity and the second entity. Some embodiments also include a selection module for selecting-one of the first selected time period or the second selected time period based on the ranking of the possibility of a future event occurring in the first selected time period, and the ranking of the possibility of a future event occurring in the second selected time period.

Signal-Bearing Media

Wherever the functionality of any operational components of the disclosure is implemented using one or more machine-executed program sequences, these sequences may be embodied in various forms of signal-bearing media. Such a signal-bearing media may comprise, for example, the storage or another signal-bearing media, such as a magnetic or optical disk, tape, non-volatile or volatile memory such as. ROM (read only memory), EPROM (erasable programmable read only memory) flash PROM, or EEPROM, battery backup RAM, optical storage e.g. CD-ROM, WORM, DVD, digital optical tape, or other suitable signal-bearing media including analog or digital transmission media and analog and communication links and wireless communications as well as communications over the internet.

A machine-readable medium that provides instructions that, when executed by a machine, cause the machine to read transaction data, determine a relationship between a first entity and a second entity from the transaction data, rank the possibility of a future event occurring in a first selected time period based on the relationship between the first entity and the second entity, and rank the possibility of a future action occurring in a second selected time period based on the relationship between the first entity and the second entity. The instructions, in some embodiments, further cause the machine to quantify the relationship between the first entity and the second entity. In another embodiment, the machine-readable medium provides instructions that, when executed by a machine, further cause the machine to select one of the first selected time period or the second selected time period based on the ranking of the possibility of a future event occurring in the first selected time period, and the ranking of the possibility of a future event occurring in the first selected time period. The machine-readable medium, in still further embodiments, provides instructions that, when executed by a machine, further cause the machine to determine a relationship between the first entity and the second entity and a third entity. The third entity may be a marketing action, or demographic information, or the like.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method for selecting a next action comprising:
reading data;
determining a relationship between a first entity associated with the data and a second entity associated with the data;
predicting the occurrence of a future event based on the determined relationship between the first entity and the second entity;
ranking the possibility of the future event occurring in a first selected time period; and
ranking the possibility of the future action occurring in a second selected time period.

2. The method of claim 1 further comprising quantifying the relationship between the first entity and the second entity.

3. The method of claim 1 wherein:
ranking of the possibility of the future event occurring in the first selected time period includes quantifying the possibility of occurrence in the first selected time period; and
ranking of the possibility of the future event occurring in the second selected time period includes quantifying the possibility of occurrence in the second selected time period.

4. The method of claim 3 further comprising:
optimizing the ranking of the possibility of the future event occurring in the first selected time period, and the ranking of the possibility of the future event occurring in the second period; and
taking action based on the optimization.

5. The method of claim 1 further comprising selecting one of the first selected time period or the second selected time period based on the ranking of the possibility of the future event occurring in the first selected time period, and the ranking of the possibility of the future event occurring in the first selected time period.

6. The method of claim 1 wherein the first entity is a first product and wherein the second entity is a second product.

7. The method of claim 1 wherein the first entity is a product and the second entity is a customer.

8. The method of claim 1 wherein the first entity is a product and the second entity is a set of customers.

9. The method of claim 1 further comprising a third entity, the method further comprising determining a relationship between the first entity and the second entity and the third entity.

10. The method of claim 9 further comprising:
predicting the occurrence of a plurality of future events based on the determined relationship between at least two of the first entity, the second entity and the third entity;
ranking the possibility of a plurality of future events occurring in a first selected time period; and
ranking the possibility of a plurality of future events occurring in a second selected time period;
applying constraints to the rankings of the plurality of future events occurring in the first selected time period and the second selected time period; and
optimizing the rankings based on a value associated with the ranking and the constraints.

11. The method of claim 10 further comprising recommending actions based on the optimized rankings.

12. A system for selecting a next action comprising:
a memory for storing data;
an insight determination module for determining a relationship between a first entity and a second entity from the data;
a prediction module for predicting a future event between a first entity and a second entity based on the relationship between the first and second entity;
a ranking module for ranking the possibility of the future event occurring in a first selected time period based on the relationship between the first entity and the second entity, and for ranking the possibility of the future action occurring in a second selected time period based on the relationship between the first entity and the second entity.

13. The system of claim 12 wherein the rankings for the possibilities of the future event occurring in a first or second selected time period are quantified.

14. The system of claim 13 further comprising an optimization module for selecting one of the first selected time period or the second selected time period based on the quantized rankings.

15. The system of claim 12 further comprising a feedback mechanism for monitoring transactions to determine if a predicted event occurred.

16. A method for selecting actions comprising:
storing data;
determining an insight between a first entity, a second entity, and a third entity from information that includes the transaction data;
predicting the occurrence of a plurality of events based on relationships determined between the first entity, the second entity and the third entity;
ranking the possibility of the plurality of events occurring in a first selected time period; and
ranking the possibility of the plurality of events occurring in a second selected time period.

17. The method for selecting actions of claim 16 further comprising applying at least one constraint to the plurality of events.

18. The method for selecting actions of claim 17 further comprising optimizing actions based on the applied at least one constraint.

19. The method of claim 18 wherein the actions include a marketing action.

20. The method of claim 17 wherein the first entity, the second entity, and the third entity include a product.

21. A machine-readable medium that provides instructions that, when executed by a machine, cause the machine to:
read data;
determine an insight between a first entity associated with the data and a second entity associated with the data;
predict the occurrence of a future event based on the determined relationship between the first entity and the second entity;
rank the possibility of the future event occurring in a first selected time period; and
rank the possibility of the future action occurring in a second selected time period.

22. The machine-readable medium of claim 21 that provides instructions that, when executed by a machine, further cause the machine to quantify the relationship between the first entity and the second entity.

23. The machine-readable medium of claim 21 that provides instructions that, when executed by a machine, further cause the machine to:
apply constraints to the ranked future events in one of the first or second time periods; and
to optimize the selection of at least one of the first selected time period or the second selected time period based on the optimization.
